(19) United States
(12) Patent Application Publication
(10) Pub. No.: US 2015/0039268 A1
(43) Pub. Date: Feb. 5, 2015

(54) CAVITATING JET PERFORMANCE ESTIMATION METHOD AND CAVITATING JET PERFORMANCE ESTIMATION DEVICE, CAVITATING JET ESTIMATION ERROR CALCULATION METHOD AND CAVITATING JET ESTIMATION ERROR CALCULATION DEVICE, CAVITATING JET PERFORMANCE EVALUATION METHOD AND CAVITATING JET PERFORMANCE EVALUATION DEVICE AND CAVITATING JET PERFORMANCE CALCULATION FORMULA SPECIFICATION DEVICE

(71) Applicant: TOHOKU UNIVERSITY, Sendai-shi, Miyagi (JP)

(72) Inventor: Hitoshi Soyama, Sendai-shi (JP)

(73) Assignee: TOHOKU UNIVERSITY, Sendai-shi, Miyagi (JP)

(21) Appl. No.: 14/380,322

(22) PCT Filed: Feb. 15, 2013
(86) PCT No.: PCT/JP2013/053678

§ 371 Date: Aug. 21, 2014

(30) Foreign Application Priority Data
Feb. 23, 2012 (JP) 2012-038047

(51) Int. Cl. G01M 99/00; G06F 17/17

(52) U.S. Cl. CPC G01M 99/008; G06F 17/17
USPC 702/182

(57) ABSTRACT

Equation (1) for calculating estimated cavitating jet performance E is set, a power index n(σ) of a term x^{n(σ)} relating to a power law of an injection pressure p₁ of a cavitating jet and a power index m(σ) of a term y^{m(σ)} relating to a power law of a nozzle diameter d for producing the cavitating jet in Equation (1) are specified from data on the injection pressure p₁, the nozzle diameter d and a cavitation number σ and data on cavitating jet performance E_{Rmax} corresponding to these pieces of data, and the estimated cavitating jet performance E is obtained using the data on the injection pressure p₁, the nozzle diameter d and the cavitation number σ, the Equation (1) and the functions n(σ), m(σ) for the specified power indices.

### TECHNICAL FIELD

The present invention relates to a cavitating jet performance estimation method, a cavitating jet performance estimation system and a cavitating jet performance estimation device, further to a cavitating jet estimation error calculation method and a cavitating jet estimation error calculation device, a cavitating jet performance evaluation method and a cavitating jet performance evaluation device, a cavitating jet performance calculation formula specification system and a cavitating jet performance calculation formula specification device, and a program for computer execution and a computer-readable recording medium recording the program.

### BACKGROUND ART

A cavitating jet associated with cavitation bubbles obtained by injecting a high-speed water jet in water is utilized in cavitation peening (CP), surface modification of metal materials, cleaning devices, chemical reaction treatments and the like.

Performance on cavitation peening, surface modification of metal materials, cleaning, chemical reaction treatments or the like by a cavitating jet is also called performance of the cavitating jet (hereinafter, also referred to as “cavitating jet performance”).

Such cavitating jet performance is known to largely differ depending on hydrodynamic parameters of the cavitating jet such as an injection pressure (nozzle upstream pressure) of the cavitating jet, a bubble collapse site pressure (nozzle downstream pressure) and a nozzle shape (dimensions of a device).

For example, in cavitation peening, the cavitating jet performance may not increase, but may rather decrease even if the injection pressure and a flow velocity of the cavitating jet are merely increased since a processing is performed by a collapse impact force of cavitation bubbles.

Further, even under the condition that the flow velocity condition is constant, a cavitation bubble growing time becomes longer and the cavitation bubbles grow larger if the dimensions of the nozzle are increased. As a result, impact energy at the time of bubble collapse increases and the cavitating jet performance increases.

Further, generally in cavitation erosion, a power law of erosion that erosion increases in proportion to the cube of dimensions of a fluid device is known, but the details thereof are unknown. Further, concerning a power law of flow velocity and a power index thereof, the power index is 3 if cavitation intensity is in proportion to flow energy. However, reported power indices largely vary from 4 to 11 and the details thereof are unknown.

Thus, in the case of performing cavitation peening at high efficiency utilizing a cavitating jet or in the case of designing or fabricating a cavitating jet generator utilizing a cavitating jet, performance of a cavitating jet has been conventionally estimated by actually conducting a test using the cavitating jet generator to be estimated or by fabricating a prototype model machine for estimation.

A method for estimating a cavitation impact force using an impact force measuring sensor has been proposed as a method for estimating such cavitating jet performance (see patent literature 1). For this, it has been necessary to actually measure an impact force at each condition (nozzle upstream pressure, nozzle downstream pressure, nozzle diameter) using a cavitating jet generator to be actually estimated.

A method for obtaining cavitation intensity of a model fluid machine using the model fluid machine simulating an actual fluid machine to be estimated and calculating cavitation intensity of the actual fluid machine by utilizing similarity between the model fluid machine and the actual fluid machine has been proposed as another estimation method (see patent literature 2).

Besides, it has been also attempted to predict cavitating jet performance by simulating a cavitating jet using a super computer.

### CITATION LIST

### Patent Literature

Patent literature 1: JP2001-267584A

Patent literature 2: Japanese Patent No. 4812100

### SUMMARY OF INVENTION

### Technical Problem

Since a cavitating jet generator to be estimated needs to be prepared every time the cavitating jet performance is estimated in the method described in patent literature 1, cost and time for estimation have been problems.

In the method described in patent literature 2, the cavitation intensity of the actual fluid machine is calculated from that of the model fluid machine, but power indices relating to hydrodynamic parameters of the fluid machine are constants. In this method, it has been difficult to predict the cavitation intensity of the actual fluid machine with sufficient accuracy.

Further, the simulation of the cavitating jet can simulate the growth of cavitation, but it has been difficult to calculate the cavitating jet performance since a phase transition of bubbles occurs in cavitation and the simulation of a large quantity of bubbles is difficult.

From the above background, a technology has been required which estimates performance of a cavitating jet with high accuracy from the aforementioned hydrodynamic parameters.

The present invention has been made in view of the above problems.

Specifically, the present invention aims to provide a method for estimating performance of a cavitating jet from hydrodynamic parameters of the cavitating jet without conducting any test by a model fluid machine or an actual fluid machine for the cavitating jet to be estimated.

### Solution to Problem

[1] Specifically, a gist of the present invention lies in a cavitating jet performance estimation method, including, in obtaining estimated cavitating jet performance E of a cavitating jet, setting the following Equation (1) for calculating the estimated cavitating jet performance E,

[Equation 1]

E=FX^{n(σ)}Y^{m(σ)} (1)

(In Equation (1), F denotes a term relating to the effect of a cavitation number σ of the cavitating jet, X^{n(σ)} denotes a term relating to a power law of an injection pressure p₁ of the cavitating jet and a power index n(σ) thereof denotes a function of the cavitation number σ, and Y^{m(σ)} denotes a term relating to a power law of a nozzle diameter d for producing the cavitating jet and a power index m(σ) thereof denotes a function of the cavitation number σ),

specifying the functions n(σ), m(σ) for the power indices in the Equation (1) from data on the injection pressure p₁, the nozzle diameter d and the cavitation number σ and data on cavitating jet performance E_{Rmax} corresponding to these pieces of data, and obtaining the estimated cavitating jet performance E using the data on the injection pressure p₁, the nozzle diameter d and the cavitation number σ, the Equation (1) and the specified functions n(σ), m(σ) for the power indices.

[2] Here, preferably, the Equation (1) of [1] for calculating the estimated cavitating jet performance E of the cavitating jet is the following Equation (2),

$$\begin{matrix}[ Equation 2 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), and the estimated cavitating jet performance E_{cav} is obtained using the Equation (2).

[3] Furthermore, preferably, Kₙ=1 in the Equation (2) of [2]

[4] Further, the influence function is preferably defined as a function different before and after the cavitation number σ exhibiting a maximum.

[5] In specifying the functions n(σ), m(σ) for the power indices in the Equation (1) or (2) of [2] or [3], preferably, the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d are first respectively obtained, and the functions n(σ), m(σ) for the power indices are specified from the both relationships.

[6] Further, in obtaining the estimated cavitating jet performance E_{cav} of [1] to [5], preferably, a predetermined order of operations is set for the data on the injection pressure p₁, the nozzle diameter d and the cavitation number σ, and the estimated cavitating jet performance E_{cav} is successively obtained in accordance with the order of operations.

[7] Another aspect of the present invention lies in a cavitating jet performance estimation system, including a database for accumulating data on an injection pressure p₁ of a cavitating jet, a nozzle diameter d for producing the cavitating jet and a cavitation number σ and data on cavitating jet performance E_{Rmax} corresponding to these pieces of data, a power index specification means for specifying functions n(σ), m(σ) for power indices in the following Equation (1) for calculating estimated cavitating jet performance E from data accumulated in the database,

[Equation 3]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(n)} denotes a term relating to a power law of the nozzle diameter d for producing the cavitating jet and a power index m(σ) thereof denotes a function of the cavitation number σ), and an estimation means for obtaining the estimated cavitating jet performance E using the data on the injection pressure p₁, the nozzle diameter d and the cavitation number σ, the Equation (1) and the specified functions n(σ), m(σ) for the power indices.

[8] Still another gist of the present invention lies in a cavitating jet performance estimation device, including a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 4]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ), and an estimation means for obtaining the estimated cavitating jet performance E using the data on the injection pressure p₁, the nozzle diameter d and the cavitation number σ, the Equation (1) and the specified functions n(σ), m(σ) for the power indices.

[9] Still another gist of the present invention lies in a cavitating jet performance estimation device, including an estimation means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 5]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ), and obtaining the estimated cavitating jet performance E using the data on the injection pressure p₁, the nozzle diameter d and the cavitation number σ, the Equation (1) and the specified functions n(σ), m(σ) for the power indices.

[10] Here, preferably, the Equation (1) of [8] or [9] for calculating the estimated cavitating jet performance E of the cavitating jet is the following Equation (2),

$$\begin{matrix}[ Equation 6 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), and estimated cavitating jet performance E_{cav} is obtained using the Equation (2).

[11] Furthermore, preferably, Kₙ=1 in the Equation (2) of [10].

[12] Further, the influence function of [10] or [11] is defined as a function different before and after the cavitation number σ exhibiting a maximum.

[13] Further, to specify the power indices of [10] or [11], there are preferably provided a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d, and a means for specifying the functions n(σ), m(σ) for the power indices from the both relationships.

[14] Further, the estimation means of [8] to [13] preferably includes a means for setting a predetermined order of operations for the data on the injection pressure p₁, the nozzle diameter d and the cavitation number σ, and a means for successively obtaining the estimated cavitating jet performance E_{cav} in accordance with the order of operations.

[15] Still another gist of the present invention lies in a program for causing a computer to function as a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 7]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ), and an estimation means for obtaining the estimated cavitating jet performance E using the data on the injection pressure p₁, the nozzle diameter d and the cavitation number σ, the Equation (1) and the specified functions n(σ), m(σ) for the power indices.

[16] Still another gist of the present invention lies in a program for causing a computer to function as an estimation means for obtaining estimated cavitating jet performance E using functions n(σ), m(σ) for power indices obtained by specifying the functions n(σ), m(σ) for the power indices in the following Equation (1) for calculating the estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 8]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ), the data on the injection pressure p₁, the nozzle diameter d and the cavitation number σ and the Equation (1).

[17] Here, preferably, the Equation (1) of [15] or [16] for calculating the estimated cavitating jet performance E of the cavitating jet is the following Equation (2),

$$\begin{matrix}[ Equation 9 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), and estimated cavitating jet performance E_{cav} is obtained using the Equation (2).

[18] Furthermore, preferably, Kₙ=1 in the Equation (2) of [17].

[19] Still another gist of the present invention lies in a computer-readable recording medium recording the program of [15] to [18].

[20] Still another gist of the present invention lies in a cavitating jet estimation error calculation method, including obtaining the estimated cavitating jet performance E_{cav} by the cavitating jet performance estimation method of [2] to [6], and obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

[21] Here, preferably, the cavitating jet performance estimation error is obtained by the cavitating jet estimation error calculation method according to [20], and cavitating jet performance estimation accuracy is evaluated based on the cavitating jet performance estimation error.

[22] Further, there are preferably provided the cavitating jet performance estimation device according to [8] to [14], and a means for obtaining the cavitating jet performance estimation error by comparing estimated cavitating jet performance E_{cav} obtained by the cavitating jet performance estimation device and actually measured cavitating jet performance E_{Rmax exp} of the cavitating jet corresponding to the estimated cavitating jet performance E_{cav}.

[23] Further, there are preferably provided the cavitating jet estimation error calculation device of [22], and a means for evaluating cavitating jet performance estimation accuracy based on the cavitating jet performance estimation error obtained by the cavitating jet estimation error calculation device.

[24] Still another gist of the present invention lies in a program for causing a computer to function as a power index specification means for specifying functions n(σ), m(σ) for power indices in the following Equation (2) for calculating estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$\begin{matrix}[ Equation 10 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), an estimation means for obtaining the estimated cavitating jet performance E_{cav} using the data on the injection pressure p₁, the nozzle diameter d and the cavitation number σ, the Equation (2) and the specified functions n(σ), m(σ) for the power indices, and a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

[25] Still another gist of the present invention lies in a program for causing a computer to function as an estimation means for obtaining estimated cavitating jet performance E_{cav} using functions n(σ), m(σ) for power indices obtained by specifying the functions n(σ), m(σ) for the power indices in the following Equation (2) for calculating the estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$\begin{matrix}[ Equation 11 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), the data on the injection pressure p₁, the nozzle diameter d and the cavitation number σ and the Equation (2), and a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

[26] Still another gist of the present invention lies in a program for causing a computer to function as a power index specification means for specifying functions n(σ), m(σ) for power indices in the following Equation (2) for calculating estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$\begin{matrix}[ Equation 12 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), an estimation means for obtaining the estimated cavitating jet performance E_{cav} using the data on the injection pressure p₁, the nozzle diameter d and the cavitation number σ, the Equation (2) and the specified functions n(σ), m(σ) for the power indices, a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}, and a means for evaluating cavitating jet performance estimation accuracy based on the cavitating jet performance estimation error.

[27] Still another gist of the present invention lies in a program for causing a computer to function as an estimation means for obtaining estimated cavitating jet performance E_{cav} using functions n(σ), m(σ) for power indices obtained by specifying the functions n(σ), m(σ) for the power indices in the following Equation (2) for calculating the estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$\begin{matrix}[ Equation 13 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to), the data on the injection pressure p₁, the nozzle diameter d and the cavitation number σ and the Equation (2), a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}, and a means for evaluating cavitating jet performance estimation accuracy based on the cavitating jet performance estimation error.

[28] Here, preferably, Kₙ=1 in the Equation (2) of [24] to [27].

[29] Still another gist of the present invention lies in a computer-readable recording medium recording the program of [24] to [28].

[30] Still another gist of the present invention lies in a cavitating jet performance calculation formula specification system, including a database for accumulating data on an injection pressure p₁ of a cavitating jet, a nozzle diameter d for producing the cavitating jet and a cavitation number σ and data on cavitating jet performance E_{Rmax} corresponding to these pieces of data, and a power index specification means for specifying functions n(σ), m(σ) for power indices in the following Equation (1) for calculating estimated cavitating jet performance E from data accumulated in the database,

[Equation 14]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ).

[31] Still another gist of the present invention lies in a cavitating jet performance calculation formula specification device, including a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 15]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ).

[32] Here, the Equation (1) for calculating the estimated cavitating jet performance E of the cavitating jet is preferably the following Equation (2),

$$\begin{matrix}[ Equation 16 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{rd} to be referred to).

[33] Furthermore, preferably, Kₙ=1 in the Equation (2) of [32].

[34] Further, the influence function of [32] or [33] is preferably defined as a function different before and after the cavitation number σ exhibiting a maximum.

[35] Further, the power index specification means of [32] or [33] includes a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d, and a means for specifying the functions n(σ), m(σ) for the power indices from the both relationships.

[36] Still another gist of the present invention lies in a program for causing a computer to function as a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 17]

E=FX^{n(σ)}Y^{m(σ)} (1)

(In Equation (1), F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and Y^{m(σ)} denotes a term relating to a power law of the nozzle diameter d for producing the cavitating jet and a power index m(σ) thereof denotes a function of the cavitation number σ).

[37] Here, the Equation (1) of [36] for calculating the estimated cavitating jet performance E of the cavitating jet is the following Equation (2),

$$\begin{matrix}[ Equation 18 ] & \\ {E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} & ( 2 )\end{matrix}$$

(In the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ, and f(σ_{ref}) denotes the influence function at a cavitation number σ_{ref} to be referred to).

[38] Furthermore, preferably, Kₙ=1 in the Equation (2) of [37].

[39] Still another gist of the present invention lies in a computer-readable recording medium recording the program of [36] to [38].

### Advantageous Effects of Invention

According to the present invention, it is possible to estimate cavitating jet performance of a cavitating jet with a high accuracy. Further, it is possible to estimate at lower cost and in a shorter time than conventional estimation techniques using an actual fluid machine and a model fluid machine since no test by a cavitating jet to be estimated is conducted.

### BRIEF DESCRIPTION OF DRAWINGS

FIG. 1 is a diagram schematically showing the configuration of a cavitating jet testing device used in the present embodiment,

FIG. 2 is a diagram schematically showing a relationship between dimensions of a tip part of a nozzle of the cavitating jet testing device used in the present embodiment and a test piece,

FIG. 3 is a diagram schematically showing a relationship between the tip part of the nozzle of the cavitating jet testing device used in the present embodiment and a cavitating jet,

FIGS. 4(a) to 4(g) are diagrams schematically showing cross-sectional shapes of tip parts of various nozzles in the cavitating jet testing device used in the present embodiment,

FIG. 5 is a graph showing a standoff distance and an erosion amount of each nozzle of the cavitating jet testing device,

FIG. 6 is a graph showing an erosion time and the erosion amount of each nozzle of the cavitating jet testing device,

FIG. 7 is a diagram schematically showing the hardware configuration of a cavitating jet performance estimation system as one embodiment of the present invention,

FIG. 8 is a diagram schematically showing a function block of the cavitating jet performance estimation system as one embodiment of the present invention,

FIG. 9 is a flow chart showing a process of a power index specification means in the cavitating jet performance estimation system as one embodiment of the present invention,

FIG. 10 is a flow chart showing a process of an influence function specification means in the cavitating jet performance estimation system as one embodiment of the present invention,

FIG. 11 is a flow chart showing a process of a jet performance estimation means in the cavitating jet performance estimation system as one embodiment of the present invention,

FIG. 12 is a diagram schematically showing the hardware configuration of a cavitating jet performance estimation device as another embodiment of the present invention,

FIG. 13 is a diagram schematically showing a function block of a cavitating jet performance estimation system as another embodiment of the present invention,

FIG. 14 is a flow chart showing a process of a jet performance estimation means in the cavitating jet performance estimation device as another embodiment of the present invention,

FIG. 15(a) is a graph showing a relationship of standoff distance s and erosion rate E_{R} at each cavitation number σ and each nozzle diameter d and FIG. 15(b) is a graph showing a relationship of standoff distance s and erosion rate E_{R} at each cavitation number σ and each injection pressure p₁,

FIG. 16(a) is a graph showing a relationship of nozzle diameter d and optimum standoff distance sₒₚₜ at each cavitation number σ and FIG. 16(b) is a graph showing a relationship of injection pressure p₁ and optimum standoff distance sₒₚₜ at each cavitation number σ,

FIGS. 17(a) to 17(c) are graphs showing a change of mass loss Δm with time for each nozzle diameter d at each cavitation number σ,

FIGS. 18(a) to 18(c) are graphs showing a change of mass loss Δm with time for each injection pressure p₁ at each cavitation number σ,

FIG. 19(a) is a graph showing a relationship of nozzle diameter d and maximum cumulative erosion rate E_{Rmax} at each cavitation number σ and FIG. 19(b) is a graph showing a relationship of injection pressure p₁ and maximum cumulative erosion rate E_{Rmax} at each cavitation number σ,

FIG. 20 is a graph showing a relationship of cavitation number σ and power indices nₚ, n_{d},

FIG. 21 is a graph showing a relationship of cavitation number σ and influence function f(σ),

FIGS. 22(a) to 22(d) are views showing images of an observed cavitating jet in the case of changing the cavitation number σ and a bubble collapse site pressure p₂,

FIG. 23 is a chart showing a flow for estimating cavitating jet performance,

FIG. 24 is a chart showing a relationship of each term of Equation (3), parameters to be introduced into each term and a calculation process,

FIG. 25 is a chart showing a flow for estimating the cavitating jet performance,

FIG. 26 is a chart showing a relationship of each term of Equation (3), parameters to be introduced into each term and a calculation process,

FIG. 27 is a diagram schematically showing the hardware configuration of a cavitating jet performance estimation device as another embodiment of the present invention,

FIG. 28 is a diagram schematically showing a function block of the cavitating jet performance estimation device as another embodiment of the present invention,

FIG. 29 is a flow chart showing a process of a power index specification means in the estimation system as another embodiment of the present invention,

FIG. 30 is a flow chart showing a process of an influence function specification means in the estimation system as another embodiment of the present invention, and

FIG. 31 is a flow chart showing a process of a jet performance specification means in the estimation system as another embodiment of the present invention.

### DESCRIPTION OF EMBODIMENTS

Hereinafter, embodiments of the present invention are described.

[1. Concerning Estimation of Cavitating Jet Performance]

A cavitating jet performance estimation method according to the present invention (hereinafter, also referred to as the present estimation method) is a method for estimating cavitating jet performance of a cavitating jet (hereinafter, also referred to as cavitating jet performance). In other words, the present estimation method is a method for obtaining estimated cavitating jet performance of a cavitating jet.

The cavitating jet performance is a value indicating an index of power applied by the action of a cavitating jet and means performance on cavitation peening, surface modification of metal materials, cleaning, chemical reaction treatments or the like by a cavitating jet as described above.

For example, in the case of using a cavitating jet for cavitation peening, a cavitation erosion rate (hereinafter, also referred to as an erosion rate) can be used as an index of the cavitating jet performance since performance of a cavitating jet involved in cavitation peening (processing performance) is a collapse impact force of cavitation bubbles and impact energy calculated from the impact force is in proportion to the erosion rate (time change rate of an erosion amount).

In the present estimation method, in obtaining estimated cavitating jet performance E of a cavitating jet, the following Equation (1) for calculating the estimated cavitating jet performance E is set,

[Equation 19]

E=FX^{n(σ)}Y^{m(σ)} (1)

(In Equation (1), F denotes a term relating to the effect of a cavitation number σ of the cavitating jet, X^{n(σ)} denotes a term relating to a power law of an injection pressure p₁ of the cavitating jet and a power index n(σ) thereof denotes a function of the cavitation number σ, Y^{m(σ)} denotes a term relating to a power law of a nozzle diameter d for producing the cavitating jet and a power index m(σ) thereof denotes a function of the cavitation number σ).

The functions n(σ), m(σ) for the power indices in the Equation (1) are specified from data on the injection pressure p₁, the nozzle diameter d and the cavitation number σ and data on cavitating jet performance E_{Rmax} corresponding to these pieces of data, and the estimated cavitating jet performance E is obtained using the data on the injection pressure p₁, the nozzle diameter d and the cavitation number σ, the Equation (1) and the specified functions n(σ), m(σ) for the power indices.

Further, a cavitating jet performance estimation system according to the present invention (hereinafter, also referred to as the present estimation system) includes a database for accumulating the data on the injection pressure p₁ of the cavitating jet, the nozzle diameter d for producing the cavitating jet and the cavitation number σ and the data on the cavitating jet performance E_{Rmax} corresponding to these pieces of data, a power index specification means for specifying the functions n(σ), m(σ) for the power indices in the Equation (1) for calculating the estimated cavitating jet performance E from the data accumulated in the database and an estimation means for obtaining the estimated cavitating jet performance E using the data on the injection pressure p₁, the nozzle diameter d and the cavitation number σ, the Equation (1) and the specified functions n(σ), m(σ) for the power indices.

Further, a cavitating jet performance estimation device according to the present invention (hereinafter, also referred to as the present estimation device) includes a power index specification means for specifying the functions for the power indices n(σ), m(σ) in the Equation (1) for calculating the estimated cavitating jet performance E from the data on the injection pressure p₁ of the cavitating jet, the nozzle diameter d for producing the cavitating jet and the cavitation number σ and the data on the cavitating jet performance E_{Rmax} corresponding to these pieces of data, and an estimation means for obtaining the estimated cavitating jet performance E using the data on the injection pressure p₁, the nozzle diameter d and the cavitation number σ, the Equation (1) and the specified functions n(σ), m(σ) for the power indices.

Further, the present estimation device includes an estimation means for specifying the functions for the power indices n(σ), m(σ) in the Equation (1) for calculating the estimated cavitating jet performance E from the data accumulated in the database for accumulating the data on the injection pressure p₁ of the cavitating jet, the nozzle diameter d for producing the cavitating jet and the cavitation number σ and the data on the cavitating jet performance E_{Rmax} corresponding to these pieces of data and obtaining the estimated cavitating jet performance E using the data on the injection pressure p₁, the nozzle diameter d and the cavitation number σ, the Equation (1) and the functions n(σ), m(σ) for the power indices specified in advance.

Here, the cavitation number σ is a dimensionless number expressing an occurrence likelihood of cavitation and it is known that cavitation is less likely to occur as the cavitation number σ becomes larger and more likely to occur as the cavitation number σ becomes smaller.

The cavitation number σ can be expressed by the following Equation (4) from a relationship of a saturated steam pressure p_{ν} of fluid for producing the cavitating jet, a nozzle upstream pressure (injection pressure) p₁ and a nozzle downstream pressure (bubble collapse site pressure) p₂ of the cavitating jet.

$$\begin{matrix}[ Equation 20 ] & \\ σ = \frac{{p}_{2} - {p}_{v}}{{p}_{1} - {p}_{2}} & ( 4 )\end{matrix}$$

Further, the equation (4) can be expressed as in the following Equation (5) from p₁>>p₂>>p_{ν}.

$$\begin{matrix}[ Equation 21 ] & \\ σ = \frac{{p}_{2}}{{p}_{1}} & ( 5 )\end{matrix}$$

Alternatively, the cavitation number σ can be expressed by the following Equation (21) where ρ denotes a fluid density of the fluid for producing the cavitating jet and V denotes a flow velocity of a nozzle throat portion.

$$\begin{matrix}[ Equation 22 ] & \\ σ = \frac{{p}_{2} - {p}_{v}}{\frac{1}{2} ρ {V}^{2}} & ( 21 )\end{matrix}$$

The present estimation method, estimation system and estimation device (hereinafter, the present estimation method, estimation system and estimation device are collectively referred to as the present estimation technique) specify the functions n(σ), m(σ) for the power indices in the Equation (1) based on the data on the injection pressure p₁ of the cavitating jet, the nozzle diameter d and the cavitation number σ and obtains the estimated cavitating jet performance E using the data on the injection pressure p₁, the nozzle diameter d and the cavitation number σ, the Equation (1) and the specified functions n(σ), m(σ) for the power indices. Further, in obtaining the estimated cavitating jet performance E of the cavitating jet from the Equation (1), the power index n(σ) of the term relating to the power law of the injection pressure p₁ is a function of the cavitation number σ and the power index m(σ) of the term relating to the power law of the nozzle diameter d is a function of the cavitation number σ.

Conventionally, it has been known as general knowledge that there is a power law for terms relating to hydrodynamic parameters on a cavitating jet and the cavitating jet performance has been estimated by multiplying terms relating to the parameters and raised to some power. However, it is still unknown how much the value of power (power index) should be. As a result, the estimated cavitating jet performance has been different from the actual cavitating jet performance by several to several hundred times in the conventional calculation method.

It was found out that cavitating jet performance could be estimated with higher accuracy than conventional cavitating jet performance estimation techniques by setting a power index of a term relating to a hydrodynamic parameter on a cavitating jet as a function of a cavitation number σ of a cavitating jet, and the present invention was completed.

The Equation (1) for calculating the estimated cavitating jet performance E of the cavitating jet can be expressed by the following Equation (2).

$$[ Equation 23 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

Using the Equation (2), estimated cavitating jet performance E_{cav} can be obtained. It should be noted that, in the Equation (2), E_{ref} denotes cavitating jet performance of a cavitating jet to be referred to, p_{1ref} denotes an injection pressure to be referred to, d_{ref} denotes a nozzle diameter to be referred to, Kₙ denotes a shape function dependent on a nozzle shape or the shape of a testing unit, f(σ) denotes an influence function at the cavitation number σ of the cavitating jet performance to be referred to and f(σ_{ref}) denotes the influence function at a cavitation number σ_{ref} to be referred to.

Here, the influence function is a relational expression expressing a relationship of the cavitation number σ and the cavitating jet performance E_{Rmax} and a function made dimensionless by the value of the cavitating jet performance E_{Rmax} at the cavitation number σₘₐₓ at which the cavitating jet performance E_{Rmax} is maximum. Since this function is the influence function of the cavitation number σ in the cavitating jet performance, it is referred to as an “influence function f(σ) of the cavitation number σ” (or influence function f(σ)) below.

The influence function f(σ) of the cavitation number σ is, for example, such a function that f(σₘₐₓ)=1 in the case of the cavitation number σₘₐₓ when the cavitating jet performance E_{Rmax} exhibits a maximum and a derivative of this influence function is f′(σₘₐₓ)=0.

In the Equation (2), f(σ) is obtained by introducing the cavitation number σ of the cavitating jet to be estimated into the influence function f(σ) of the cavitation number σ. That is, f(σ) of the Equation (2) denotes the influence function at the cavitation number σ of the cavitating jet to be estimated.

In the Equation (2), f(σ_{ref}) is obtained by introducing the cavitation number σ_{ref} of the cavitating jet to be referred to into the influence function f(σ) of the cavitation number σ. That is, f(σ_{ref}) of the Equation (2) denotes the influence function at the cavitation number σ_{ref} of the cavitating jet to be referred to.

It should be noted that this influence function f(σ) is obtained, for example, using a technique described in (Influence Function Specification Process) and (Specification of Influence Function f(σ)) described later. However, other obtaining methods have also been proposed and can be applied to the present estimation technique.

Specifically, in the present estimation technique, the functions n(σ), m(σ) for the power indices in the Equation (2) are specified based on the data on the injection pressure p₁ of the cavitating jet, the nozzle diameter d and the cavitation number σ and the estimated cavitating jet performance E_{cav} is obtained using the injection pressure p₁, the nozzle diameter d and the cavitation number σ of the cavitating jet to be estimated, the influence function f(σ) at the cavitation number σ of the cavitating jet to be estimated, the cavitating jet performance E_{ref}, the injection pressure p_{1ref}, the nozzle diameter d_{ref} and the cavitation number σ_{ref} of the cavitating jet to be referred to, the influence function f(σ_{ref}) at the cavitation number σ_{ref} of the cavitating jet to be referred to, Kₙ indicating the shape function dependent on the nozzle shape or the shape of the testing unit and the specified functions n(σ), m(σ) for the power indices.

As described above, in obtaining the estimated cavitating jet performance E_{cav} of the cavitating jet, the power index n(σ) of the term relating to the power law of the injection pressure p₁ is a function of the cavitation number σ and the power index m(σ) of the term relating to the power law of the nozzle diameter d is a function of the cavitation number σ. It should be noted that since the functions n(σ), m(σ) for the power indices are respectively the function of the term relating to the power law of injection pressure p₁ and the function of the term relating to the power law of the nozzle diameter d, the functions n(σ), m(σ) for the power indices may be respectively denoted by nₚ, n_{d} below for the sake of convenience.

In this case, the Equation (2) for calculating the estimated cavitating jet performance E_{cav} of the cavitating jet can be expressed by the following Equation (3).

$$[ Equation 24 ]$$

$${E}_{cav} = {E}_{ref} {K}_{n} \frac{f ( σ )}{f ( {σ}_{ref} )} {( \frac{{p}_{1}}{{p}_{1 ref}} )}^{{n}_{p}} {( \frac{d}{{d}_{ref}} )}^{{n}_{d}} \qquad ( 3 )$$

It should be noted that the functions nₚ, n_{d} for the power indices in the Equation (3) can be, for example, expressed by the following relational expressions of Equations (6), (7), which are linear expressions of the cavitation number σ, using c₁, c₂, c₃ and c₄ as constants.

[Equation 25]

nₚ=c₁σ+c₂ (6)

[Equation 26]

n_{d}=c₃σ+c₄ (7)

The Equation (3) indicates that the estimated cavitating jet performance E_{cav} can be calculated by multiplying the cavitating jet performance E_{ref} of the cavitating jet to be referred to by Kₙ indicating the shape function dependent on the nozzle shape or the shape of the testing unit, a ratio of the influence function f(σ) at the cavitation number σ of the cavitating jet to be estimated to the influence function f(σ_{ref}) at the cavitation number σ ref of the cavitating jet to be referred to, the nₚ-th power of a ratio of the injection pressure p₁ of the cavitating jet to be estimated to the injection pressure p_{1ref} of the cavitating jet to be referred, nₚ being a function of the cavitation number σ of the term relating to the power law of the injection pressure p₁ and the power index expressed by the Equation (6), and the n_{d}-th power of a ratio of the nozzle diameter d of the cavitating jet to be estimated to the nozzle diameter d_{ref} of the cavitating jet to be referred, n_{d} being a function of the cavitation number σ of the term relating to the power law of the nozzle diameter and the power index expressed by the Equation (7).

In the present invention, in the Equations (2), (3), the cavitating jet performance E_{ref} at each condition is obtained by testing the cavitating jet at various conditions of the injection pressure p₁, the nozzle diameter d and the cavitation number σ, and each function (Kₙ, f(σ) and n(σ) and m(σ) or nₚ and n_{d}) of the Equations (2), (3) for calculating the estimated cavitating jet performance E_{cav} of the cavitating jet is obtained from these pieces of data. The estimated cavitating jet performance E_{cav} of the cavitating jet to be estimated is calculated using the Equation (2) or (3), each function of the Equation (2) or (3), the jet performance E_{ref}, the injection pressure p_{1ref}, the nozzle diameter d_{ref} and the cavitation number σ_{ref} of the cavitating jet to be referred to and the injection pressure p₁, the nozzle diameter d and the cavitation number σ of the cavitating jet to be estimated. In this way, the estimated cavitating jet performance E_{cav} can be obtained with high accuracy from the injection pressure p₁, the nozzle diameter d and the cavitation number σ of the cavitating jet to be estimated without testing the cavitating jet to be estimated by an actual fluid machine and a model fluid machine.

It should be noted that although the present invention specifies the Equation (1), (2) or (3), in estimating the cavitating jet performance, for calculating the estimated cavitating jet performance by specifying the functions n(σ), m(σ) or nₚ, n_{d} for the power indices in advance, the present invention also provides a new technique for specifying such a cavitating jet performance calculation formula.

Specifically, a cavitating jet performance calculation formula specification system according to the present invention (hereinafter, also referred to as the present specification system) includes a database for accumulating the data on the injection pressure p₁ of the cavitating jet, the nozzle diameter d for producing the cavitating jet and the cavitation number σ and the data on the cavitating jet performance E_{Rmax} corresponding to these pieces of data and a power index specification means for specifying the functions n(σ), m(σ) for the power indices in the Equation (1), (2) for calculating the estimated cavitating jet performance E or the functions nₚ, n_{d} in the Equation (3) from the data accumulated in the database.

Further, a cavitating jet performance estimation calculation formula specification device according to the present invention (hereinafter, also referred to as the present specification device) includes a power index specification means for specifying the functions n(σ), m(σ) for the power indices in the Equation (1), (2) for calculating the estimated cavitating jet performance E or the functions nₚ, n_{d} in the Equation (3) from the data on the injection pressure p₁ of the cavitating jet, the nozzle diameter d for producing the cavitating jet and the cavitation number σ and the data on the cavitating jet performance E_{Rmax} corresponding to these pieces of data.

[2. Concerning Estimation Error of Estimated Cavitating Jet Performance and Evaluation of Estimated Cavitating Jet Performance]

Further, the present invention can also obtain an estimation error of the estimated cavitating jet performance and evaluate the cavitating jet performance based on this estimation error.

Specifically, a technique for obtaining a cavitating jet performance estimation error according to the present invention includes a power index specification means for specifying the functions n(σ), m(σ) for the power indices in the Equation (2) for calculating the estimated cavitating jet performance E_{cav} from the data accumulated in the database for accumulating the data on the injection pressure p₁ of the cavitating jet, the nozzle diameter d for producing the cavitating jet and the cavitation number σ and the data on the cavitating jet performance E_{Rmax} corresponding to these pieces of data, and a means for obtaining the estimated cavitating jet performance E_{cav} using the data on the injection pressure p₁, the nozzle diameter d and the cavitation number σ, the Equation (2) and the specified functions n(σ), m(σ) for the power indices and obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

Further, the technique for obtaining a cavitating jet performance estimation error according to the present invention includes an estimation means for specifying the functions n(σ), m(σ) for the power indices in the Equation (2) for calculating the estimated cavitating jet performance E_{cav} from the data accumulated in the database for accumulating the data on the injection pressure p₁ of the cavitating jet, the nozzle diameter d for producing the cavitating jet and the cavitation number σ and the data on the cavitating jet performance E_{Rmax} corresponding to these pieces of data and obtaining the estimated cavitating jet performance E_{cav} using the data on the injection pressure p₁, the nozzle diameter d and the cavitation number σ, the Equation (2) and the specified functions n(σ), m(σ) for the power indices, and a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

Furthermore, a technique for evaluating cavitating jet performance estimation accuracy according to the present invention includes a power index specification means for specifying the functions n(σ), m(σ) for the power indices in the Equation (2) for calculating the estimated cavitating jet performance E_{cav} from the data accumulated in the database for accumulating data on the injection pressure p₁ of the cavitating jet, the nozzle diameter d for producing the cavitating jet and the cavitation number σ and the data on the cavitating jet performance E_{Rmax} corresponding to these pieces of data, an estimation means for obtaining the estimated cavitating jet performance E_{cav} using the data on the injection pressure p₁, the nozzle diameter d and the cavitation number σ, the Equation (2) and the specified functions n(σ), m(σ) for the power indices, a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav} and a means for evaluating the cavitating jet performance estimation accuracy based on the cavitating jet performance estimation error.

Further, the technique for evaluating cavitating jet performance estimation accuracy according to the present invention includes an estimation means for specifying the functions n(σ), m(σ) for the power indices in the Equation (2) for calculating the estimated cavitating jet performance E_{cav} from the data accumulated in the database for accumulating the data on the injection pressure p₁ of the cavitating jet, the nozzle diameter d for producing the cavitating jet and the cavitation number σ and the data on the cavitating jet performance E_{Rmax} corresponding to these pieces of data and obtaining the estimated cavitating jet performance E_{cav} using the data on the injection pressure p₁, the nozzle diameter d and the cavitation number σ, the Equation (2) and the specified functions n(σ), m(σ) for the power indices, a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav} and a means for evaluating the cavitating jet performance estimation accuracy based on the cavitating jet performance estimation error.

[3. Specific Description of Embodiments of Present Invention]

Hereinafter, embodiments of the present invention are specifically described.

### First Embodiment

A cavitating jet performance estimation method, an estimation system according to the estimation method, a program for causing a computer to execute the estimation method and a computer-readable recording medium recording the program are described as one embodiment of the present invention (hereinafter, this embodiment is referred to as a first embodiment).

[3-1-1. Configuration Example of Estimation System]

(Description of Hardware Configuration of Present System)

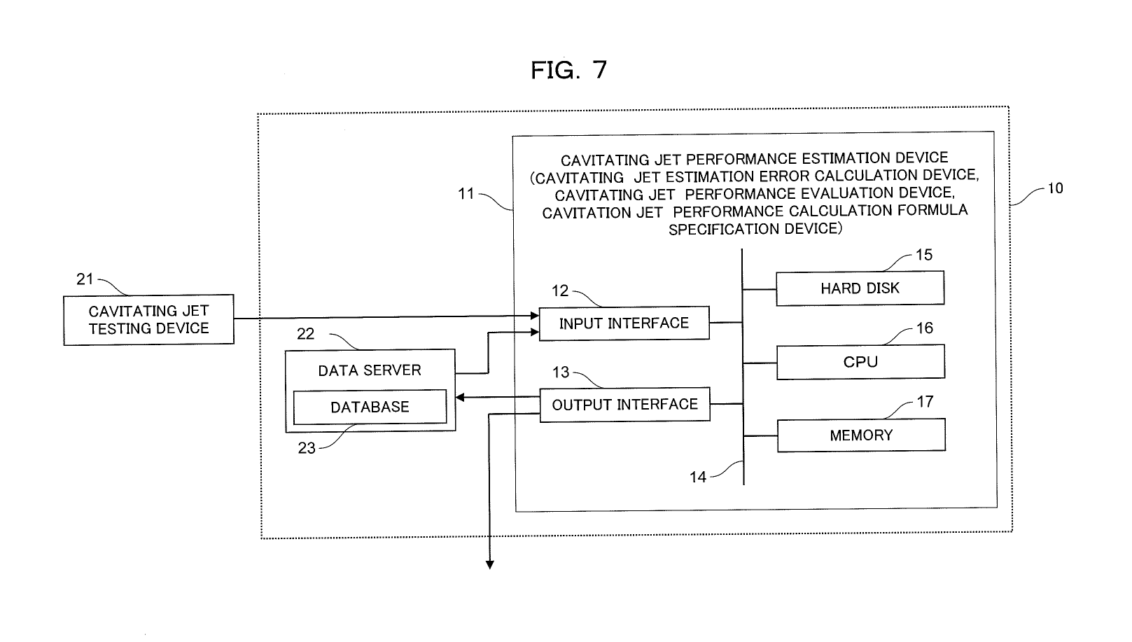

FIG. 7 is a diagram schematically showing the hardware configuration of the cavitating jet performance estimation system as the first embodiment of the present invention.

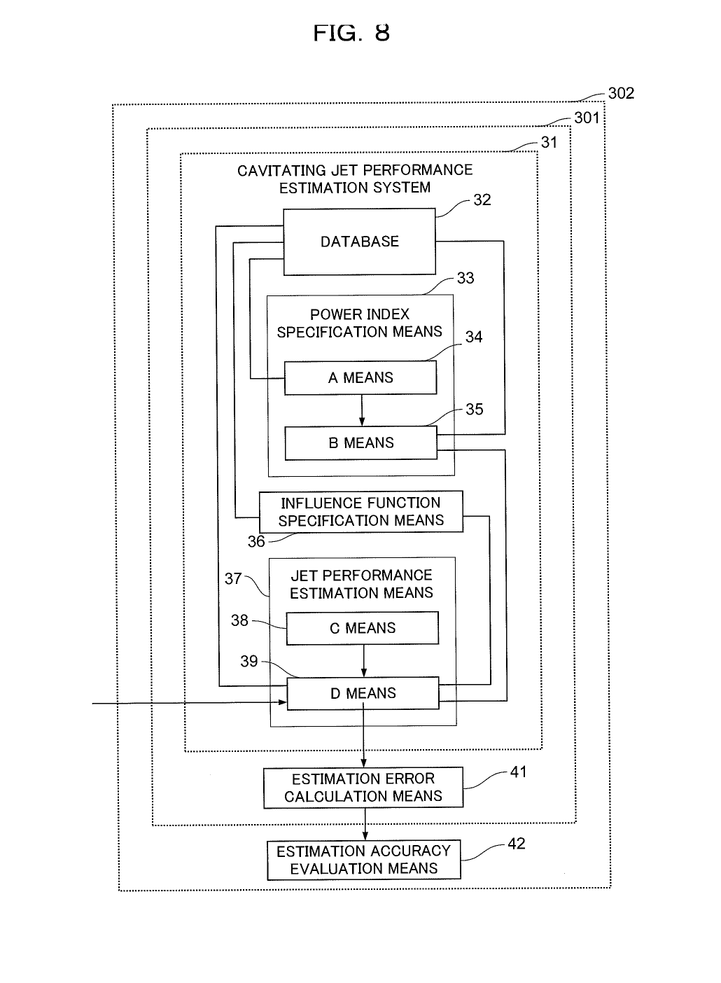

FIG. 8 is a diagram schematically showing a function block of the cavitating jet performance estimation system as the first embodiment of the present invention.

A cavitating jet performance estimation system 10 in the present embodiment includes a cavitating jet performance estimation device 11 and a data server 22 as shown in FIG. 7.

The cavitating jet performance estimation device 11 includes an input interface 12, an output interface 13, a bus 14, a hard disk 15, a CPU (Central Processing Unit) 16, a memory 17 and the like. The data server 22 includes a database 23.

The input interface 12 is a unit for transferring information between the cavitating jet performance estimation device 11 and outside, and appropriately transmits signals to each component 13, 15 to 17 in the cavitating jet performance estimation device 11 via the bus 14 upon receiving information (signal) from the outside.

A cavitating jet testing device 21 is connected to the input interface 12, so that data on cavitating jet performance of a cavitating jet, data on hydrodynamic parameters such as an injection pressure of the cavitating jet, a bubble collapse site pressure, a nozzle diameter and a cavitation number and data on a test result are input to the cavitating jet performance estimation device 11. Further, an unillustrated external memory or keyboard may be connected to the input interface 12, whereby data on the cavitating jet performance, the hydrodynamic parameters and the like may be input to the cavitating jet performance estimation device 11.

Further, the data server 22 provided outside the cavitating jet performance estimation device 11 is connected to the input interface 12. The cavitating jet performance estimation device 11 and the data server 22 may be connected in either wired or wireless manner or may be connected via the Internet.

The data server 22 includes the database 23 (external database). Data on cavitating jet performance, data on hydrodynamic parameters such as an injection pressure of a cavitating jet, a bubble collapse site pressure and a nozzle shape, data on a test result, an influence function f(σ) of a cavitation number σ, Kₙ indicating a shape function dependent on a nozzle shape or the shape of a testing unit and the functions n(σ), m(σ) for the power indices in the Equations (1) and (2) and the functions nₚ, n_{d} for the power indices in the Equation (3) are accumulated and stored in this database 23, so that these pieces of data can be captured or written into the cavitating jet performance estimation device 11.

It should be noted that although the database 23 is stored as an external database in the data server 22 provided outside the cavitating jet performance estimation device 11 in the present embodiment, it may be stored in an unillustrated computer-readable recording medium provided outside the cavitating jet performance estimation device 11 and data may be read therefrom or written therein.

Further, although the database 23 is stored in the data server 22 provided outside the cavitating jet performance estimation device 11 in the present embodiment, it may be stored in the hard disk 15 provided in the cavitating jet performance estimation device 11 or as an internal database in a computer-readable recording medium provided in the cavitating jet performance estimation device 11 and data may be read from this internal database or written therein.

The output interface 13 is a unit for transferring information between the information processing device 11 and outside, and appropriately transmits a signal to the outside upon receiving information (signal) from the components 12, 15 to 17 in the information processing device 11.

Besides a database for accumulating data on the cavitating jet performance and the hydrodynamic parameters, computer software for power index specification, computer software for influence function specification and computer software for jet performance estimation are stored in the hard disk 15.

The CPU 16 is a processing device for performing various controls and operations and realizes various functions by executing the computer software for power index specification, the computer software for influence function specification and the computer software for jet performance estimation stored in the hard disk 15 or the memory 17. The CPU 16 functions as a power index specification means 33, an influence function specification means 36 and a jet performance estimation means 37 shown in FIG. 8 and to be described later by executing these computer programs.

The programs (computer software for power index specification, computer software for influence function specification and computer software for jet performance estimation) for realizing the functions as these power index specification means 33, influence function specification means 36 and jet performance estimation means 37 are provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc. The cavitating jet performance estimation device 11 reads the programs from that recording medium and transfers and stores them to and in the internal storage device (e.g. hard disk 15 or memory 17) or the external storage device to use them. Further, those programs may be recorded in an unillustrated storage device (recording medium) such as a magnetic disc, an optical disc or a magnetic optical disc and provided to the cavitating jet performance estimation device 11 from that storage device via a communication path.

In realizing the functions as the power index specification means 33, the influence function specification means 36 and the jet performance estimation means 37, the programs stored in the internal storage device (hard disk 15 or memory 17 in the present embodiment) are executed by a microprocessor (CPU 16 in the present embodiment) of the cavitating jet performance estimation device 11. At this time, the programs recorded in the unillustrated external recording medium may be read and executed by a computer.

Here, the computer software for power index specification specifies the functions n(σ), m(σ) for the power indices in the Equation (1) or (2) for calculating the estimated cavitating jet performance from the data accumulated in the database 23. Alternatively, this computer software specifies the functions nₚ, n_{d} for the power indices if the Equation (1) for calculating the estimated cavitating jet performance of the cavitating jet is the Equation (3).

The computer software for influence function specification obtains the influence function f(σ) of the cavitation number σ from a relationship of the cavitation number σ and the cavitating jet performance E_{Rmax}.

The computer software for jet performance estimation obtains the estimated cavitating jet performance E using the data on the injection pressure p₁, the nozzle diameter d and the cavitation number σ, the Equation (1) and the specified functions n(σ), m(σ) for the power indices. Alternatively, this computer software obtains the estimated cavitating jet performance E_{cav} using the data on the injection pressure p₁, the nozzle diameter d and the cavitation number σ of the cavitating jet to be estimated, the data on the cavitating jet performance E_{ref}, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (2) and the specified functions n(σ), m(σ) for the power indices. Alternatively, this computer software obtains the estimated cavitating jet performance E_{cav} using the data on the injection pressure p₁, the nozzle diameter d and the cavitation number σ of the cavitating jet to be estimated, the data on the cavitating jet performance E_{ref}, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (3) and the functions nₚ, n_{d} for the power indices.

These computer software for power index specification, computer software for influence function specification and computer software for jet performance estimation are stored in various computer-readable recording media.

It should be noted that, in the present embodiment, a computer is a concept including hardware and an operating system and means the hardware that operates under the control of the operating system. Further, if no operating system is necessary and hardware is operated singly by an application program, the hardware itself is equivalent to the computer. The hardware includes at least a microprocessor such as a CPU and a means for reading a computer program recorded in a recording medium.

The memory 17 is a storage unit for storing various pieces of data and programs and realized, for example, a volatile memory such as a RAM (Random Access Memory) or a nonvolatile memory such as a ROM or a flash memory. In the present embodiment, the computer software for power index specification, the computer software for influence function specification and the computer software for jet performance estimation to be executed by the CPU 16, the data on the hydrodynamic parameters such as the injection pressure, the nozzle diameter and the cavitation number, data on the cavitating jet performance of the cavitating jet, the data on Kₙ indicating the shape function dependent on the nozzle shape or the shape of the testing unit and the data on the functions for the power indices are stored in the memory 17.

(Description of Hardware Configuration of Cavitating Jet Testing Device)

Next, the configuration of a cavitating jet testing device to be connected to the cavitating jet performance estimation system 10 is described.

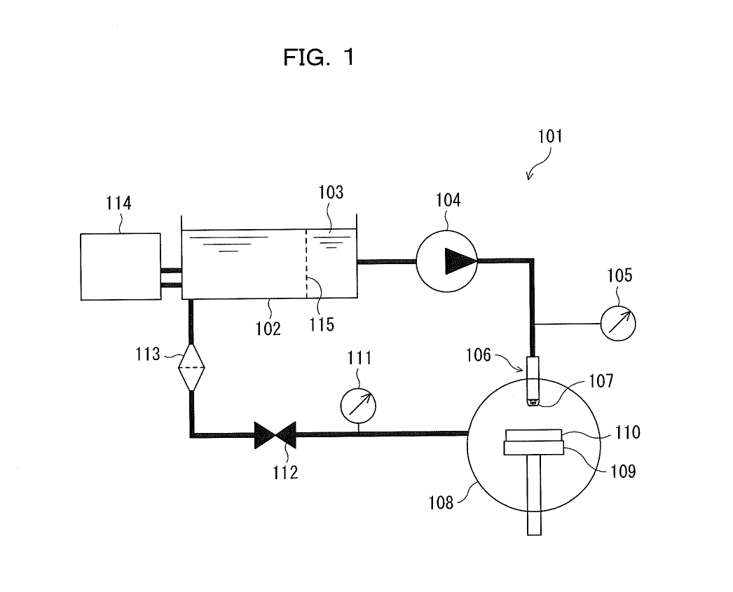

FIG. 1 is a diagram schematically showing the configuration of a cavitating jet testing device 101 used in the present embodiment.

As shown in FIG. 1, the present cavitating jet testing device 101 includes a water tank 102, sample water 103, a plunger pump 104, a nozzle 106, a testing unit 108, a test piece 110, an upstream pressure gauge 105, a downstream pressure gauge 111, a downstream valve 112, a filter 113, a cooling machine 114 and a partition wall 115. It should be noted that a tip part of the nozzle 106 is denoted by 107 in FIG. 1.

The cavitating jet testing device 101 pressurizes the sample water 103 stored in the water tank 102 by the plunger pump 104 and injects the pressurized sample water 103 to the test piece 110 (hereinafter, also referred to as an erosion test piece) via the nozzle tip part 107 of the nozzle 106. The erosion test piece 110 is placed on a test stand 109 in the sealable testing unit 108. A nozzle upstream pressure (injection pressure) p₁ can be measured by the upstream pressure gauge 105 and is controlled by a rotational speed of an inverter of the plunger pump 104. A nozzle downstream pressure (bubble collapse site pressure) p₂ which is a pressure in the testing unit 108 can be measured by the downstream pressure gauge 111 and is controlled by regulating a flow rate from the testing unit. The cavitating jet testing device 101 includes the cooling machine 114 and can cool the sample water 103. Further, the clean sample water 103 can be provided for a cavitating jet by the filter 113 and the partition wall 115 provided in the water tank 102.

The cavitating jet testing device 101 is configured as described above and can obtain a cavitation erosion rate as an index of cavitating jet performance by conducting a test (cavitating jet test) for causing a cavitating jet to act on the test piece 110 and measuring an erosion amount of the test piece 110 per unit time at each condition while changing the aforementioned conditions such as the nozzle upstream pressure (injection pressure) p₁, the nozzle downstream pressure (bubble collapse site pressure) p₂ and the shape of the nozzle tip part 107.

(Concerning Nozzle Shape K)

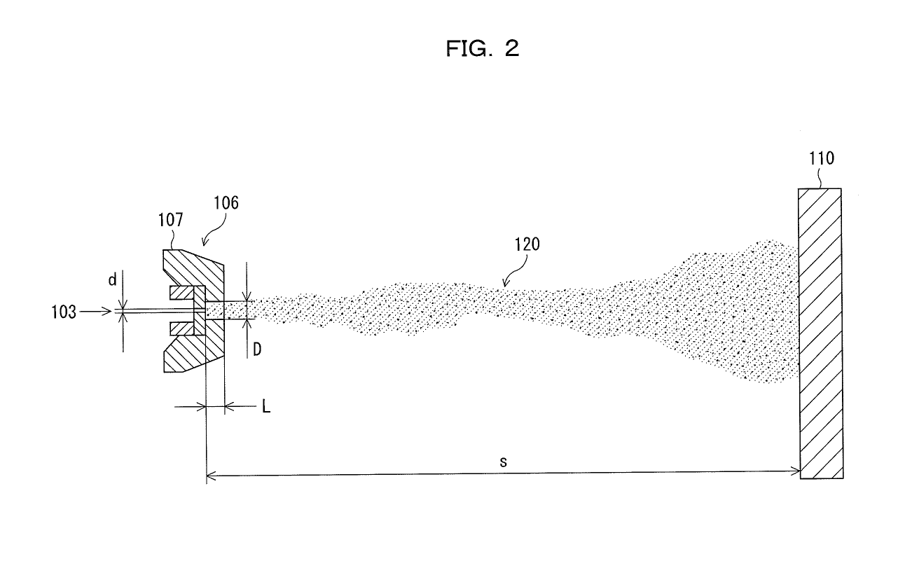

FIG. 2 is a diagram schematically showing a relationship between dimensions of the tip part 107 of the nozzle 106 of the cavitating jet testing device 101 used in the present embodiment and the test piece.

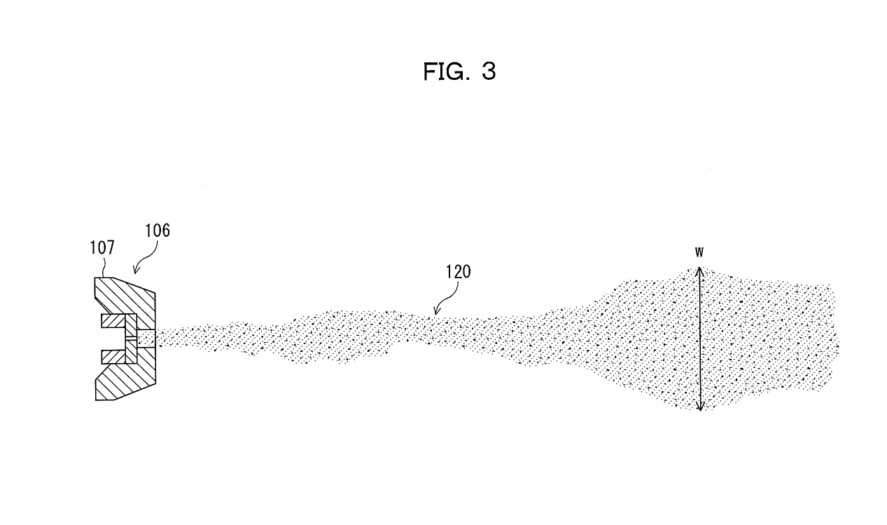

FIG. 3 is a diagram schematically showing a relationship between the tip part 107 of the nozzle 106 of the cavitating jet testing device 101 used in the present embodiment and a cavitating jet,

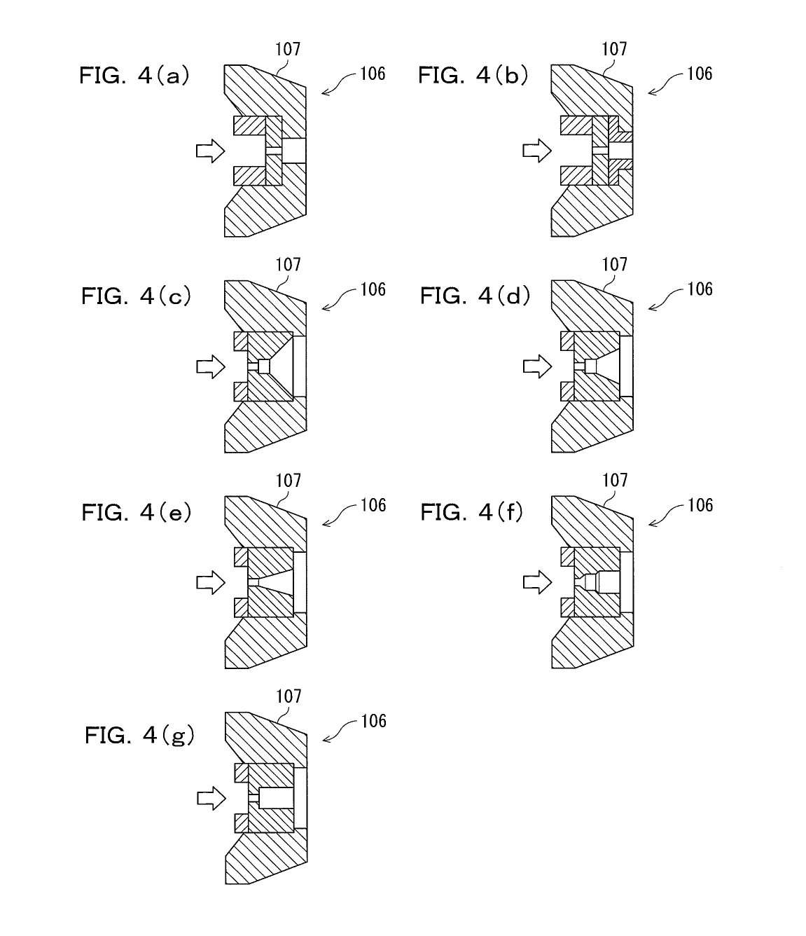

FIGS. 4(a) to 4(g) are diagrams schematically showing cross-sectional shapes of tip parts 107 of various nozzles 106 in the cavitating jet testing device 101 used in the present embodiment.

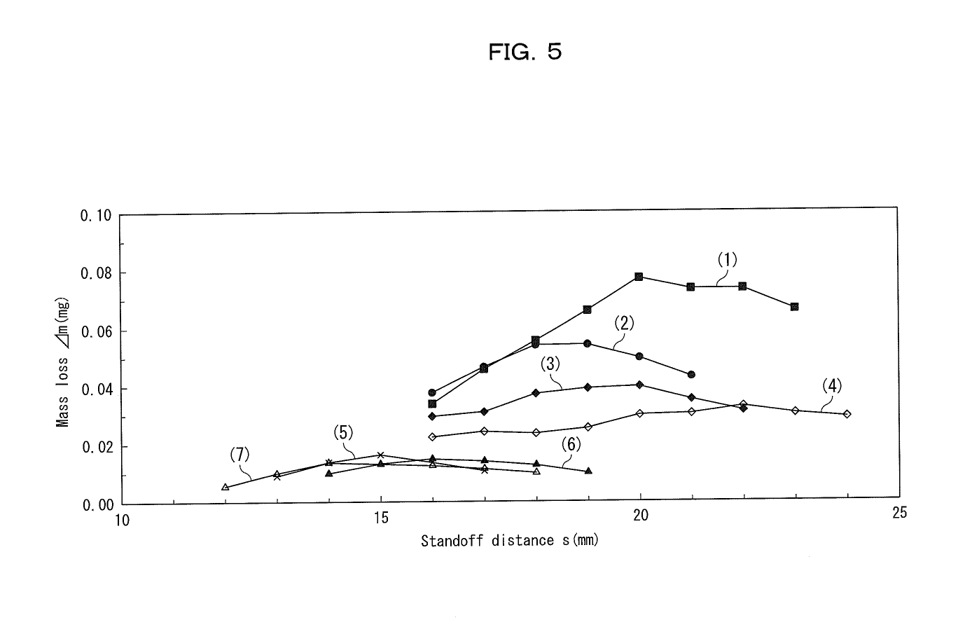

FIG. 5 is a graph showing a standoff distance and an erosion amount of each nozzle 106 of the cavitating jet testing device 101.

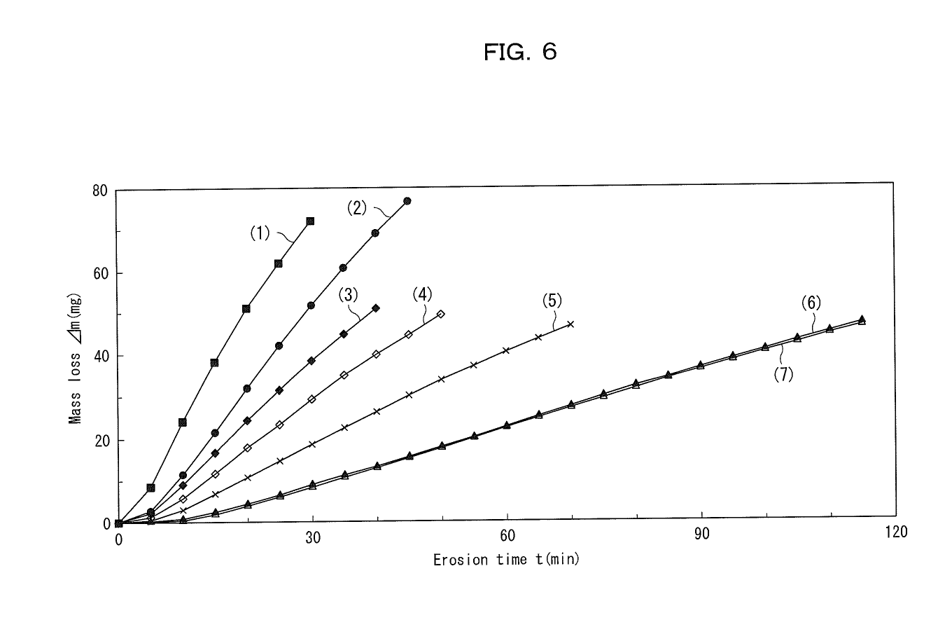

FIG. 6 is a graph showing an erosion time and the erosion amount of each nozzle 106 of the cavitating jet testing device 101.

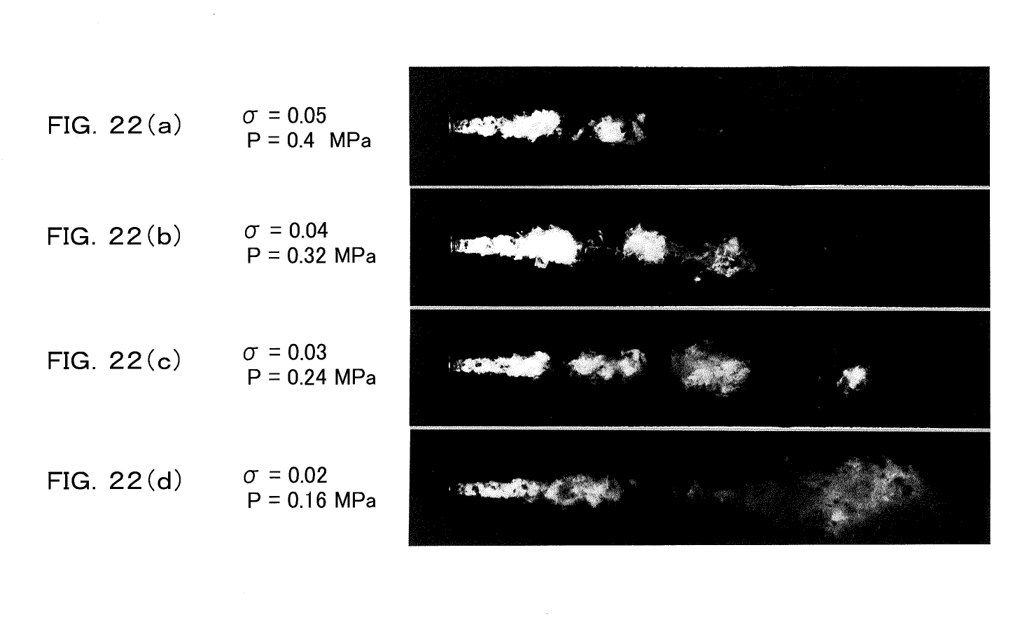

FIGS. 22(a) to 22(d) are views showing images of an observed cavitating jet in the case of changing the cavitation number σ and the bubble collapse site pressure p₂ in the cavitating jet testing device 101.

The tip part 107 of the nozzle 106 of the cavitating jet testing device 101 comes in various shapes as illustrated in FIGS. 4(a) to 4(g).

As shown in FIGS. 22(a) to 22(d), the cavitating jet can be observed by processing images photographed using a high-speed video camera. The behavior of the cavitating jet is understood to change according to the cavitation number σ and the bubble collapse site pressure p₂ (i.e. injection pressure p₁ and bubble collapse site pressure p₂).

FIG. 2 schematically shows a cavitating jet 120. The sample water 103 is introduced from a left side of the nozzle tip part 107 in FIG. 2 and the cavitating jet 120 is injected from a right side in FIG. 2. d denotes a diameter of a nozzle throat of the tip part 107 of the nozzle 106 (hereinafter, also merely referred to as a nozzle diameter), D denotes a cylinder diameter of a nozzle exit portion, L denotes a cylinder length of the nozzle exit portion and s denotes a distance from an exit-side end part of the nozzle throat portion to the test piece 110 (hereinafter, also referred to as a standoff distance).

Further, as schematically shown in FIG. 3, w denotes a width of a widest part of the cavitating jet 120.

By using the cavitating jet testing device 101, the erosion quantity of the test piece 110 by the cavitating jet can be measured. At this time, the erosion quantity can be measured at each parameter condition by changing the injection pressure p₁, the bubble collapse site pressure p₂, the nozzle diameter d, the cylinder diameter D, the cylinder length L, the standoff distance s and an erosion time which is a time during which the cavitating jet 120 is caused to act on the test piece 110.

As shown in FIG. 5, the erosion quantity changes according to the standoff distance s and an optimum standoff distance s_{oft}, which is a standoff distance at which the erosion quantity is maximum, changes according to nozzle shapes (1) to (7) (nozzle shapes (1) to (7) correspond to the shapes of the nozzles respectively shown in FIGS. 4(a) to 4(g). The same applies hereinafter.).

Further, as shown in FIG. 6, the erosion quantity Δm changes according to the erosion time t and the nozzle shapes (1) to (7) also affect a change of the erosion quantity.

Kₙ in the Equations (2), (3) for calculating the estimated cavitating jet performance of the cavitating jet is a shape function dependent on the shape of the test piece 110 such as the aforementioned cylinder diameter D and cylinder length L of the nozzle. This function may also be a constant.

As described above, the optimum standoff distance sₒₚₜ which exhibits a maximum is present in the action (erosion amount, erosion rate) by the cavitating jet and changes according to the time during which the cavitating jet is caused to act (erosion time). Thus, in first measuring the cavitating jet performance using the cavitating jet testing device 101, tests are conducted at various injection pressures p₁ and nozzle diameters d to clarify the optimum standoff distance sₒₚₜ at each condition. Thereafter, erosion tests are conducted while the erosion time is changed at the optimum standoff distance sₒₚₜ, thereby obtaining maximum cavitating jet performance (maximum cumulative erosion rate). Kₙ, the functions for the power indices and the influence function at the maximum cumulative erosion rate at each of these conditions can be empirically obtained.

[3-1-2. Functional Configuration of Estimation System]

Next, the functional configuration of the cavitating jet performance estimation system of the present embodiment is described.

FIG. 8 is a diagram schematically showing a function block of the cavitating jet performance estimation system as the first embodiment of the present invention.

In functionally expressing the cavitating jet performance estimation system 31 of the present embodiment, the cavitating jet performance estimation system 31 includes the database 32, the power index specification means 33, the influence function specification means 36 and the jet performance estimation means 37 as shown in FIG. 8. By executing the software by the computer programs, this software functions as these power index specification means 33, influence function specification means 36 and jet performance estimation means 37. This software is stored in the memory 17 and read and executed by the CPU 16.

The database 32 is a database for accumulating data on the cavitating jet performance of the cavitating jet, the hydrodynamic parameters such as the injection pressure, the bubble collapse site pressure, the nozzle diameter and the cavitation number and data on equations and functions used in the calculation of the estimated cavitating jet performance.

The cavitating jet performance of the cavitating jet, the injection pressure p₁, the bubble collapse site pressure p₂, the nozzle diameter d, the cavitation number σ, the influence function f(σ) of the cavitation number σ specified by the influence function specification means 36 to be described later and Kₙ indicating the shape function dependent on the nozzle shape or the shape of the testing unit are stored in the database 32. Further, relational expressions expressing relationships of the cavitation number σ and the power indices of the Equations (1) to (3) specified by a B means 35 to be described later (functions for the power indices), i.e. the functions n(σ), m(σ) for the power indices in the Equations (1) and (2) and the functions nₚ, n_{d} for the power indices in the Equation (3) are stored in the database 32.

These pieces of data are stored in association with each combination of data on actually measured cavitating jet performance at each condition obtained by conducting a cavitating jet test for evaluating the cavitating jet performance at various conditions of the injection pressure p₁, the bubble collapse site pressure p₂, the nozzle diameter d and the cavitation number σ using the aforementioned cavitating jet testing device. The more data of the actually measured cavitating jet performance there is at each condition, the more accurately the estimation of the cavitating jet performance to be described later can be made.

The power index specification means 33 is composed of an A means 34 and the B means 35.

The A means 34 obtains the injection pressure p₁ of the cavitating jet and a relationship of the actually measured cavitating jet performance E_{Rmax} with the injection pressure p₁ accumulated in the database 32 and obtains the nozzle diameter d of the cavitating jet and a relationship of the actually measured cavitating jet performance E_{Rmax} with the nozzle diameter d.

The B means 35 specifies a relationship of the cavitation number σ and the function n(σ) for the power index in the Equations (1) and (2) or a relationship of the cavitation number σ and the function nₚ for the power index in the Equation (3) as a relational expression (6), which is a function of σ, from the injection pressure p₁ of the cavitating jet and the relationship of the actually measured cavitating jet performance E_{Rmax} with the injection pressure p₁ obtained by the A means 34. Further, the B means 35 specifies a relationship of the cavitation number σ and the function m(σ) for the power index in the Equations (1) and (2) or a relationship of the cavitation number σ and the function n_{d} for the power index in the Equation (3) as a relational expression (7), which is a function of σ, from the relationship of the cavitating jet performance E_{Rmax} with the nozzle diameter d obtained by the A means 34.

The relational expression expressing the relationship of the cavitation number σ and the function n(σ) for the power index in the Equations (1) and (2) or the relational expression (6) expressing the relationship of the cavitation number σ and the function nₚ for the power index in the Equation (3), and the relational expression expressing the relationship of the cavitation number σ and the function m(σ) for the power index in the Equations (1) and (2) or the relational expression (7) expressing the relationship of the cavitation number σ and the function n_{d} for the power index in the Equation (3) obtained in this way are stored in the database 32.

The influence function specification means 36 obtains the influence function f(σ) of the cavitation number σ from the relationship of the cavitation number σ and the cavitating jet performance E_{Rmax}.

The jet performance estimation means 37 is composed of a C means 38 and a D means 39.

The C means 38 sets an order of operations in calculating the cavitating jet performance for the data on the injection pressure p₁, the nozzle diameter d and the cavitation number σ.

The D means 39 obtains the estimated cavitating jet performance E using the data on the injection pressure p₁, the nozzle diameter d and the cavitation number σ, the Equation (1) and the functions n(σ), m(σ) for the power indices specified by the B means 35 in accordance with the order of operations set by the C means 38.

Alternatively, the D means 39 obtains the estimated cavitating jet performance E_{cav} using the data input from the outside on the injection pressure p₁, the nozzle diameter d and the cavitation number σ of the cavitating jet to be estimated, the data stored in the database 32 on the cavitating jet performance E_{ref}, the injection pressure p_{1ref}, the nozzle diameter d_{ref} and the cavitation number σ_{rd} of the cavitating jet to be referred to, the data on Kₙ indicating the shape function dependent on the nozzle shape or the shape of the testing unit, the Equation (2), the functions n(σ), m(σ) for the power indices specified by the B means 35 and the influence functions f(σ), f(σ_{ref}) of the cavitation numbers σ and the σ_{ref} specified by the influence function specification means 36.

Alternatively, the D means 39 obtains the estimated cavitating jet performance E_{cav} using the data input from the outside on the injection pressure p₁, the nozzle diameter d and the cavitation number σ of the cavitating jet to be estimated, the data stored in the database 32 on the cavitating jet performance E_{ref}, the injection pressure p_{1ref}, the nozzle diameter d_{ref} and the cavitation number σ_{rd} of the cavitating jet to be referred to, the data on Kₙ indicating the shape function dependent on the nozzle shape or the shape of the testing unit, the Equation (3), the functions nₚ, n_{d} for the power indices expressed by the Equations (6), (7) and specified by the B means 35 and the influence functions f(σ), f(σ_{ref}) of the cavitation numbers σ and the σ_{ref} specified by the influence function specification means 36.

[3-1-3. Operation of Estimation System and Cavitating Jet Performance Estimation Method Using Estimation System]

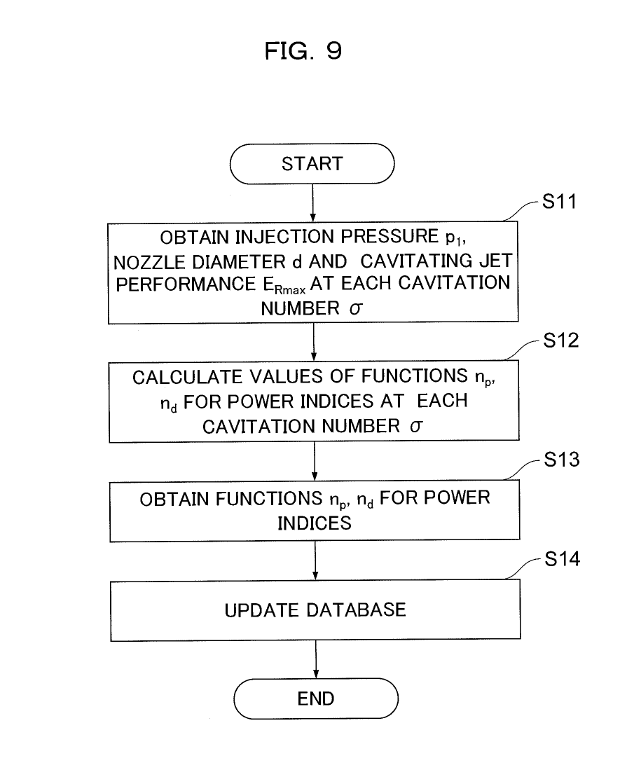

Operations in a power index specification process, an influence function specification process and a jet performance estimation process of the cavitating jet performance estimation system of the present embodiment are described in accordance with flow charts shown in FIGS. 9 to 11.

FIG. 9 is a flow chart showing a process of the power index specification means 33 in the cavitating jet performance estimation system as the first embodiment of the present invention.

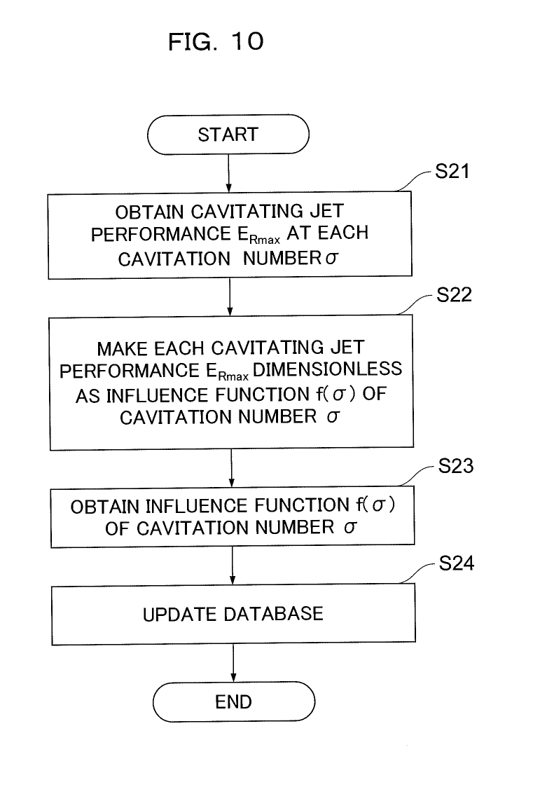

FIG. 10 is a flow chart showing a process of the influence function specification means 36 in the cavitating jet performance estimation system as the first embodiment of the present invention.

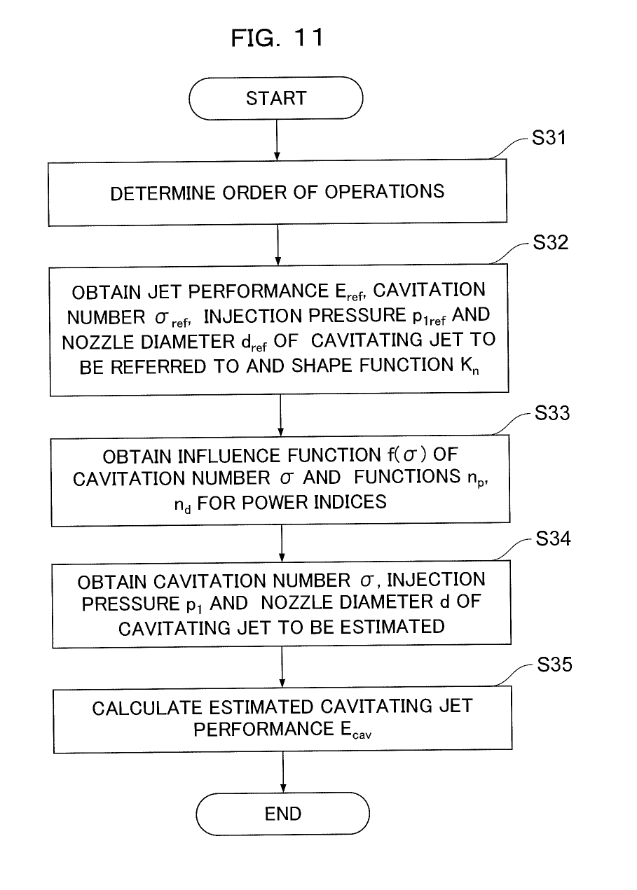

FIG. 11 is a flow chart showing a process of the jet performance estimation means 37 in the cavitating jet performance estimation system as the first embodiment of the present invention.

(Power Index Specification Process)

As shown in FIG. 9, the A means 34 first obtains the injection pressure p₁ and the cavitating jet performance E_{Rmax} at each cavitation number σ and the nozzle diameter d and the cavitating jet performance E_{Rmax} at each σ from the database 32 (Step S11).

In the power index specification process, the functions n(σ), m(σ) for the respective power indices of the injection pressure p₁ and the nozzle diameter d are obtained from these pieces of data. Specifically, the functions nₚ, n_{d} for the power indices of the respective terms of the injection pressure p₁ and the nozzle diameter d in the Equation (3) expressed by the Equations (6), (7) are obtained.

If the cavitating jet performance E_{Rmax} is shown in relation to the injection pressure p₁ and the nozzle diameter d on a double-logarithmic graph, linear relationships are respectively confirmed on the double-logarithmic graph and it is understood that a power law holds for each cavitation number σ. The A means 34 can obtain the power index nₚ, n_{d} as a gradient of the cavitating jet performance E_{Rmax} in relation to the injection pressure p₁ or the nozzle diameter d at each cavitation number σ on the double-logarithmic graph. At this time, since the values of the power indices nₚ, n_{d} change depending on the cavitation number σ, the values of the functions nₚ, n_{d} for the respective power indices at each cavitation number σ in the case of assuming the power law are calculated (Step S12).

Subsequently, the B means 35 obtains the functions nₚ, n_{d} for the power indices from relationships of the cavitation number σ and the values of the power indices nₚ, n_{d}. Since a linear relationship can be confirmed between the cavitation number σ and the function nₚ for the power index, a linear expression is assumed and the power index of the term of the injection pressure p₁ in the Equation (3) is obtained as the function nₚ expressed by the cavitation number σ. Similarly, since a liner relationship can be confirmed between a and n_{d}, a linear expression is assumed and the power index of the term of the nozzle diameter d in the Equation (3) is obtained as the function n_{d} expressed by the cavitation number σ (Step S13).

The function nₚ for the power index of the term of the injection pressure p₁ and the function n_{d} for the power index of the term of the nozzle diameter d obtained in this way are stored in the database 32 (Step S14).

(Influence Function Specification Process)

As shown in FIG. 10, the influence function specification means 36 obtains the actually measured cavitating jet performance E_{Rmax} at each cavitation number σ from the database 32 (Step S21).

Subsequently, the influence function specification means 36 makes the cavitating jet performance E_{Rmax} dimensionless as the influence function f(σ) of the cavitation number σ by the value of σ, at which the cavitating jet performance E_{Rmax} is maximum, at each injection pressure p₁ and each nozzle diameter d (Step S22). Specifically, f(σ) is normalized to be 1 at the value of σ at which the cavitating jet performance E_{Rmax} is maximum at each injection pressure p₁ and each nozzle diameter d by dividing the cavitating jet performance E_{Rmax} at each σ by the value of the cavitating jet performance E_{Rmax} at the value of σ at which the cavitating jet performance E_{Rmax} is maximum.

Further, assuming an approximation expression using σ as a variable as f(σ), the influence function f(σ) is obtained (Step S23).

Here, the influence function f(σ) of the cavitation number σ is preferably defined to be a function different before and after a cavitation number σₘₐₓ exhibiting maximum cavitating jet performance.

For example, since the influence function f(σ) exhibits a maximum at the cavitation number σₘₐₓ exhibiting maximum cavitating jet performance at each injection pressure p₁ and each nozzle diameter d, it is thought that f(σₘₐₓ)=1, f′(σₘₐₓ)=0. Further, at σ≈0, it can be assumed that f(0)=0 since there is thought to be no action by the cavitating jet. In consideration of the above, in a region of the cavitation number σ where a σₘₐₓ (or σ<σₘₐₓ), a cubic expression of σ is preferably assumed as f(σ) and each coefficient of f(σ) can be obtained by applying Newton's method to actual measurement values of σ≦σₘₐₓ.

On the other hand, at a σ≧σₘₐₓ (or σ>σₘₐₓ), a cavitation occurrence area is reduced and f(σ) decreases as a increases. If σ is larger than an incipient cavitation number σᵢ (or desinent cavitation number σ_{d}), the cavitation does not occur, wherefore f(σᵢ)=0. Specifically, since f(σ) is thought to monotonously decrease in the range of the cavitation number σ where σ≧σₘₐₓ (or σ>σₘₐₓ), it is preferable to assume a linear expression.

The influence function f(σ) of the cavitation number σ obtained in this way is stored in the database 32 (Step S24).

(Jet Performance Estimation Process)

As shown in FIG. 11, the C means 38 sets the order of operations in calculating the cavitating jet performance for the data on the injection pressure p₁, the nozzle diameter d and the cavitation number σ (Step S31).

Here, six combinations are considered depending on the order of operations of three parameters. In terms of operation accuracy, the order of operations is preferably such that the cavitation number σ comes first and then the injection pressure p₁ or the nozzle diameter d comes next. Specifically, a preferred order of operations is cavitation number σ→injection pressure p₁→nozzle diameter d or cavitation number σ→nozzle diameter d→injection pressure p₁.

Subsequently, the D means 39 obtains the jet performance E_{ref}, the cavitation number σ_{ref}, the injection pressure p_{1ref} and the nozzle diameter d_{ref} and of the cavitating jet to be referred to and the shape function Kₙ from the database 32 (Step S32). These pieces of data to be referred to are pieces of actually measured data obtained by conducting a test for evaluating the cavitating jet performance in advance.

It should be noted that, from the perspective of estimation accuracy in the calculation of the estimated cavitating jet performance, it is preferable to obtain data on the cavitation number σ_{ref}, the injection pressure p_{1ref} and the nozzle diameter d_{ref} having values approximate to the injection pressure p₁, the nozzle diameter d and the cavitation number σ of the cavitating jet to be estimated as the data of the cavitating jet to be referred to used in the calculation of the estimated cavitating jet performance. Above all, it is particularly preferable to obtain the data with the cavitation number σ_{ref} of the cavitating jet to be referred to having a value approximate to the cavitation number σ of the cavitating jet to be estimated.

Further, the D means 39 obtains the influence function f(σ) of the cavitation number σ obtained in Step S13, the function nₚ for the power index of the term of the injection pressure p₁ and the function n_{d} for the power index of the term of the nozzle diameter d obtained in Step S23 from the database 32 (Step S33).

Furthermore, the D means 39 obtains the cavitation number σ, the injection pressure p₁ and the nozzle diameter d of the cavitating jet to be estimated (Step S34).

Then, the D means 39 calculates the estimated cavitating jet performance E_{cav} by introducing the value of the cavitating jet performance of the cavitating jet to be referred to into E_{ref}, the value of the shape function into Kₙ, the value of the influence function f(σ) at the cavitation number σ of the cavitating jet to be estimated into f(σ), the value of the influence function gσ_{ref}) at the cavitation number σ_{ref} of the cavitating jet to be referred to into gσ_{ref}), the value of the injection pressure of the cavitating jet to be estimated into p₁, the value of the injection pressure of the cavitating jet to be referred to into p_{1ref}, the value of the nozzle diameter of the cavitating jet to be estimated into d, the value of the nozzle diameter of the cavitating jet to be referred to into d_{ref}, the value of the function nₚ for the power index of the term of the injection pressure p₁ at the cavitation number σ of the cavitating jet to be estimated into nₚ and the value of the function n_{d} for the power index of the term of the nozzle diameter d at the cavitation number σ of the cavitating jet to be estimated into n_{d} in the Equation (3) (Step S35).

It should be noted that although the order of operations is obtained (Step S31) before obtaining each piece of data (Step S32 to 34) in the present embodiment, the order of operations may be obtained after obtaining each piece of data. Further, a sequence of obtaining each piece of data (Step S32 to 34) may be exchanged.

Further, although the functions nₚ, n_{d} for the power indices obtained by the B means 35 are stored in the database 32 and the D means 39 obtains them from the database 32 in Step S33 in the present embodiment, the functions nₚ, n_{d} for the power indices obtained by the B means 35 may be directly used by the D means 39 without being stored in the database 32.

Further, although the influence function f(σ) of the cavitation number σ obtained by the influence function specification means 36 is stored in the database 32 and the D means 39 obtains it from the database 32 in Step S33 in the present embodiment, the influence function f(σ) of the cavitation number σ obtained by the influence function specification means 36 may be directly used by the D means 39 without being stored in the database 32.

(Estimation Process of Estimated Cavitating Jet Performance)

Here, the estimation process of the estimated cavitating jet performance by the Equation (3), particularly the processing in Step S35 described above, is described in detail.

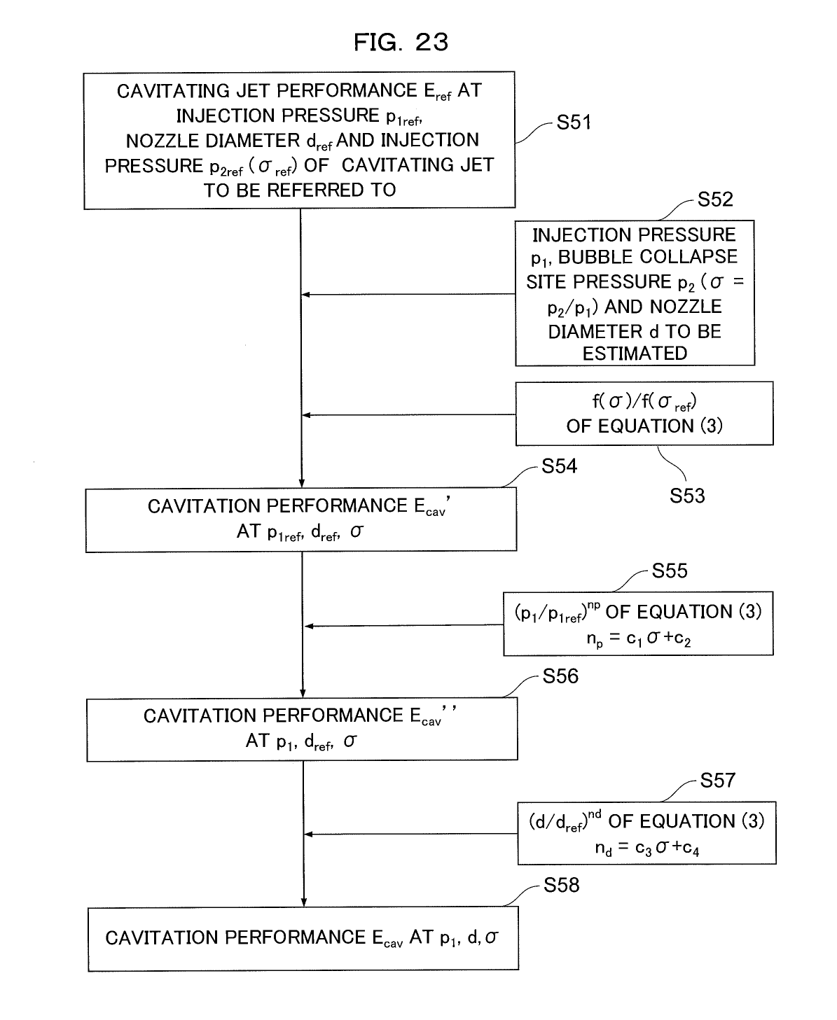

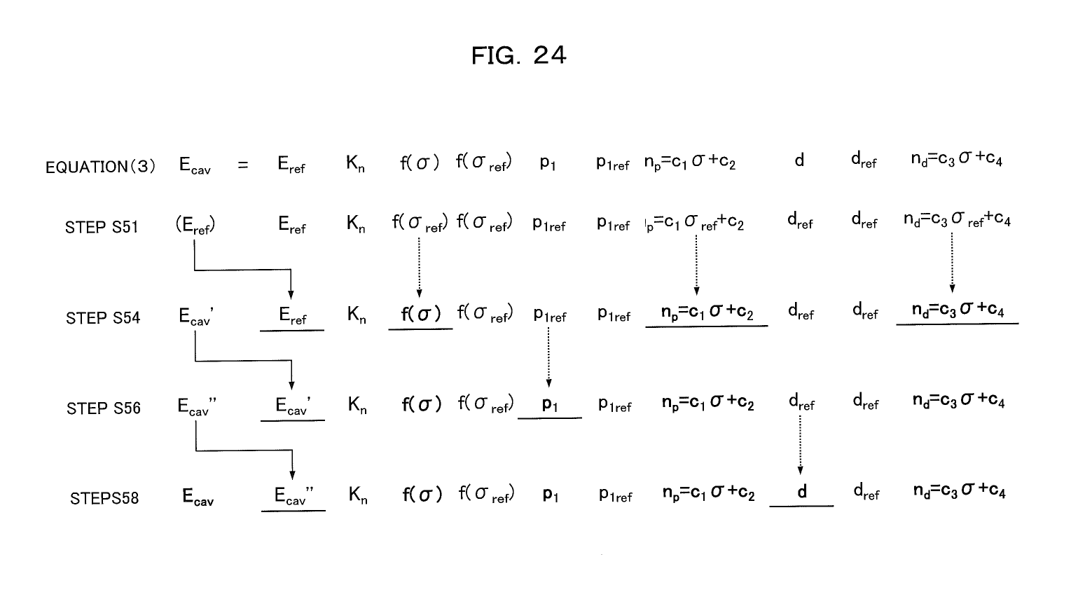

The estimation process of the cavitating jet performance performed by the D means 39 is described using FIGS. 23 and 24. Although a case where the cavitating jet performance E_{cav} is calculated in the order of operations of cavitation number σ→injection pressure p₁→nozzle diameter d is described as an example here, the estimation process can be similarly performed even if the order of operations is different.

FIG. 23 is a chart showing a flow for estimating the cavitating jet performance to describe the estimation process.

FIG. 24 is a chart showing a relationship of each term of the Equation (3), parameters to be introduced into each term and a calculation process to describe the estimation process.

In the present embodiment, in calculating the estimated cavitating jet performance E_{cav}, the parameters including the injection pressure p₁, the nozzle diameter d and the cavitation number σ are successively introduced one by one into the Equation (3) based on the order of operations obtained in Step S31 by the C means 38 to calculate an estimated value of the cavitating jet performance.

First, the flow of the estimation process of the present embodiment is described using FIG. 23.

First, using the Equation (3), the cavitating jet performance is estimated when all the parameters including the injection pressure p₁, the nozzle diameter d and the cavitation number σ are parameters of the cavitating jet to be referred to, i.e. at the injection pressure p_{1ref}, the nozzle diameter d_{ref} and the injection pressure p_{2ref} (σ_{ref}=p_{2ref}/p_{1ref}). The estimated cavitating jet performance at this time is expressed as the cavitating jet performance E_{ref} of the cavitating jet to be referred to if the shape function Kₙ=1 (Step S51).

Subsequently, the injection pressure p₁, the bubble collapse site pressure p₂ (σ=p₂/p₁) and the nozzle diameter d of the cavitating jet to be estimated are obtained (Step S52). It should be noted that this processing is equivalent to Step S34 of FIG. 11.

Further, f(σ)/f(σ_{ref}) of the Equation (3) is calculated (Step S53).

Then, using the Equation (3), estimated cavitating jet performance E_{cav}′ when the parameter of the cavitating jet to be estimated is introduced only into the first parameter in the order of operations (here, cavitation number σ), i.e. at p_{1ref}, d_{ref} and σ is calculated (Step S54).

Subsequently, (p₁/p_{1ref})^{np} and nₚ=c₁σ+c₂ of the Equation (3) are calculated (Step S55).

Then, using the Equation (3), estimated cavitating jet performance E_{cav}″ when the parameters of the cavitating jet to be estimated are introduced into the first and second parameters in the order of operations (here, cavitation number σ and injection pressure p₁), i.e. at p₁, d_{ref} and σ is calculated (Step S56).

Subsequently, (d/d_{ref})^{nd} and n_{d}=c₃σ+c₄ are calculated (Step S57).

Finally, using the Equation (3), estimated cavitating jet performance E_{cav} when the parameters of the cavitating jet to be estimated are introduced into all the first to third parameters in the order of operations, i.e. at p₁, d and σ is calculated (Step S58).

A relationship of each term of the Equation (3) and the parameters introduced into each term for the process described using FIG. 23 is summarized as in FIG. 24. In FIG. 24, the term of the parameter changed from the preceding Step is shown by a broken-line arrow and an underline. Further, if the parameter calculated in the preceding Step is used in the succeeding Step, this parameter is shown by a solid-line arrow and an underline.

First, in Step S51, the terms (f(σ), f(σ_{ref}), p₁, p_{1ref}, d, d_{ref}, nₚ, n_{d}) relating to the cavitation number, the injection pressure and the nozzle diameter of the Equation (3) are all parameters of the cavitating jet to be estimated. The estimated cavitating jet performance at this time is equivalent to E_{ref} if the shape function Kₙ=1.

Subsequently, in Step S54, the estimated cavitating jet performance E_{ref} calculated in Step S51 is used as the cavitating jet performance E_{ref} of the cavitating jet to be referred to in the Equation (3) and the estimated cavitating jet performance E_{cav}′ is calculated by introducing the cavitation number σ of the cavitating jet to be estimated into the cavitation number σ.

Further, in Step S56, the estimated cavitating jet performance E_{cav}′ calculated in Step S54 is used as the cavitating jet performance E_{ref} of the cavitating jet to be referred to in the Equation (3) and the estimated cavitating jet performance E_{cav}″ is calculated by introducing the injection pressure p₁ of the cavitating jet to be estimated into the injection pressure p₁.

Finally, in Step S58, the estimated cavitating jet performance E_{cav}″ calculated in Step S56 is used as the cavitating jet performance E_{ref} of the cavitating jet to be referred to in the Equation (3) and the estimated cavitating jet performance E_{cav} is calculated by introducing the nozzle diameter d of the cavitating jet to be estimated into the nozzle diameter d.

By performing the aforementioned process, the estimated cavitating jet performance of the cavitating jet to be estimated can be calculated by successively introducing the respective parameters including the injection pressure p₁, the nozzle diameter d and the cavitation number σ one by one into the Equation (3).

It should be noted that although the calculation of the estimated cavitating jet performance E_{cav} is described for the process in the case of successively calculating the estimated cavitating jet performance by successively introducing each parameter of the cavitating jet to be estimated as described above in the present embodiment, the estimated cavitating jet performance E_{cav} may be calculated at once by simultaneously introducing each parameter of the cavitating jet to be estimated into the Equation (3).

[3-1-4. Estimation Error Calculation and Estimation Accuracy Evaluation]

In the present embodiment, an estimation error calculation means 41 may be further provided which obtains a cavitating jet performance estimation error by comparing the estimated cavitating jet performance E_{cav} of the cavitating jet and the actually measured cavitating jet performance E_{Rmax exp} of the cavitating jet corresponding to this estimated cavitating jet performance E_{cav} after the estimated cavitating jet performance E_{cav} of the cavitating jet is obtained in the jet performance estimation means 37. Further, an estimation accuracy evaluation means 42 may be further provided which evaluates cavitating jet performance estimation accuracy based on this cavitating jet performance estimation error (see FIG. 8).

Specifically, a cavitating jet estimation error calculation system 301 is configured by adding the estimation error calculation means 41 to the database 32, the power index specification means 33, the influence function specification means 36 and the jet performance estimation means 37, and a cavitating jet performance evaluation system 302 is configured by adding the estimation accuracy evaluation means 42 to this cavitating jet estimation error calculation system 301.

It should be noted that the hardware configurations of the cavitating jet estimation error calculation system 301 and the cavitating jet performance evaluation system 302 are similar to those of FIG. 7. Programs (computer software for estimation error calculation and computer software for estimation accuracy evaluation) for realizing the functions of the estimation error calculation means 41 and the estimation accuracy evaluation means 42 are provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc. The cavitating jet performance estimation device 11 reads the programs from that recording medium and transfers and stores them to and in the internal storage device (e.g. hard disk 15 or memory 17) or the external storage device to use them. Further, those programs may be recorded in an unillustrated storage device (recording medium) such as a magnetic disc, an optical disc or a magnetic optical disc and provided to the cavitating jet performance estimation device 11 from that storage device via a communication path.

Cavitating jet estimation performance can be evaluated and compared by the cavitating jet estimation error calculation system 301 including the estimation error calculation means 41 and the cavitating jet performance evaluation system 302 including the estimation accuracy evaluation means 42.

### Second Embodiment

A cavitating jet performance estimation method, an estimation system according to the estimation method, a program for causing a computer to execute the estimation method and a computer-readable recording medium recording the program are described as another embodiment of the present invention (hereinafter, this other embodiment is referred to as a second embodiment).

[3-2-1. Configuration Example of Estimation Device]

(Description of Hardware Configuration of Present Device)

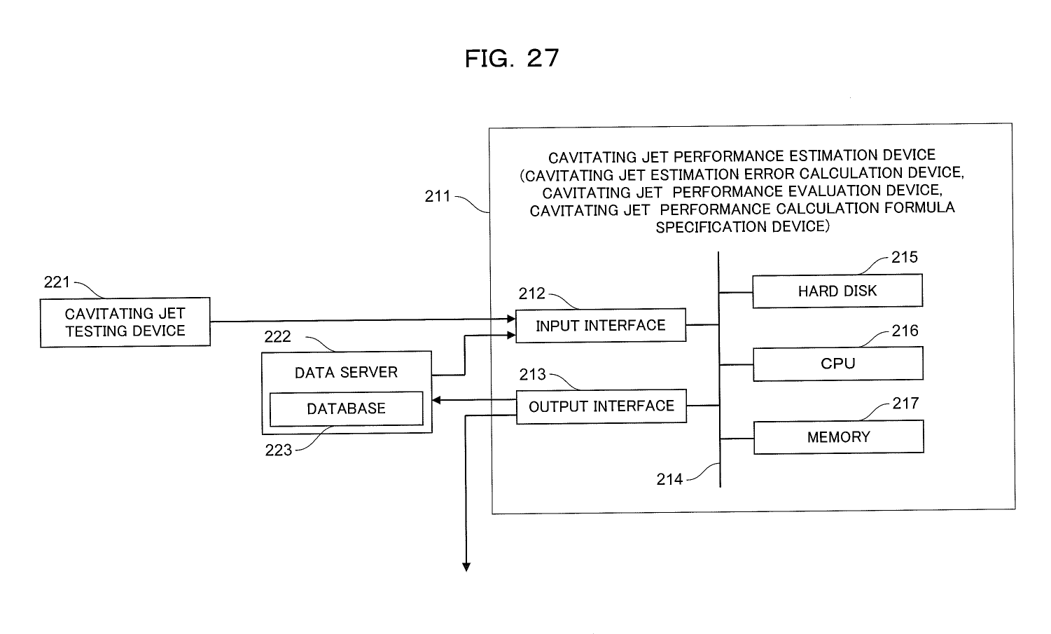

FIG. 27 is a diagram schematically showing the hardware configuration of a cavitating jet performance estimation device as the second embodiment of the present invention.

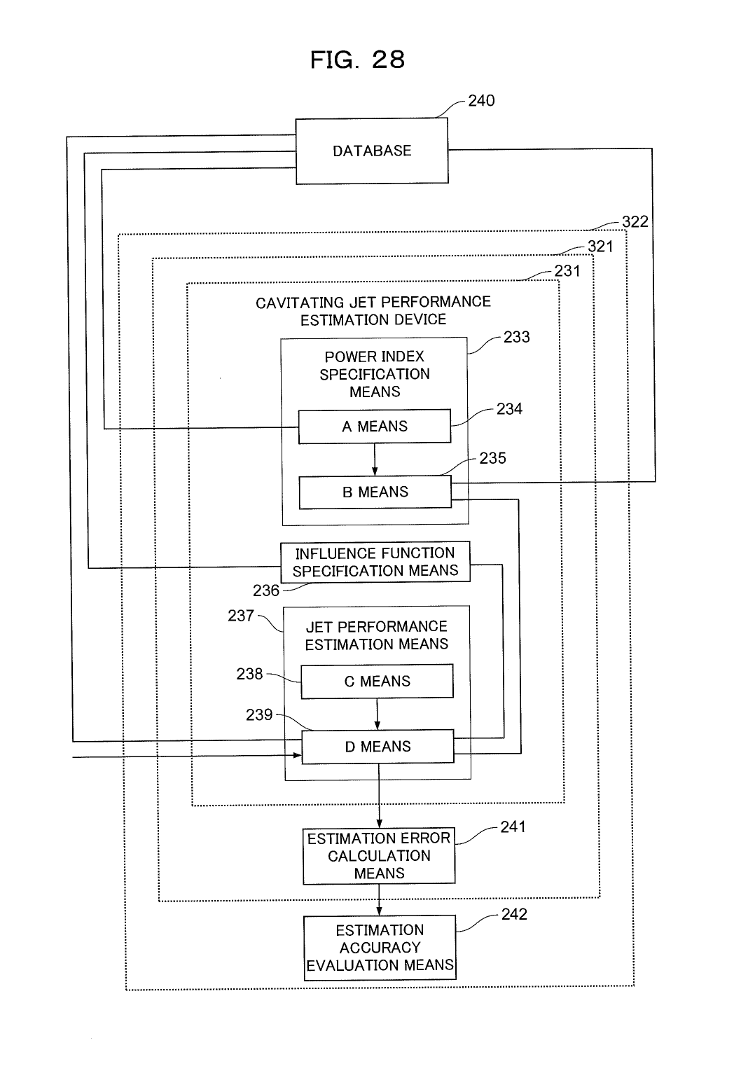

FIG. 28 is a diagram schematically showing a function block of the cavitating jet performance estimation device as the second embodiment of the present invention.

A cavitating jet performance estimation system 211 in the present embodiment includes an input interface 212, an output interface 213, a bus 214, a hard disk 215, a CPU (Central Processing Unit) 216, a memory 217 and the like as shown in FIG. 27.

The input interface 212 is similar to the input interface 12 of the first embodiment, and a data server 222 is connected outside a cavitating jet performance estimation device 221.

The data server 222 includes a database 223 (external database). Data on cavitating jet performance, data on hydrodynamic parameters such as an injection pressure of a cavitating jet, a bubble collapse site pressure and a nozzle shape, data on a test result, an influence function f(σ) of a cavitation number σ, Kₙ indicating a shape function dependent on the nozzle shape or the shape of a testing unit, functions n(σ), m(σ) for power indices in the Equations (1) and (2) and functions nₚ, n_{d} for power indices in the Equation (3) are accumulated and stored in this database 223, so that these pieces of data can be captured or written into the cavitating jet performance estimation device 211.

It should be noted that although the database 223 is stored as an external database in the data server 222 provided outside the cavitating jet performance estimation device 211 in the present embodiment, it may be stored in an unillustrated computer-readable recording medium provided outside the cavitating jet performance estimation device 211 and data may be read therefrom or written therein.

The output interface 213 is similar to the output interface 13 of the first embodiment and the hard disk 215 is similar to the hard disk 15 of the first embodiment.

The CPU 216 is similar to the CPU 16 of the first embodiment and realizes various functions by executing computer software for power index specification, computer software for influence function specification and computer software for jet performance estimation stored in the hard disk 215 and the memory 217. The CPU 216 functions as a power index specification means 233, an influence function specification means 236 and a jet performance estimation means 237 shown in FIG. 28 and to be described later by executing these computer programs.

It should be noted that the programs (computer software for power index specification, computer software for influence function specification and computer software for jet performance estimation) for realizing the functions as these power index specification means 233, influence function specification means 236 and jet performance estimation means 237 are provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc as in the first embodiment. The cavitating jet performance estimation device 211 reads the programs from that recording medium and transfers and stores them to and in the internal storage device (e.g. hard disk 215 or memory 217) or the external storage device to use them. Further, those programs may be recorded in an unillustrated storage device (recording medium) such as a magnetic disc, an optical disc or a magnetic optical disc and provided to the cavitating jet performance estimation device 211 from that storage device via a communication path.

In realizing the functions as the power index specification means 233, the influence function specification means 236 and the jet performance estimation means 237, the programs stored in the internal storage device (hard disk 215 or memory 217 in the present embodiment) are executed by a microprocessor (CPU 216 in the present embodiment) of the cavitating jet performance estimation device 211. At this time, the programs stored in the unillustrated external recording medium may be read and executed by a computer. Then, the cavitating jet performance estimation device 211 reads the programs from that recording medium and transfers and stores them to and in the internal storage device (e.g. hard disk 215 or memory 217) or the external storage device to use them. Further, those programs may be recorded in an unillustrated storage device (recording medium) such as a magnetic disc, an optical disc or a magnetic optical disc and provided to the cavitating jet performance estimation device 211 from that storage device via a communication path.

Here, the computer software for power index specification specifies the functions n(σ), m(σ) for the power indices in the Equation (1) or (2) for calculating estimated cavitating jet performance from the data accumulated in the database 223. Alternatively, this computer software specifies the functions nₚ, n_{d} for the power indices if the Equation (1) for calculating the estimated cavitating jet performance of the cavitating jet is the Equation (3).

The computer software for influence function specification obtains the influence function f(σ) of the cavitation number σ from a relationship of the cavitation number σ and the cavitating jet performance E_{Rmax}.

The computer software for jet performance estimation obtains the estimated cavitating jet performance E using data on an injection pressure p₁, a nozzle diameter d and a cavitation number σ, the Equation (1) and the specified functions n(σ), m(σ) for the power indices. Alternatively, this computer software obtains the estimated cavitating jet performance E_{cav} using the data on the injection pressure p₁, the nozzle diameter d and the cavitation number σ of a cavitating jet to be estimated, data on cavitating jet performance E_{ref}, an injection pressure p_{1ref}, a nozzle diameter d_{ref} and a cavitation number σ_{ref} of a cavitating jet to be referred to, the data on Kₙ indicating the shape function dependent on the nozzle shape or the shape of the testing unit, the Equation (2) and the functions n(σ), m(σ) for the power indices. Alternatively, this computer software obtains the estimated cavitating jet performance E_{cav} using the data on the injection pressure p₁, the nozzle diameter d and the cavitation number σ of the cavitating jet to be estimated, the data on the cavitating jet performance E_{ref}, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (3) and the functions nₚ, n_{d} for the power indices.

These computer software for power index specification, computer software for influence function specification and computer software for jet performance estimation are stored in various computer-readable recording media.

It should be noted that, in the present embodiment, a computer is a concept including hardware and an operating system and means the hardware that operates under the control of the operating system. Further, if no operating system is necessary and hardware is operated singly by an application program, the hardware itself is equivalent to the computer. The hardware includes at least a microprocessor such as a CPU and a means for reading a computer program recorded in a recording medium.

The memory 217 is a storage unit for storing various pieces of data and programs and realized, for example, a volatile memory such as a RAM (Random Access Memory) or a nonvolatile memory such as a ROM or a flash memory. In the present embodiment, the computer software for power index specification, the computer software for influence function specification and the computer software for jet performance estimation to be executed by the CPU 216, the data on the hydrodynamic parameters such as the injection pressure, the nozzle diameter and the cavitation number, data on the cavitating jet performance of the cavitating jet, the data on Kₙ indicating the shape function dependent on the nozzle shape or the shape of the testing unit and the data on the functions for the power indices are stored in the memory 217.

(Description of Hardware Configuration of Cavitating Jet Testing Device)

The configuration of a cavitating jet testing device 221 to be connected to the cavitating jet performance estimation device 211 is similar to that of the cavitating jet testing device 21 of the first embodiment.

Further, the cavitating jet testing device 221 can obtain a cavitation erosion rate at each condition as an index of cavitating jet performance by conducting a cavitating jet test while changing conditions such as the injection pressure p₁, a bubble collapse site pressure p₂ and the shape of a nozzle tip part similarly to the cavitating jet testing device 21 of the first embodiment.

[3-2-2. Functional Configuration of Estimation Device]

Next, the functional configuration of the cavitating jet performance estimation device of the present embodiment is described.

FIG. 28 is a diagram schematically showing a function block of the cavitating jet performance estimation device as the second embodiment of the present invention.

In functionally expressing a cavitating jet performance estimation device 231 of the present embodiment, the cavitating jet performance estimation device 231 includes the power index specification means 233, the influence function specification means 236 and the jet performance estimation means 237 as shown in FIG. 28. By executing the software by the computer programs, this software functions as these power index specification means 233, influence function specification means 236 and jet performance estimation means 237. This software is stored in the memory 217 and read and executed by the CPU 216. It should be noted that an A means and a B means of the power index specification means 233, the influence function specification means 236 and a D means 239 of the jet performance estimation means 237 of the cavitating jet performance estimation device 231 are functionally connected to a database 240.

The database 240 is a database for accumulating data on the cavitating jet performance of the cavitating jet, the hydrodynamic parameters such as the injection pressure, the bubble collapse site pressure, the nozzle diameter and the cavitation number and equations and functions used in the calculation of the estimated cavitating jet performance.

The cavitating jet performance of the cavitating jet, the injection pressure p₁, the bubble collapse site pressure p₂, the nozzle diameter d, the cavitation number σ, the influence function f(σ) of the cavitation number σ specified by the influence function specification means 236 to be described later and Kₙ indicating the shape function dependent on the nozzle shape or the shape of the testing unit are stored in the database 240. Further, relational expressions expressing relationships of the cavitation number σ and the power indices of the Equations (1) to (3) specified by the B means 235 to be described later (functions for the power indices), i.e. the functions n(σ), m(σ) for the power indices in the Equations (1) and (2) and the functions nₚ, n_{d} for the power indices in the Equation (3) are stored in the database 240.

These pieces of data are stored in association with each combination of data on actually measured cavitating jet performance at each condition obtained by conducting a cavitating jet test for evaluating the cavitating jet performance at various conditions of the injection pressure p₁, the bubble collapse site pressure p₂, the nozzle diameter d and the cavitation number σ using the aforementioned cavitating jet testing device. The more data of the actually measured cavitating jet performance there is at each condition, the more accurately the estimation of the cavitating jet performance to be described later can be made.

The power index specification means 233 is composed of the A means 234 and the B means 235.

The A means 234 obtains the injection pressure p₁ of the cavitating jet and a relationship of the actually measured cavitating jet performance E_{Rmax} with the injection pressure p₁ accumulated in the database 240 and obtains the nozzle diameter d of the cavitating jet and a relationship of the actually measured cavitating jet performance E_{Rmax} with the nozzle diameter d.

The B means 235 specifies a relationship of the cavitation number σ and the function n(σ) for the power index in the Equations (1) and (2) or a relationship of the cavitation number σ and the function nₚ for the power index in the Equation (3) as a relational expression (6), which is a function of σ, from the injection pressure p₁ of the cavitating jet and the relationship of the actually measured cavitating jet performance E_{Rmax} with the injection pressure p₁ obtained by the A means 234. Further, the B means 235 specifies a relationship of the cavitation number σ and the function m(σ) for the power index in the Equations (1) and (2) or a relationship of the cavitation number σ and the function n_{d} for the power index in the Equation (3) as a relational expression (7), which is a function of σ, from the relationship of the cavitating jet performance E_{Rmax} with the nozzle diameter d obtained by the A means 234.

The relational expression expressing the relationship of the cavitation number σ and the function n(σ) for the power index in the Equations (1) and (2) or the relational expression (6) expressing the relationship of the cavitation number σ and the function nₚ for the power index in the Equation (3) and the relational expression expressing the relationship of the cavitation number σ and the function m(σ) for the power index in the Equations (1) and (2) or the relational expression (7) expressing the cavitation number σ and the function n_{d} for the power index in the Equation (3) obtained in this way are stored in the database 240.

The influence function specification means 236 obtains the influence function f(σ) of the cavitation number σ from the relationship of the cavitation number σ and the cavitating jet performance E_{Rmax}.

The jet performance estimation means 237 is composed of a C means 238 and the D means 239.

The C means 238 is similar to the C means 38 of the first embodiment.

The D means 239 obtains the estimated cavitating jet performance E using the data on the injection pressure p₁, the nozzle diameter d and the cavitation number σ, the Equation (1) and the functions n(σ), m(σ) for the power indices specified by the B means 235 in accordance with an order of operations set by the C means 238.

Alternatively, the D means 239 obtains the estimated cavitating jet performance E_{cav} using the data input from the outside on the injection pressure p₁, the nozzle diameter d and the cavitation number σ of the cavitating jet to be estimated, the data stored in the database 240 on the cavitating jet performance E_{ref} the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (2), the functions n(σ), m(σ) for the power indices specified by the B means 235 and the influence functions f(σ), f(σ_{ref}) of the cavitation numbers σ and the σ_{ref} specified by the influence function specification means 236.

Alternatively, the D means 239 obtains the estimated cavitating jet performance E_{cav} using the data input from the outside on the injection pressure p₁, the nozzle diameter d and the cavitation number σ of the cavitating jet to be estimated, the data stored in the database 240 on the cavitating jet performance Era, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (3), the functions nₚ, n_{d} for the power indices expressed by the Equations (6), (7) and specified by the B means 235 and the influence functions f(σ), f(σ_{ref}) of the cavitation numbers σ and the σ_{ref} specified by the influence function specification means 236.

[3-2-3. Operation of Estimation System and Cavitating Jet Performance Estimation Method Using Estimation System]

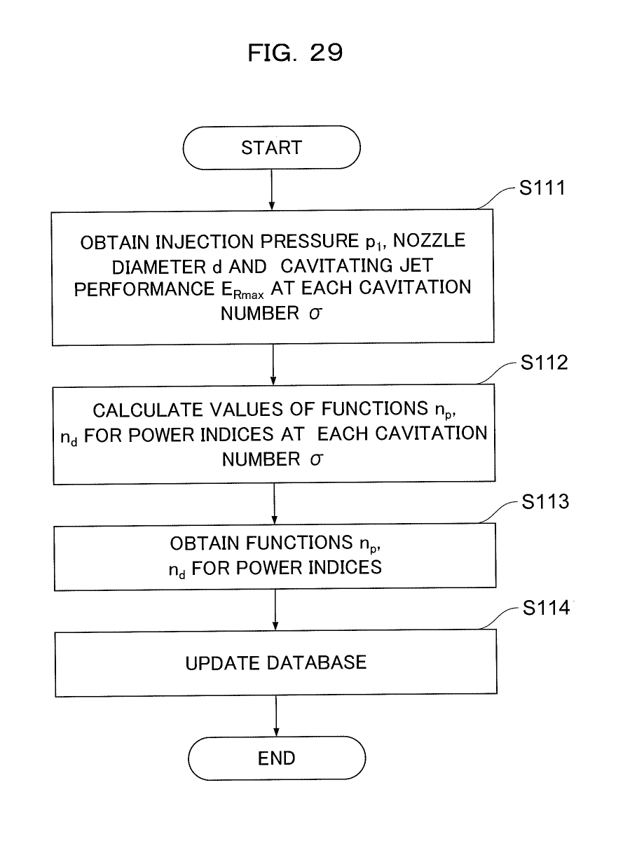

Operations in a power index specification process, an influence function specification process and a jet performance estimation process of the cavitating jet performance estimation system of the present embodiment are described in accordance with flow charts shown in FIGS. 29 to 31.

FIG. 29 is a flow chart showing a process of the power index specification means 233 in the present estimation system as one example of the present embodiment.

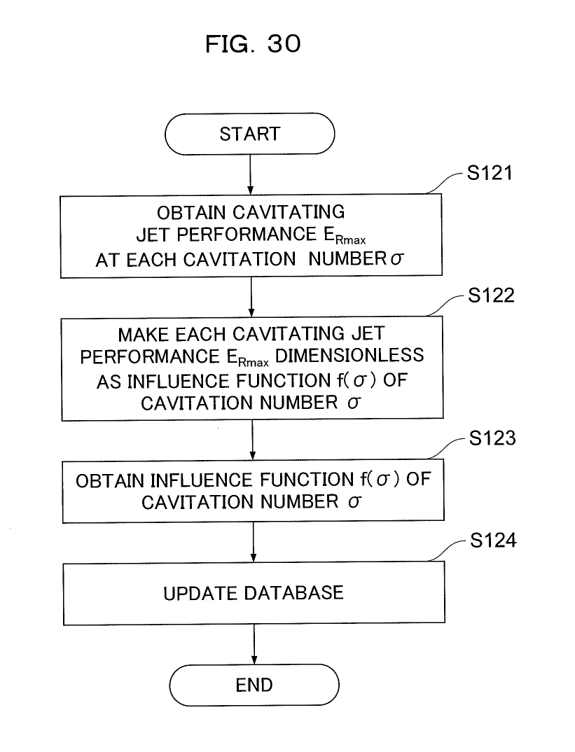

FIG. 30 is a flow chart showing a process of the influence function specification means 236 in the present estimation system as one example of the present embodiment.

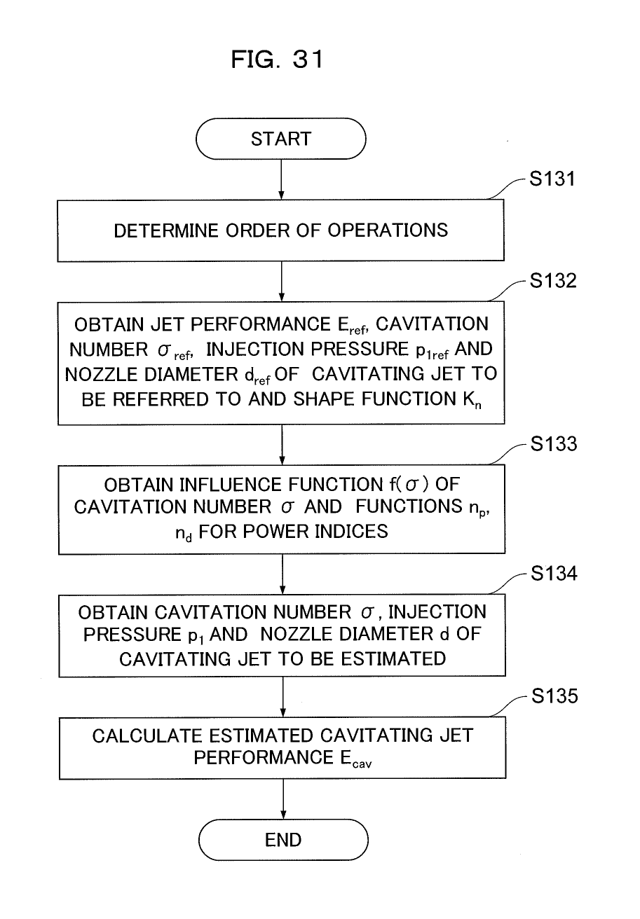

FIG. 31 is a flow chart showing a process of the jet performance estimation means 237 in the present estimation system as one example of the present embodiment.

(Power Index Specification Process)

As shown in FIG. 29, the A means 234 first obtains the injection pressure p₁ and the cavitating jet performance E_{Rmax} at each cavitation number σ and the nozzle diameter d and the cavitating jet performance E_{Rmax} at each σ from the database 240 (Step S111).

In the power index specification process, the functions n(σ), m(σ) for the respective power indices of the injection pressure p₁ and the nozzle diameter d are obtained from these pieces of data. Specifically, the functions nₚ, n_{d} for the power indices of the respective terms of the injection pressure p₁ and the nozzle diameter d in the Equation (3) expressed by the Equations (6), (7) are obtained.

If the cavitating jet performance E_{Rmax} is shown in relation to the injection pressure p₁ and the nozzle diameter d on a double-logarithmic graph, linear relationships are respectively confirmed on the double-logarithmic graph and it is understood that a power law holds for each cavitation number σ. The A means 234 can obtain the power index nₚ, n_{d} as a gradient of the cavitating jet performance E_{Rmax} in relation to the injection pressure p₁ or the nozzle diameter d at each cavitation number σ on the double-logarithmic graph. At this time, since the values of the power indices nₚ, n_{d} change depending on the cavitation number σ, the values of the functions nₚ, n_{d} for the respective power indices at each cavitation number σ in the case of assuming the power law are calculated (Step S112).

Subsequently, the B means 235 obtains the functions nₚ, n_{d} for the power indices from relationships of the cavitation number σ and the values of the power indices nₚ, n_{d}. Since a linear relationship can be confirmed between the cavitation number σ and the function nₚ for the power index, a linear expression is assumed and the power index of the term of the injection pressure p₁ in the Equation (3) is obtained as the function nₚ expressed by the cavitation number σ. Similarly, since a liner relationship can be confirmed between a and n_{d}, a linear expression is assumed and the power index of the term of the nozzle diameter d in the Equation (3) is obtained as the function n_{d} expressed by the cavitation number σ (Step S113).

The function nₚ for the power index of the term of the injection pressure p₁ and the function n_{d} for the power index of the term of the nozzle diameter d obtained in this way are stored in the database 240 (Step S114).

(Influence Function Specification Process)

As shown in FIG. 30, the influence function specification means 236 obtains the actually measured cavitating jet performance E_{Rmax} at each cavitation number σ from the database 240 (Step S121).

Subsequently, the influence function specification means 236 makes the cavitating jet performance E_{Rmax} dimensionless as the influence function f(σ) of the cavitation number σ by the value of σ, at which the cavitating jet performance E_{Rmax} is maximum, at each injection pressure p₁ and each nozzle diameter d (Step S122). Specifically, f(σ) is normalized to be 1 at the value of σ at which the cavitating jet performance E_{Rmax} is maximum at each injection pressure p₁ and each nozzle diameter d by dividing the cavitating jet performance E_{Rmax} at each σ by the value of the cavitating jet performance E_{Rmax} at the value of σ at which the cavitating jet performance E_{Rmax} is maximum.

Further, assuming an approximation expression using σ as a variable as f(σ), the influence function f(σ) is obtained (Step S123).

Here, the influence function f(σ) of the cavitation number σ is preferably defined to be a function different before and after a cavitation number σₘₐₓ exhibiting maximum cavitating jet performance.

For example, since the influence function f(σ) exhibits a maximum at the cavitation number σₘₐₓ exhibiting maximum cavitating jet performance at each injection pressure p₁ and each nozzle diameter d, it is thought that f(σₘₐₓ)=1, f′(σₘₐₓ)=0. Further, at σ≈0, it can be assumed that f(0)=0 since there is thought to be no action by the cavitating jet. In consideration of the above, in a region of the cavitation number σ where a σₘₐₓ (or σ<σₘₐₓ), a cubic expression of σ is preferably assumed as f(σ) and each coefficient of f(σ) can be obtained by applying Newton's method to actual measurement values of a σₘₐₓ.

On the other hand, at σ≧σₘₐₓ (or σ>σₘₐₓ), a cavitation occurrence area is reduced and f(σ) decreases as a increases. If σ is larger than an incipient cavitation number σ_{I} (or desinent cavitation number σ_{d}), the cavitation does not occur, wherefore f(σᵢ)=0. Specifically, since f(σ) is thought to monotonously decrease in the range of the cavitation number σ where σ≧σₘₐₓ (or σ>σₘₐₓ), it is preferable to assume a linear expression.

The influence function f(σ) of the cavitation number σ obtained in this way is stored in the database 240 (Step S124).

(Jet Performance Estimation Process)

As shown in FIG. 31, the C means 238 sets the order of operations in calculating the cavitating jet performance for the data on the injection pressure p₁, the nozzle diameter d and the cavitation number σ (Step S131).

Here, six combinations are considered depending on the order of operations of three parameters. In terms of operation accuracy, the order of operations is preferably such that the cavitation number σ comes first and then the injection pressure p₁ or the nozzle diameter d comes next. Specifically, a preferred order of operations is cavitation number σ→injection pressure p₁→nozzle diameter d or cavitation number σ→nozzle diameter d→injection pressure p₁.

Subsequently, the D means 239 obtains the jet performance E_{ref}, the cavitation number σ_{ref}, the injection pressure p_{1ref} and the nozzle diameter d_{ref} of the cavitating jet to be referred to and the shape function Kₙ from the database 240 (Step S132). These pieces of data to be referred to are pieces of actually measured data obtained by conducting a test for evaluating the cavitating jet performance in advance.

It should be noted that, from the perspective of estimation accuracy in the calculation of the estimated cavitating jet performance, it is preferable to obtain data on the cavitation number σ_{ref}, the injection pressure p_{1ref} and the nozzle diameter d_{ref} having values approximate to the injection pressure p₁, the nozzle diameter d and the cavitation number σ of the cavitating jet to be estimated as the data of the cavitating jet to be referred to used in the calculation of the estimated cavitating jet performance. Above all, it is particularly preferable to obtain the data with the cavitation number σ_{ref} of the cavitating jet to be referred to having a value approximate to the cavitation number σ of the cavitating jet to be estimated.

Further, the D means 239 obtains the influence function f(σ) of the cavitation number σ obtained in Step S113 and the function nₚ for the power index of the term of the injection pressure p₁ and the function n_{d} for the power index of the term of the nozzle diameter d obtained in Step S123 from the database 240 (Step S133).

Furthermore, the D means 239 obtains the cavitation number σ, the injection pressure p₁ and the nozzle diameter d of the cavitating jet to be estimated (Step S134).

Then, the D means 239 calculates the estimated cavitating jet performance E_{cav} by introducing the value of the cavitating jet performance of the cavitating jet to be referred to into E_{ref}, the value of the shape function into Kₙ, the value of the influence function f(σ) at the cavitation number σ of the cavitating jet to be estimated into f(σ), the value of the influence function f(σ_{ref}) at the cavitation number σ_{ref} of the cavitating jet to be referred to into f(σ_{ref}), the value of the injection pressure of the cavitating jet to be estimated into p₁, the value of the injection pressure of the cavitating jet to be referred to into p_{1ref}, the value of the nozzle diameter of the cavitating jet to be estimated into d, the value of the nozzle diameter of the cavitating jet to be referred to into d_{ref}, the value of the function nₚ for the power index of the term of the injection pressure p₁ at the cavitation number σ of the cavitating jet to be estimated into nₚ and the value of the function n_{d} for the power index of the term of the nozzle diameter d at the cavitation number σ of the cavitating jet to be estimated into n_{d} in the Equation (3) (Step S135).

It should be noted that although the order of operations is obtained (Step S131) before obtaining each piece of data (Step S132 to 134) in the present embodiment, the order of operations may be obtained after obtaining each piece of data. Further, a sequence of obtaining each piece of data (Step S132 to 134) may be exchanged.

Further, although the functions nₚ, n_{d} for the power indices obtained by the B means 235 are accumulated in the database 240 and the D means 239 obtains them from the database 240 in Step S133 in the present embodiment, the functions nₚ, n_{d} for the power indices obtained by the B means 235 may be directly used by the D means 239 without being stored in the database 240.

Further, although the influence function f(σ) of the cavitation number σ obtained by the influence function specification means 236 is stored in the database 240 and the D means 239 obtains it from the database 240 in Step S133 in the present embodiment, the influence function f(σ) of the cavitation number σ obtained by the influence function specification means 236 may be directly used by the D means 239 without being accumulated in the database 240.

(Estimation Process of Estimated Cavitating Jet Performance)

The estimation process of the estimated cavitating jet performance by the Equation (3), particularly the processing in Step S135 described above, can be performed similarly to the estimation processing in Step S35 of the first embodiment described above.

[3-2-4. Estimation Error Calculation and Estimation Accuracy Evaluation]

In the present embodiment, an estimation error calculation means 241 may be further provided which obtains a cavitating jet performance estimation error by comparing the estimated cavitating jet performance E_{cav} of the cavitating jet and actually measured cavitating jet performance E_{Rmax exp} of the cavitating jet corresponding to this estimated cavitating jet performance E_{cav} after the estimated cavitating jet performance E_{cav} of the cavitating jet is obtained in the jet performance estimation means 237. Further, an estimation accuracy evaluation means 242 may be further provided which evaluates cavitating jet performance estimation accuracy based on this cavitating jet performance estimation error (see FIG. 28).

Specifically, an cavitating jet estimation error calculation device 321 is configured by adding the estimation error calculation means 241 to the power index specification means 233, the influence function specification means 236 and the cavitating jet performance estimation means 237, and a cavitating jet performance evaluation device 322 is configured by adding the estimation accuracy evaluation means 242 to this cavitating jet estimation error calculation device 321.

It should be noted that the hardware configurations of the cavitating jet estimation error calculation device 321 and the cavitating jet performance evaluation device 322 are similar to those of FIG. 27. Programs (computer software for estimation error calculation and computer software for estimation accuracy evaluation) for realizing the functions of the estimation error calculation means 241 and the estimation accuracy evaluation means 242 are provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc. The cavitating jet performance estimation device 211 reads the programs from that recording medium and transfers and stores them to and in the internal storage device (e.g. hard disk 215 or memory 217) or the external storage device to use it. Further, those programs may be recorded in an unillustrated storage device (recording medium) such as a magnetic disc, an optical disc or a magnetic optical disc and provided to the cavitating jet performance estimation device 211 from that storage device via a communication path.

Cavitating jet estimation performance can be evaluated and compared by the cavitating jet estimation error calculation device 321 including the estimation error calculation means 241 and the cavitating jet performance evaluation device 322 including the estimation accuracy evaluation means 242.

### Third Embodiment

A cavitating jet performance estimation method, an estimation device according to the estimation method, a program for causing a computer to execute the estimation method and a computer-readable recording medium recording the program are described as another embodiment of the present invention (hereinafter, this other embodiment is referred to as a third embodiment).

[3-3-1. Configuration Example of Estimation Device]

(Description of Hardware Configuration of Present Device)

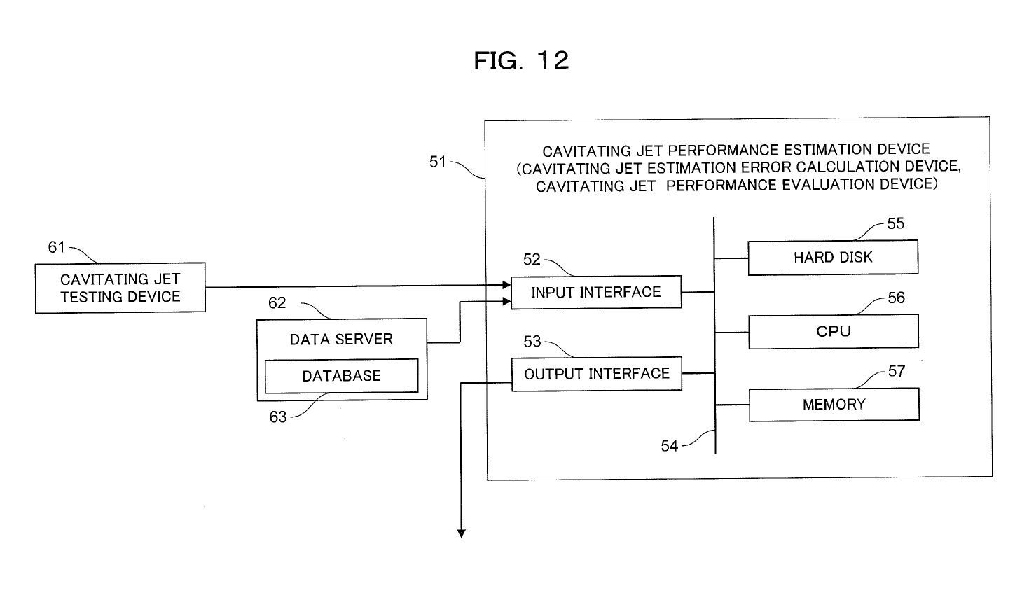

FIG. 12 is a diagram schematically showing the hardware configuration of a cavitating jet performance estimation device as the third embodiment of the present invention.

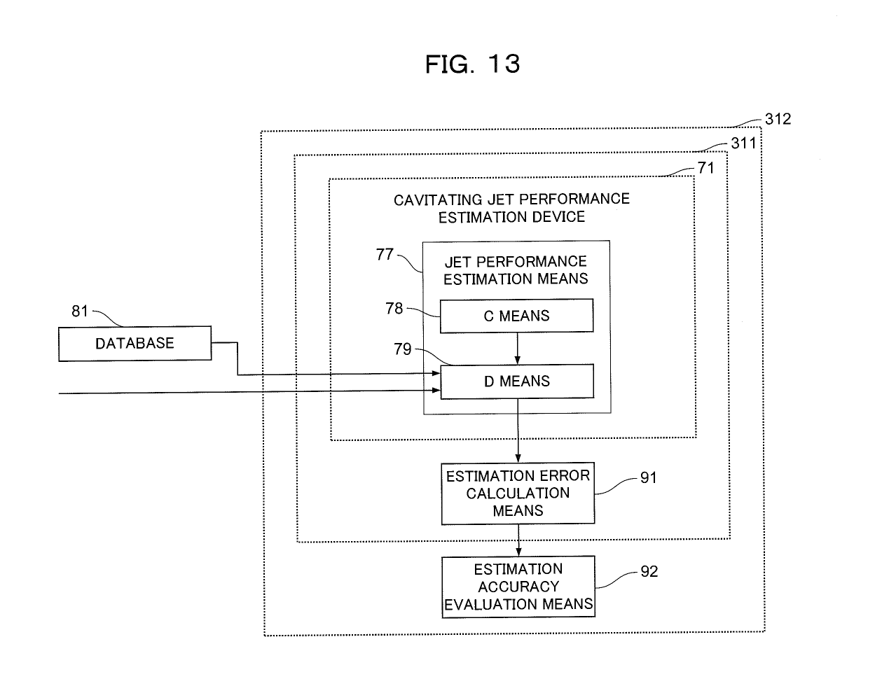

FIG. 13 is a diagram schematically showing a function block of a cavitating jet performance estimation system as the third embodiment of the present invention.

A cavitating jet performance estimation system 51 in the present embodiment includes an input interface 52, an output interface 53, a bus 54, a hard disk 55, a CPU (Central Processing Unit) 56, a memory 57 and the like as shown in FIG. 12.

The input interface 52 is similar to the input interface 12 of the first embodiment, and a data server 62 is connected outside a cavitating jet performance estimation device 51.

The data server 62 includes a database 63 (external database). Data on cavitating jet performance, data on hydrodynamic parameters such as an injection pressure of a cavitating jet, a bubble collapse site pressure and a nozzle shape, data on a test result, an influence function f(σ) of a cavitation number σ, Kₙ indicating a shape function dependent on the nozzle shape or the shape of a testing unit, functions n(σ), m(σ) for power indices in the Equations (1) and (2) and functions nₚ, n_{d} for power indices in the Equation (3) are accumulated and stored in this database 63, so that these pieces of data can be captured or written into the cavitating jet performance estimation device 51.

It should be noted that although the database 63 is stored as an external database in the data server 62 provided outside the cavitating jet performance estimation device 51 in the present embodiment, it may be stored in an unillustrated computer-readable recording medium provided outside the cavitating jet performance estimation device 51 and data may be read therefrom.

The output interface 53 is similar to the output interface 13 of the first embodiment.

Besides a database for accumulating data on the cavitating jet performance and the hydrodynamic parameters, computer software for power index specification and computer software for jet performance estimation are stored in the hard disk 55.

The CPU 56 is a processing device for performing various controls and operations and realizes various functions by executing the computer software for jet performance estimation stored in the hard disk 55 or the memory 57. The CPU 56 functions as a jet performance estimation means 77 shown in FIG. 13 and to be described later by executing the computer program.

It should be noted that the program (computer software for jet performance estimation) for realizing the function as the jet performance estimation means 77 is provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc. The cavitating jet performance estimation device 51 reads the program from that recording medium and transfers and stores it to and in the internal storage device (e.g. hard disk 55 or memory 57) or the external storage device to use it. Further, that program may be recorded in an unillustrated storage device (recording medium) such as a magnetic disc, an optical disc or a magnetic optical disc and provided to the cavitating jet performance estimation device 51 from that storage device via a communication path.

In realizing the function as the jet performance estimation means 77, the program stored in the internal storage device (hard disk 55 or memory 57 in the present embodiment) is executed by a microprocessor (CPU 56 in the present embodiment) of the cavitating jet performance estimation device 51. At this time, the program recorded in the unillustrated external recording medium may be read and executed by a computer.

Here, the computer software for jet performance estimation obtains estimated cavitating jet performance E using data on an injection pressure p₁, a nozzle diameter d and a cavitation number σ, the Equation (1), functions n(σ), m(σ) for power indices. Alternatively, this computer software obtains estimated cavitating jet performance E_{cav} using the data on the injection pressure p₁, the nozzle diameter d and the cavitation number σ of a cavitating jet to be estimated, data on a cavitating jet performance E_{ref}, an injection pressure p_{1ref}, a nozzle diameter d_{ref} and a cavitation number σ_{ref} of a cavitating jet to be referred to, data on Kₙ indicating a shape function dependent on a nozzle shape or the shape of a testing unit, the Equation (2), the functions n(σ), m(σ) for the power indices. Alternatively, this computer software obtains the estimated cavitating jet performance E_{cav} using the data on the injection pressure p₁, the nozzle diameter d and the cavitation number σ of the cavitating jet to be estimated, the data on a cavitating jet performance E_{ref}, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (3), functions nₚ, n_{d} for power indices.

This computer software for jet performance estimation is stored in various computer-readable recording media described above.

It should be noted that, in the present invention, a computer is a concept including hardware and an operating system and means the hardware that operates under the control of the operating system. Further, if no operating system is necessary and hardware is operated singly by an application program, the hardware itself is equivalent to the computer. The hardware includes at least a microprocessor such as a CPU and a means for reading a computer program recorded in a recording medium.

The memory 57 is a storage unit for storing various pieces of data and programs and realized, for example, a volatile memory such as a RAM (Random Access Memory) or a nonvolatile memory such as a ROM or a flash memory. In the present embodiment, the computer software for jet performance estimation to be executed by the CPU 56, the data on the hydrodynamic parameters such as the injection pressure, the nozzle diameter and the cavitation number, the data on the cavitating jet performance of the cavitating jet, the data on Kₙ indicating the shape function dependent on the nozzle shape or the shape of the testing unit and the data on the functions for the power indices are stored in the memory 57.

(Description of Hardware Configuration of Cavitating Jet Testing Device)

The configuration of a cavitating jet testing device 61 to be connected to the cavitating jet performance estimation device 51 is similar to the cavitating jet testing device 21 of the first embodiment.

Further, the cavitating jet testing device 61 can obtain a cavitation erosion rate at each condition as an index of cavitating jet performance by conducting a cavitating jet test while changing conditions such as the injection pressure p₁, the bubble collapse site pressure p₂ and the shape of a nozzle tip part similarly to the cavitating jet testing device 21 of the first embodiment.

[3-3-2. Functional Configuration of Estimation Device]

Next, the functional configuration of the cavitating jet performance estimation device of the present embodiment is described.

FIG. 13 is a diagram schematically showing a function block of the cavitating jet performance estimation system as the third embodiment of the present invention.

In functionally expressing the cavitating jet performance estimation device 71 of the present embodiment, the cavitating jet performance estimation device 71 includes the jet performance estimation means 77 as shown in FIG. 13. By executing the software by the computer program, this software functions as the jet performance estimation means 77. This software is stored in the memory 57 and read and executed by the CPU 56. The cavitating jet performance estimation device 71 can read data from a database 81 and operate.

The database 81 is a database for accumulating data on the cavitating jet performance, the hydrodynamic parameters such as the injection pressure of the cavitating jet, the bubble collapse site pressure, the nozzle diameter and the cavitation number and equations and functions used in the calculation of the estimated cavitating jet performance.

The cavitating jet performance of the cavitating jet, the injection pressure p₁, the bubble collapse site pressure p₂, the nozzle diameter d, the cavitation number σ, the influence function f(σ) of the cavitation number σ specified by the influence function specification means 36 of the aforementioned cavitating jet performance estimation system 31, Kₙ indicating the shape function dependent on the nozzle shape or the shape of the testing unit, the functions n(σ), m(σ) for the power indices in the Equations (1) and (2) specified by the power index specification means 33 of the aforementioned cavitating jet performance estimation system 31 and the functions nₚ, n_{d} for the power indices in the Equation (3) are stored in the database 81.

These pieces of data are stored in association with each combination of data on actually measured cavitating jet performance at each condition obtained in advance by conducting a test for evaluating the cavitating jet performance by changing the injection pressure p₁, the bubble collapse site pressure p₂, the nozzle diameter d and the cavitation number σ. The more data of the actually measured cavitating jet performance there is at each condition, the more accurately the estimation of the cavitating jet performance to be described later can be made.

The jet performance estimation means 77 is composed of a C means 78 and a D means 79.

The C means 78 is similar to the C means 38 of the first embodiment.

The D means 79 obtains the estimated cavitating jet performance E using the data on the injection pressure p₁, the nozzle diameter d and the cavitation number σ, the Equation (1) and the functions n(σ), m(σ) for the power indices stored in the database 81 in accordance with an order of operations set by the C means 78.

Alternatively, the D means 79 obtains the estimated cavitating jet performance E_{cav} using the data input from the outside on the injection pressure p₁, the nozzle diameter d and the cavitation number σ of the cavitating jet to be estimated, the data stored in the database 81 on the cavitating jet performance E_{ref}, the injection pressure p_{1ref}, the nozzle diameter d_{ref} and the cavitation number σ_{ref} of the cavitating jet to be referred to, the data on Kₙ indicating the shape function dependent on the nozzle shape or the shape of the testing unit, the Equation (2), the functions n(σ), m(σ) for the power indices stored in the database 81 and the influence functions f(σ), f(σ_{ref}) of the cavitation numbers σ and the σ_{ref} stored in the database 81.

Alternatively, the D means 79 obtains the estimated cavitating jet performance E_{cav} using the data input from the outside on the injection pressure p₁, the nozzle diameter d and the cavitation number σ of the cavitating jet to be estimated, the data stored in the database 81 on the cavitating jet performance E_{ref}, the injection pressure p_{1ref}, the nozzle diameter d_{ref} and the cavitation number σ_{1ref} of the cavitating jet to be referred to, the data on Kₙ indicating the shape function dependent on the nozzle shape or the shape of the testing unit, the Equation (3), the functions nₚ, n_{d} for the power indices stored in the database 81 and the influence functions f(σ), f(σ_{ref}) of the cavitation numbers σ and the σ_{ref} stored in the database 81.

[3-3-3. Operation of Estimation System]

Operations in a jet performance estimation process of the cavitating jet performance estimation device of the present embodiment are described in accordance with flow charts shown in FIGS. 9, 10 and 14.

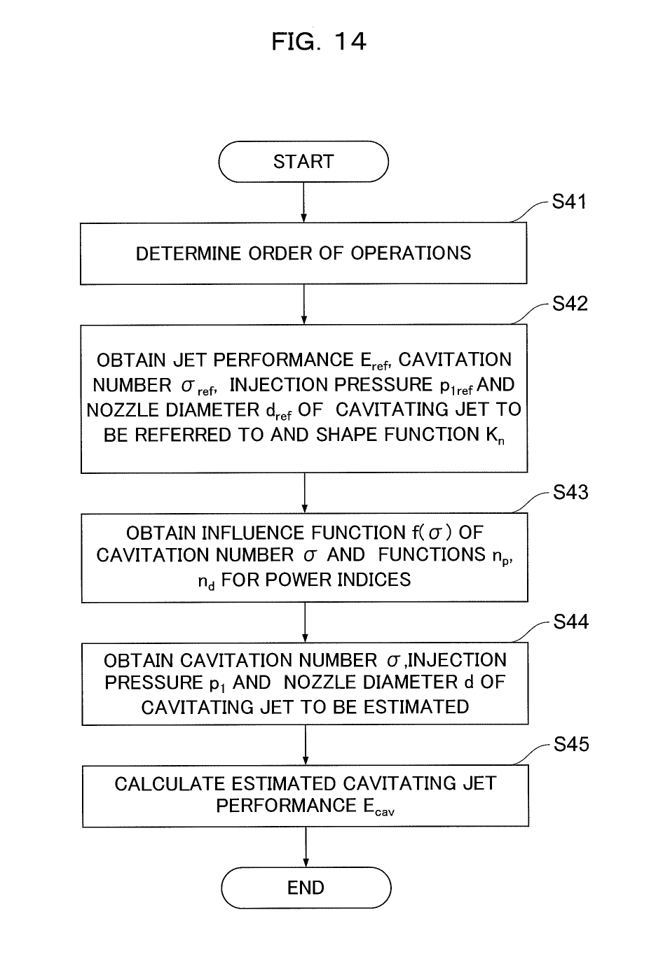

FIG. 14 is a flow chart showing a process of the jet performance estimation means 77 in the cavitating jet performance estimation device as the third embodiment of the present invention.

In the present embodiment, the functions nₚ, n_{d} for the power indices are specified in advance and the estimated cavitating jet performance E_{cav} is calculated using the functions nₚ, n_{d} stored in the database 63. At this time, the functions nₚ, n_{d} for the power indices can be specified similarly to the power index specification process of Steps S11 to S14 described using FIG. 9.

Further, in the present embodiment, the influence function f(σ) of the cavitation number σ is specified in advance and the estimated cavitating jet performance E_{cav} is calculated using the influence function f(σ) stored in the database 63. At this time, the influence function f(σ) of the cavitation number σ can be specified similarly to the influence function specification process of Steps S21 to S24 described using FIG. 10.

(Jet Performance Estimation Process)

As shown in FIG. 14, the C means 78 sets the order of operations in calculating the cavitating jet performance for the data on the injection pressure p₁, the nozzle diameter d and the cavitation number σ (Step S41).

Here, in terms of operation accuracy, the order of operations is preferably such that the cavitation number σ comes first and then the injection pressure p₁ or the nozzle diameter d comes next. Specifically, a preferred order of operations is cavitation number σ→injection pressure p₁→nozzle diameter d or cavitation number σ→nozzle diameter d→injection pressure p₁.

Subsequently, the D means 79 obtains the jet performance E_{ref}, the cavitation number σ_{ref}, the injection pressure p_{1ref} and the nozzle diameter d_{ref} of the cavitating jet to be referred to and the shape function Kₙ from the database 81 (Step S42). These pieces of data to be referred to are pieces of actually measured data obtained by conducting a test for evaluating the cavitating jet performance in advance.

It should be noted that, from the perspective of estimation accuracy in the calculation of the estimated cavitating jet performance, it is preferable to obtain data on the cavitation number σ_{ref}, the injection pressure p_{1ref} and the nozzle diameter d_{ref} having values approximate to the injection pressure p₁, the nozzle diameter d and the cavitation number σ of the cavitating jet to be estimated as the data of the cavitating jet to be referred to used in the calculation of the estimated cavitating jet performance. Above all, it is particularly preferable to obtain the data with the cavitation number σ_{ref} of the cavitating jet to be referred to having a value approximate to the cavitation number σ of the cavitating jet to be estimated.

Further, the D means 79 obtains the influence function f(σ) of the cavitation number σ stored in the database 81, and the function nₚ for the power index of the term of the injection pressure p₁ and the function n_{d} for the power index of the term of the nozzle diameter d stored in the database 81 (Step S43).

Furthermore, the D means 79 obtains the cavitation number σ, the injection pressure p₁ and the nozzle diameter d of the cavitating jet to be estimated (Step S44).

Then, the D means 79 calculates the estimated cavitating jet performance E_{cav} by introducing the value of the cavitating jet performance of the cavitating jet to be referred to into E_{ref}, the value of the shape function into Kₙ, the value of the influence function f(σ) at the cavitation number σ of the cavitating jet to be estimated into f(σ), the value of the influence function f(σ_{ref}) at the cavitation number σ_{ref} of the cavitating jet to be referred to into f(σ_{ref}), the value of the injection pressure of the cavitating jet to be estimated into p₁, the value of the injection pressure of the cavitating jet to be referred to into p_{1ref}, the value of the nozzle diameter of the cavitating jet to be estimated into d, the value of the nozzle diameter of the cavitating jet to be referred to into d_{ref}, the value of the function nₚ for the power index of the term of the injection pressure p₁ at the cavitation number σ of the cavitating jet to be estimated into nₚ and the value of the function n_{d} for the power index of the term of the nozzle diameter d at the cavitation number σ of the cavitating jet to be estimated into n_{d} in the Equation (3) (Step S45).

It should be noted that although the order of operations is obtained (Step S41) before obtaining each piece of data (Step S42 to 44) in the present embodiment, the order of operations may be obtained after obtaining each piece of data. Further, a sequence of obtaining each piece of data (Step S42 to 44) may be exchanged.

(Estimation Process of Estimated Cavitating Jet Performance)

The estimation process of the estimated cavitating jet performance by the Equation (3), particularly the processing in Step S45 described above, can be performed similarly to the estimation processing in Step S35 of the first embodiment described above.

[3-3-4. Estimation Error Calculation and Estimation Accuracy Evaluation]

In the present embodiment, an estimation error calculation means 91 may be further provided which obtains a cavitating jet performance estimation error by comparing the estimated cavitating jet performance E_{cav} of the cavitating jet and actually measured cavitating jet performance E_{Rmax exp} of the cavitating jet corresponding to this estimated cavitating jet performance E_{cav} after the estimated cavitating jet performance E_{cav} of the cavitating jet is obtained in the jet performance estimation means 77. Further, an estimation accuracy evaluation means 92 may be further provided which evaluates cavitating jet performance estimation accuracy based on this cavitating jet performance estimation error (see FIG. 13).

Specifically, a cavitating jet estimation error calculation device 311 is configured by adding the estimation error calculation means 91 to the jet performance estimation means 77, and a cavitating jet performance evaluation device 312 is configured by adding the estimation accuracy evaluation means 92 to this cavitating jet estimation error calculation device 311.

It should be noted that the hardware configurations of the cavitating jet estimation error calculation device 311 and the cavitating jet performance evaluation device 312 are similar to those of FIG. 12. Programs (computer software for estimation error calculation and computer software for estimation accuracy evaluation) for realizing the functions of the estimation error calculation means 91 and the estimation accuracy evaluation means 92 are provided in the form recorded in a computer-readable recording medium such as a flexible disc, a CD (CD-ROM, CD-R, CD-RW, etc.), a DVD (DVD-ROM, DVD-RAM, DVD-R, DVD+R, DVD-RW, DVD+RW, HD DVD, etc.), a Blu-ray disc, a magnetic disc, an optical disc or a magnetic optical disc. The cavitating jet performance estimation device 71 reads the programs from that recording medium and transfers and stores them to and in the internal storage device (e.g. hard disk 55 or memory 57) or the external storage device to use them. Further, those programs may be recorded in an unillustrated storage device (recording medium) such as a magnetic disc, an optical disc or a magnetic optical disc and provided to the cavitating jet performance estimation device 71 from that storage device via a communication path.

Cavitating jet estimation performance can be evaluated and compared by the cavitating jet estimation error calculation device 311 including the estimation error calculation means 91 and the cavitating jet performance evaluation device 312 including the estimation accuracy evaluation means 92.

<Summary of Respective Embodiments>

If the first to third embodiments are summarized in a comprehensive manner, the present invention includes methods, systems, devices, programs and the like as in the following [1] to [39].

[1]

A cavitating jet performance estimation method, including, in obtaining estimated cavitating jet performance E of a cavitating jet, setting the following Equation (1) for calculating the estimated cavitating jet performance E,

[Equation 27]

E=FX^{n(σ)}Y^{m(σ)} (1)

(In Equation (1),

F denotes a term relating to the effect of a cavitation number σ of the cavitating jet,

X^{n(σ)} denotes a term relating to a power law of an injection pressure p₁ of the cavitating jet and a power index n(σ) thereof denotes a function of the cavitation number σ, and

Y^{m(σ)} denotes a term relating to a power law of a nozzle diameter d for producing the cavitating jet and a power index m(σ) thereof denotes a function of the cavitation number σ),

specifying the functions n(σ), m(σ) for the power indices in the Equation (1) from data on the injection pressure p₁, the nozzle diameter d and the cavitation number σ and data on cavitating jet performance E_{Rmax} corresponding to these pieces of data, and

obtaining the estimated cavitating jet performance E using the data on the injection pressure p₁, the nozzle diameter d and the cavitation number σ, the Equation (1) and the specified functions n(σ), m(σ) for the power indices.

[2]

The cavitating jet performance estimation method according to [1], wherein the Equation (1) for calculating the estimated cavitating jet performance E of the cavitating jet is the following Equation (2),

$$[ Equation 28 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to), and

the estimated cavitating jet performance E_{cav} is obtained using the Equation (2).

[3]

The cavitating jet performance estimation method according to [2], wherein Kₙ=1 in the Equation (2).

[4]

The cavitating jet performance estimation method according to [2] or [3], wherein the influence function is defined as a function different before and after the cavitation number σ exhibiting a maximum.

[5]

The cavitating jet performance estimation method according to any one of [1] to [4], wherein, in specifying the functions n(σ), m(σ) for the power indices in the Equation (1) or (2),

the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d are first respectively obtained, and

the functions n(σ), m(σ) for the power indices are specified from the both relationships.

[6]

The cavitating jet performance estimation method according to any one of [1] to [5], wherein, in obtaining the estimated cavitating jet performance E_{cav},

a predetermined order of operations is set for the data on the injection pressure p₁, the nozzle diameter d and the cavitation number σ, and

the estimated cavitating jet performance E_{cav} is successively obtained in accordance with the order of operations.

[7]

A cavitating jet performance estimation system, including:

a database for accumulating data on an injection pressure p₁ of a cavitating jet, a nozzle diameter d for producing the cavitating jet and a cavitation number σ and data on cavitating jet performance E_{Rmax} corresponding to these pieces of data,

a power index specification means for specifying functions n(σ), m(σ) for power indices in the following Equation (1) for calculating estimated cavitating jet performance E from data accumulated in the database,

[Equation 29]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ), and

an estimation means for obtaining the estimated cavitating jet performance E using the data on the injection pressure p₁, the nozzle diameter d and the cavitation number σ, the Equation (1) and the specified functions n(σ), m(σ) for the power indices.

[8]

A cavitating jet performance estimation device, including:

a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 30]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and the power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ), and

an estimation means for obtaining the estimated cavitating jet performance E using the data on the injection pressure p₁, the nozzle diameter d and the cavitation number σ, the Equation (1) and the specified functions n(σ), m(σ) for the power indices.

[9]

A cavitating jet performance estimation device, including:

an estimation means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 31]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ), and

obtaining the estimated cavitating jet performance E using the data on the injection pressure p₁, the nozzle diameter d and the cavitation number σ, the Equation (1) and the specified functions n(σ), m(σ) for the power indices.

[10]

The cavitating jet performance estimation device according to [8] or [9], wherein the Equation (1) for calculating the estimated cavitating jet performance E of the cavitating jet is the following Equation (2),

$$[ Equation 32 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to), and

estimated cavitating jet performance E_{cav} is obtained using the Equation (2).

[11]

The cavitating jet performance estimation device according to [10], wherein Kₙ=1 in the Equation (2).

[12]

The cavitating jet performance estimation device according to [10] or [11], wherein the influence function is defined as a function different before and after the cavitation number σ exhibiting a maximum.

[13]

The cavitating jet performance estimation device according to [10] or [11], wherein, to specify the power indices, there are provided:

a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d, and

a means for specifying the functions n(σ), m(σ) for the power indices from the both relationships.

[14]

The cavitating jet performance estimation device according to any one of [8] to [13], wherein the estimation means includes:

a means for setting a predetermined order of operations for the data on the injection pressure p₁, the nozzle diameter d and the cavitation number σ, and

a means for successively obtaining the estimated cavitating jet performance E_{cav} in accordance with the order of operations.

[15]

A program for causing a computer to function as:

a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 33]

E=FX^{n(σ)}Y^{m(σ)} (1)

(In Equation (1),

F denotes a term relating to the effect of the cavitation number σ of the cavitating jet,)

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ), and

an estimation means for obtaining the estimated cavitating jet performance E using the data on the injection pressure p₁, the nozzle diameter d and the cavitation number σ, the Equation (1) and the specified functions n(σ), m(σ) for the power indices.

[16]

A program for causing a computer to function as:

an estimation means for obtaining estimated cavitating jet performance E using functions n(σ), m(σ) for power indices obtained by specifying the functions n(σ), m(σ) for the power indices in the following Equation (1) for calculating the estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 34]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ), the data on the injection pressure p₁, the nozzle diameter d and the cavitation number σ and the Equation (1).

[17]

The program according to [15] or [16], wherein the Equation (1) for calculating the estimated cavitating jet performance E of the cavitating jet is the following Equation (2),

$$[ Equation 35 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to), and

estimated cavitating jet performance E_{cav} is obtained using the Equation (2).

[18]

The program according to [17], wherein Kₙ=1 in the Equation (2).

[19]

A computer-readable recording medium recording the program according to any one of [15] to [18].

[20]

A cavitating jet estimation error calculation method, including:

obtaining the estimated cavitating jet performance E_{cav} by the cavitating jet performance estimation method according to any one of [2] to [6], and

obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

[21]

A cavitating jet performance evaluation method, including:

obtaining the cavitating jet performance estimation error by the cavitating jet estimation error calculation method according to [20], and

evaluating cavitating jet performance estimation accuracy based on the cavitating jet performance estimation error.

[22]

A cavitating jet estimation error calculation device, including:

the cavitating jet performance estimation device according to any one of [8] to [14], and

a means for obtaining a cavitating jet performance estimation error by comparing estimated cavitating jet performance E_{cav} obtained by the cavitating jet performance estimation device and actually measured cavitating jet performance E_{Rmax exp} of the cavitating jet corresponding to the estimated cavitating jet performance E_{cav}.

[23]

A cavitating jet performance evaluation device, including:

the cavitating jet estimation error calculation device according to [22], and

a means for evaluating cavitating jet performance estimation accuracy based on the cavitating jet performance estimation error obtained by the cavitating jet estimation error calculation device.

[24]

A program for causing a computer to function as:

a power index specification means for specifying functions n(σ), m(σ) for power indices in the following Equation (2) for calculating estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$[ Equation 36 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to),

an estimation means for obtaining the estimated cavitating jet performance E_{cav} using the data on the injection pressure p₁, the nozzle diameter d and the cavitation number σ, the Equation (2) and the specified functions n(σ), m(σ) for the power indices, and

a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

[25]

A program for causing a computer to function as:

an estimation means for obtaining estimated cavitating jet performance E_{cav} using functions n(σ), m(σ) for power indices obtained by specifying the functions n(σ), m(σ) for the power indices in the following Equation (2) for calculating the estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$[ Equation 37 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to), the data on the injection pressure p₁, the nozzle diameter d and the cavitation number σ and the Equation (2), and

a means for obtaining a cavitating jet performance estimation error by comparing the estimated cavitating jet performance σ_{cav} and actually measured cavitating jet performance E_{Rmax exp} of the cavitating jet corresponding to the estimated cavitating jet performance E_{cav}.

[26]

A program for causing a computer to function as:

a power index specification means for specifying functions n(σ), m(σ) for power indices in the following Equation (2) for calculating estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$[ Equation 38 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} be referred to),

an estimation means for obtaining the estimated cavitating jet performance E_{cav} using the data on the injection pressure p₁, the nozzle diameter d and the cavitation number σ, the Equation (2) and the specified functions n(σ), m(σ) for the power indices,

a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}, and

a means for evaluating cavitating jet performance estimation accuracy based on the cavitating jet performance estimation error.

[27]

A program for causing a computer to function as:

an estimation means for obtaining estimated cavitating jet performance E_{cav} using functions n(σ), m(σ) for power indices obtained by specifying the functions n(σ), m(σ) for the power indices in the following Equation (2) for calculating the estimated cavitating jet performance E_{cav} from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

$$[ Equation 39 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to), the data on the injection pressure p₁, the nozzle diameter d and the cavitation number σ and the Equation (2),

a means for obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}, and

a means for evaluating cavitating jet performance estimation accuracy based on the cavitating jet performance estimation error.

[28]

The program according to any one of [24] to [27], wherein Kₙ=1 in the Equation (2).

[29]

A computer-readable recording medium recording the program according to any one of [24] to [28].

[30]

A cavitating jet performance calculation formula specification system, including:

a database for accumulating data on an injection pressure p₁ of a cavitating jet, a nozzle diameter d for producing the cavitating jet and a cavitation number σ and data on cavitating jet performance E_{Rmax} corresponding to these pieces of data, and

a power index specification means for specifying functions n(σ), m(σ) for power indices in the following Equation (1) for calculating estimated cavitating jet performance E from data accumulated in the database,

[Equation 40]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ).

[31]

A cavitating jet performance calculation formula specification device, including:

a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 41]

E=FX^{n(σ)}Y^{m(σ)} (1)

(In Equation (1),

F denotes a term relating to the effect of the cavitation number σ of the cavitating jet,

X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ).

[32]

The cavitating jet performance calculation formula specification device according to [31], wherein the Equation (1) for calculating the estimated cavitating jet performance E of the cavitating jet is the following Equation (2),

$$[ Equation 42 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to).

[33]

The cavitating jet performance calculation formula specification device according to [32], wherein Kₙ=1 in the Equation (2).

[34]

The cavitating jet performance calculation formula specification device according to [32] or [33], wherein the influence function is defined as a function different before and after the cavitation number σ exhibiting a maximum.

[35]

The cavitating jet performance calculation formula specification device according to [32] or [33], wherein the power index specification means includes:

a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax}, with the nozzle diameter d, and

a means for specifying the functions n(σ), m(σ) for the power indices from the both relationships.

[36]

A program for causing a computer to function as:

a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,

[Equation 43]

E=FX^{n(σ)}Y^{m(σ)}(1)

(In Equation (1),

F denotes a term relating to the effect of the cavitation number σ of the cavitating jet, X^{n(σ)} denotes a term relating to a power law of the injection pressure p₁ of the cavitating jet and a power index n(σ) thereof denotes a function of the cavitation number σ, and

Y^{m(σ)} denotes a term relating to a power law of the nozzle diameter d for producing the cavitating jet and a power index m(σ) thereof denotes a function of the cavitation number σ).

[37]

The program according to [36], wherein the Equation (1) for calculating the estimated cavitating jet performance E of the cavitating jet is the following Equation (2),

$$[ Equation 44 ]$$

$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$

(In the Equation (2),

E_{ref} denotes cavitating jet performance of a cavitating jet to be referred to,

p_{1ref} denotes an injection pressure to be referred to,

d_{ref} denotes a nozzle diameter to be referred to,

Kₙ denotes a shape function dependent on a nozzle shape or the shape of a testing unit,

f(σ) denotes an influence function at the cavitation number σ, and

f(σ_{ref}) denotes the influence function at a cavitation number σ_{ref} to be referred to).

[38]

The program according to [37], wherein Kₙ=1 in the Equation (2).

[39]

A computer-readable recording medium recording the program according to any one of [36] to [38].

In the first to third embodiments of the present invention, by having the aforementioned configuration, the cavitating jet performance estimation method, the cavitating jet performance estimation system and the cavitating jet performance estimation device according to the present invention obtain the cavitating jet performance at each condition by conducting a cavitating jet test at various conditions of the injection pressure p₁, the nozzle diameter d and the cavitation number σ_{ref}, and obtains the respective functions of the Equations (1) to (3) for calculating the estimated cavitating jet performance E_{cav} of the cavitating jet from these pieces of data. By calculating the estimated cavitating jet performance E_{cav} of the cavitating jet to be estimated using the Equations (1) to (3), each function and each parameter of the Equations (1) to (3), the estimated cavitating jet performance E_{cav} can be easily obtained with high accuracy without testing the cavitating jet to be estimated by an actual fluid machine and a model fluid machine, which can be made use of in the case of determining hydrodynamic parameters in an operation utilizing a cavitating jet and designing and fabricating a cavitating jet generator utilizing a cavitating jet.

Further, the cavitating jet performance calculation formula specification system and the cavitating jet performance calculation formula specification device according to the present invention can obtain the estimated cavitating jet performance with high accuracy by specifying the functions for the power indices of the injection pressure p₁ and the nozzle diameter d in the Equations (1) to (3) to obtain the power indices of the injection pressure p₁ and the nozzle diameter d in the estimation of the cavitating jet performance, which has been conventionally unknown, as functions of the cavitation number σ.

Further, the cavitating jet estimation error calculation device according to the present invention can specifically grasp the estimation accuracy by calculating an error between the estimated cavitating jet performance and the actually measured cavitating jet performance.

Further, the cavitating jet performance evaluation device according to the present invention can contribute to the determination of data on hydrodynamic parameters to be estimated and data to be referred to used in the estimation of the cavitating jet performance and improve estimation accuracy by evaluating an estimation result based on a cavitating jet performance estimation error.

[4. Description of Modifications]

<First Modification>

In the first or second embodiment, the shape function Kₙ in the Equations (2), (3) may be 1.

Since a contribution of the shape dependent on the nozzle shape or the shape of the testing unit to the cavitating jet performance is relatively small as compared with the injection pressure p, the nozzle diameter d and the cavitation number σ, the estimated cavitating jet performance can be calculated without considering the effect of the shape dependent on the nozzle shape or the shape of the testing unit by setting the shape function Kₙ=1.

This enables the cavitating jet performance to be more easily estimated. Further, by performing the calculation without considering the shape dependent on the nozzle shape or the shape of the testing unit, the cavitating jet performance can be estimated based on the parameters such as the injection pressure p, the nozzle diameter d and the cavitation number σ.

<Second Modification>

In the jet performance estimation means 37 of the first embodiment, the C means 38 sets the order of operations of the injection pressure p₁, the nozzle diameter d and the cavitation number σ in calculating the estimated cavitating jet performance. The value of the estimated cavitating jet performance E_{cav} changes depending on this order of operations of the injection pressure p₁, the nozzle diameter d and the cavitation number σ in calculating the estimated cavitating jet performance E_{cav} from the Equation (3) based on the order of operations in the D means 39.

This holds true also in the second and third embodiments and the value of the estimated cavitating jet performance E_{cav} changes depending on this order of operations of the injection pressure p₁, the nozzle diameter d and the cavitation number σ in calculating the estimated cavitating jet performance E_{cav} from the Equation (3).

As described above, there are six possible estimation processes depending on the order of operations of the injection pressure p₁, the nozzle diameter d and the cavitation number σ in calculating the estimated cavitating jet performance E_{cav} from the Equation (3). The estimation process in each Step and the estimated value of the cavitating jet performance obtained by the estimation process are shown in the following TABLE 1 to 6 for each order of operations.

Examples of estimating the cavitating jet performance E_{cav} of the cavitating jet from reference conditions (injection pressure p_{1ref} of the cavitating jet=10 MPa, d_{ref}=1 mm, cavitating jet performance E_{ref} at σ_{ref}=0.01=19.9 mg/min) and estimation conditions (injection pressure p₁ of the cavitating jet=30 MPa, d=2 mm, σ=0.014).

It should be noted that an actual measurement value of E_{cav} at p₁=30 MPa, d=2 mm and σ=0.014 was 1428 mg/min.

TABLE 1
In the case of estimation by changing the
parameters in an order of d→σ→p₁

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 10 | 2 | 0.1 | 0.01 | 19.9 | 2.221 | 1.604 | 0.792 | 60.5 | 56.4 |
| 10 | 2 | 0.14 | 0.014 | 60.5 | 2.453 | 1.966 | 0.994 | 75.9 | 79.1 |
| 30 | 2 | 0.42 | 0.014 | 75.9 | 2.453 | 1.966 | 0.994 | 1124.0 | 1428.0 |

TABLE 2
In the case of estimation by changing the
parameters in an order of d→p₁→σ

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 10 | 2 | 0.1 | 0.01 | 19.9 | 2.221 | 1.604 | 0.792 | 60.5 | 56.4 |
| 30 | 2 | 0.3 | 0.01 | 60.5 | 2.221 | 1.604 | 0.792 | 694.1 | |
| 30 | 2 | 0.42 | 0.014 | 694.1 | 2.453 | 1.966 | 0.994 | 870.7 | 1428.0 |

TABLE 3
In the case of estimation by changing the
parameters in an order of σ→p₁→d

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 10 | 1 | 0.14 | 0.014 | 19.9 | 2.453 | 1.966 | 0.994 | 25.0 | |
| 30 | 1 | 0.42 | 0.014 | 25.0 | 2.453 | 1.966 | 0.994 | 369.7 | |
| 30 | 2 | 0.42 | 0.014 | 369.7 | 2.453 | 1.966 | 0.994 | 1444.1 | 1428.0 |

TABLE 4
In the case of estimation by changing the
parameters in an order of σ→d→p₁

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 10 | 1 | 0.14 | 0.014 | 19.9 | 2.453 | 1.966 | 0.994 | 25.0 | |
| 10 | 2 | 0.14 | 0.014 | 25.0 | 2.453 | 1.966 | 0.994 | 97.5 | |
| 30 | 2 | 0.42 | 0.014 | 97.5 | 2.453 | 1.966 | 0.994 | 1444.1 | 1428.0 |

TABLE 5
In the case of estimation by changing the
parameters in an order of p₁→σ→d

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 30 | 1 | 0.3 | 0.01 | 19.9 | 2.221 | 1.604 | 0.792 | 228.3 | |
| 30 | 1 | 0.42 | 0.014 | 228.3 | 2.453 | 1.966 | 0.994 | 286.4 | |
| 30 | 2 | 0.42 | 0.014 | 286.4 | 2.453 | 1.966 | 0.994 | 1118.7 | 1428.0 |

TABLE 6
In the case of estimation by changing the
parameters in an order of p₁→d→σ

| | | | | | | | | | Actual |
|---|---|---|---|---|---|---|---|---|---|
| | | | | | | | | Esti- | Measure- |
| | | | | | | | | mated | ment |
| p₁ | d | p₂ | σ | E_{ref} | nₚ | n_{d} | f(σ) | value | Value |
| 10 | 1 | 0.1 | 0.01 | 19.9 | 2.221 | 1.604 | 0.792 | | |
| 30 | 1 | 0.3 | 0.01 | 19.9 | 2.221 | 1.604 | 0.792 | 228.3 | |
| 30 | 2 | 0.3 | 0.01 | 228.3 | 2.221 | 1.604 | 0.792 | 694.1 | |
| 30 | 2 | 0.42 | 0.014 | 694.1 | 2.453 | 1.966 | 0.994 | 863.7 | 1428.0 |

As is understood from TABLES 1 to 6, the final estimated cavitating jet performance E_{cav} changes depending on the order of operations of the cavitation number σ, the injection pressure p₁ and the nozzle diameter d in calculating the estimated cavitating jet performance. It is understood from the comparison of the actual measurement value of the cavitating jet performance and the estimated cavitating jet performance E_{cav} that the estimated cavitating jet performance can be calculated with high accuracy when the cavitation number σ is high in the order of operations. This is thought to be because the estimated cavitating jet performance E_{cav} is not a sufficiently large value when the calculation is performed with the injection pressure p₁ and the nozzle diameter d set high in the order of operations due to the effect of the power. On the other hand, the estimation accuracy of the cavitating jet performance is thought to increase by first introducing the cavitation number σ having no effect of a power and introducing the injection pressure p₁ and the nozzle diameter d having an effect of the power later.

<Third Modification>

In the first to third embodiments, there is described the method of the estimation process for introducing the cavitation number σ, the injection pressure p₁ and the nozzle diameter d of the cavitating jet to be estimated in one step from the jet performance p_{1ref}, the value of the nozzle diameter d_{ref} and the cavitation number σ_{ref} of the cavitating jet to be referred to in calculating the estimated cavitating jet performance in Step S35.

A method of the estimation process for taking intermediate values between the jet performance p_{1ref}, the value of the nozzle diameter d_{ref} and the cavitation number σ_{ref} of the cavitating jet to be referred to and the cavitation number σ, the injection pressure p₁ and the nozzle diameter d of the cavitating jet to be estimated and introducing the parameters in multiple steps is described as a modification.

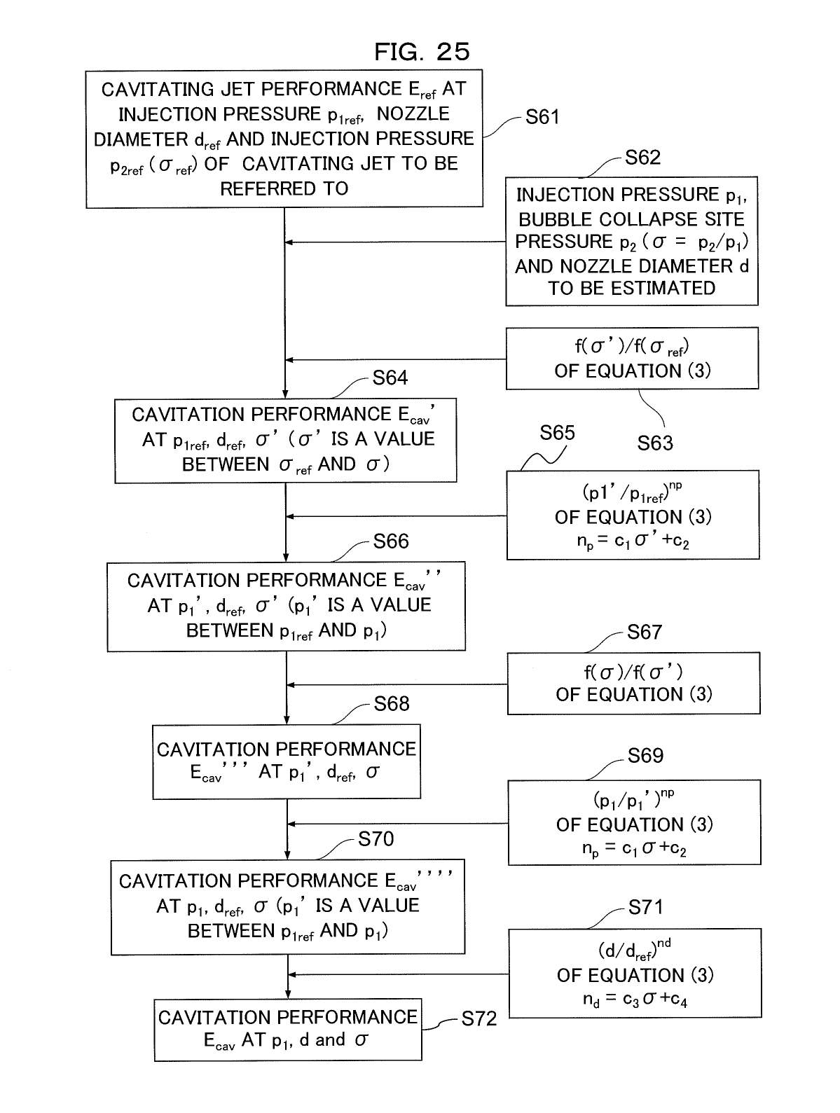

FIG. 25 is a chart showing a flow for estimating the cavitating jet performance to describe the estimation process.

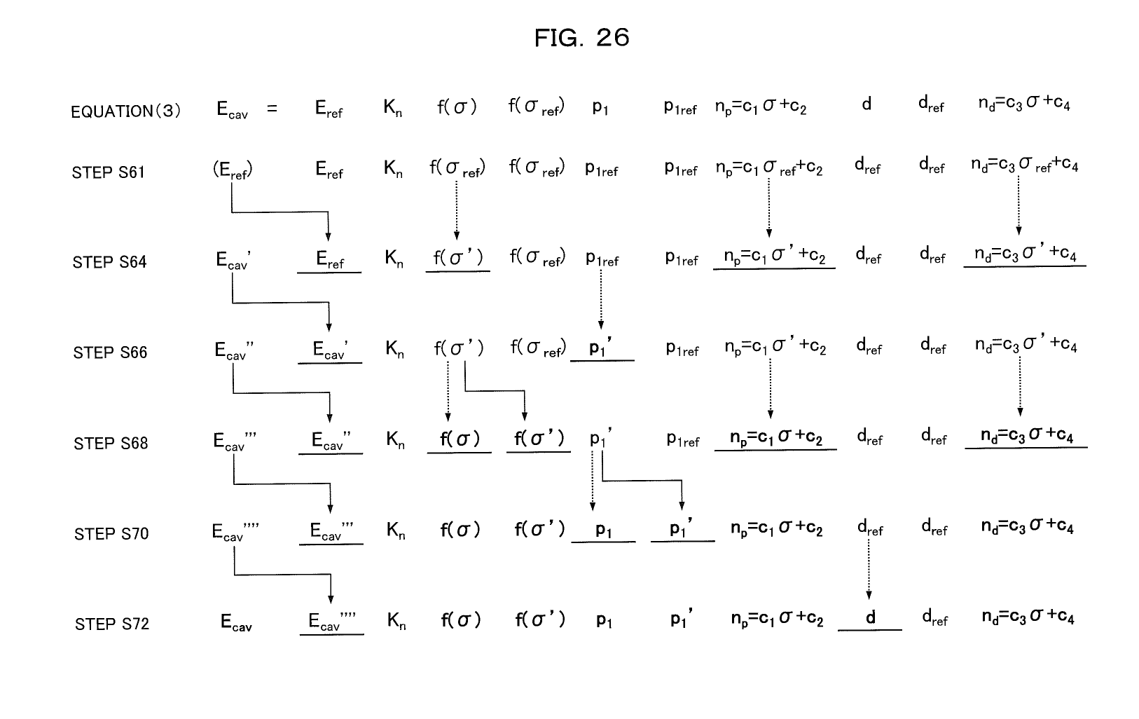

FIG. 26 is a chart showing a relationship of each term of the Equation (3), parameters to be introduced into each term and a calculation process to describe the estimation process.

The multiple-step estimation process of the cavitating jet performance performed by the D means 39 is described using FIGS. 25 and 26. Here, a process of estimation in multiple steps using a cavitation number σ′ as an intermediate value between the cavitation number σ_{ref} to be referred to and the cavitation number σ to be estimated and an injection pressure p₁′ as an intermediate value between the injection pressure p_{1ref} to be referred to and the injection pressure p₁ to be estimated in the case of calculating the cavitating jet performance E_{cav} in the order of operations of cavitation number σ→injection pressure p₁→nozzle diameter d is described as an example. However, a process of estimation in multiple steps, for example, using a nozzle diameter d′ as an intermediate value between the nozzle diameter d_{ref} to be referred to and the nozzle diameter d to be estimated can be similarly performed.

First, the flow of the multi-step estimation process is described using FIG. 25.

First, the cavitating jet performance when all the parameters including the injection pressure p₁, the nozzle diameter d and the cavitation number σ are parameters of the cavitating jet to be referred to, i.e. at the injection pressure p_{1ref}, the nozzle diameter d_{ref} and an injection pressure p_{2ref} (σ_{ref}=p_{2ref}/p_{1ref}) is estimated using the Equation (3). The estimated cavitating jet performance at this time is expressed as the cavitating jet performance E_{ref} of the cavitating jet to be referred to (Step S61).

Subsequently, the injection pressure p₁, the bubble collapse site pressure p₂ (σ=p₂/p₁) and the nozzle diameter d of the cavitating jet to be estimated are obtained (Step S62). It should be noted that this processing is equivalent to Step S34 of FIG. 11.

Further, f(σ′)/f(σ_{ref}) of the Equation (3) is calculated using an influence function f(σ′) in the case of the cavitation number σ′ as the intermediate value between the cavitation number σ_{ref} to be referred to and the cavitation number σ to be estimated (Step S63).

Then, using the Equation (3), estimated cavitating jet performance E_{cav}′ when only the cavitation number σ′ as the intermediate value is newly introduced as the first parameter of the order of operations (here, cavitation number σ), i.e. at p_{1ref}, d_{ref} and σ′ is calculated (Step S64).

Subsequently, (p₁′/p_{1ref})^{np} and nₚ=c₁σ′+c₂ of the Equation (3) are calculated using the cavitation number σ′ as the intermediate value between the cavitation number σ_{ref} to be referred to and the cavitation number σ to be estimated and the injection pressure p₁′ as the intermediate value between the injection pressure p_{1ref} to be referred to and the injection pressure p₁ to be estimated (Step S65).

Then, using the Equation (3), estimated cavitating jet performance E_{cav}″ when the cavitation number σ′ as the intermediate value and the injection pressure p₁′ as the intermediate value are introduced as the first and second parameters of the order of operations (here, cavitation number σ and injection pressure p₁), i.e. at p₁′, d_{ref} and σ′ is calculated (Step S66).

Subsequently, f(σ)/f(σ′) of the Equation (3) is calculated using the cavitation number σ′ as the intermediate value between the cavitation number σ_{ref} to be referred to and the cavitation number σ to be estimated and the cavitation number σ to be estimated (Step S67).

Then, using the Equation (3), estimated cavitating jet performance E_{cav}′″ when the cavitation number σ to be estimated and the injection pressure p₁′ as the intermediate value are introduced as the first and second parameters of the order of operations, i.e. at p₁′, d_{ref} and σ is calculated (Step S68). At this time, the cavitation number σ′ as the intermediate value is introduced as the cavitation number σ_{ref} to be referred to.

Subsequently, (p₁′/p_{1ref})^{np} of the Equation (3) is calculated using the injection pressure p₁′ as the intermediate value between the injection pressure p_{1ref} to be referred to and the injection pressure p₁ to be estimated and the injection pressure p₁ to be estimated and nₚ=c₁σ+c₂ is calculated using the cavitation number σ to be estimated (Step S69).

Then, using the Equation (3), estimated cavitating jet performance E_{cav}″″ when the cavitation number σ to be estimated and the injection pressure p₁ to be estimated are introduced as the first and second parameters of the order of operations, i.e. at p₁, d_{ref} and σ is calculated (Step S70). At this time, the injection pressure p₁′ as the intermediate value is introduced as the injection pressure p_{1ref} to be referred to.

Subsequently, (d/d_{ref})^{nd} and n_{d}=c₃σ+c₄ of the Equation (3) are calculated (Step S71).

Finally, using the Equation (3), the cavitating jet performance E_{cav} when the parameters of the cavitating jet to be estimated are introduced as all the first to third parameters of the order of operations, i.e. at p₁, d and σ is calculated.

A relationship of each term of the Equation (3) and the parameters introduced into each term for the process described using FIG. 25 is summarized as in FIG. 26. In FIG. 26, the term of the parameter changed from the preceding Step is shown by a broken-line arrow and an underline. Further, if the parameter calculated in the preceding Step is used in the succeeding Step, this parameter is shown by a solid-line arrow and an underline.

First, in Step S61, the terms (f(σ), f(σ_{ref}), p₁, p_{1ref}, d, d_{ref}, nₚ, n_{d}) relating to the cavitation number, the injection pressure and the nozzle diameter of the Equation (3) are all parameters of the cavitating jet to be estimated. The estimated cavitating jet performance at this time is equivalent to E_{ref} if the shape function Kₙ=1.

Subsequently, in Step S64, the estimated cavitating jet performance E_{ref} calculated in Step S61 is used as the cavitating jet performance E_{ref} of the cavitating jet to be referred to and the estimated cavitating jet performance E_{cav}′ is calculated by introducing the cavitation number σ′ into the intermediate value into f(σ).

Subsequently, in Step S66, the estimated cavitating jet performance E_{cav}′ calculated in Step S64 is used as the cavitating jet performance E_{ref} of the cavitating jet to be referred to and the estimated cavitating jet performance E_{cav}′″ is calculated by introducing the injection pressure p₁′ as the intermediate value into the injection pressure p₁.

Subsequently, in Step S68, the estimated cavitating jet performance E_{cav}′″ calculated in Step S66 is used as the cavitating jet performance of the cavitating jet to be referred to and the estimated cavitating jet performance E_{cav}″″ is calculated by introducing the cavitation number σ to be estimated into f(σ) and σ′ into f(σ_{ref}).

Subsequently, in Step S70, the estimated cavitating jet performance E_{cav}″″ calculated in Step S68 is used as the cavitating jet performance of the cavitating jet to be referred to and the estimated cavitating jet performance E_{cav}″″ is calculated by introducing the injection pressure p₁ to be estimated into p₁ and the injection pressure p₁′ as the intermediate value into p_{1ref}.

Finally, in Step S72, the estimated cavitating jet performance E_{cav}″″ calculated in Step S70 is used as the cavitating jet performance of the cavitating jet to be referred to and the estimated cavitating jet performance E_{cav} of the cavitating jet to be estimated is calculated by introducing the nozzle diameter d of the cavitating jet to be estimated into the nozzle diameter d.

By utilizing the aforementioned process, the estimated cavitating jet performance E_{cav} at the cavitation number σ, the injection pressure p₁ and the nozzle diameter d of the cavitating jet to be estimated can be finally calculated from the injection pressure p_{1ref}, the value of the nozzle diameter d_{ref} and the cavitation number σ_{ref} of the cavitating jet to be referred for the parameters of the Equation (3) by way of the calculation of the estimated cavitating jet performance based on the intermediate value p₁′ of the injection pressure, the intermediate value d′ of the nozzle diameter and the intermediate value σ′ of the cavitation number.

It should be noted that the intermediate values can be calculated and obtained from the parameters of the cavitating jet to be referred to and those of the cavitating jet to the estimated. The intermediate values may be calculated when being used in the estimation process or predetermined intermediate values may be stored in a database in advance and read and used as appropriate.

Here, an example in the case of the multi-step estimation process is shown below.

An example of estimating the estimated cavitating jet performance E_{cav} at estimation conditions (injection pressure p₁ of the cavitating jet=30 MPa, cavitation number σ=0.01) from reference conditions (injection pressure p_{1ref} of the cavitating jet=10 MPa, cavitating jet performance E_{ref} at cavitation number σ_{ref}=0.03) is shown as separate estimation processes in several steps. These estimation processes are shown in the following (1) to (5) depending on how many times as much as E_{ref} the estimated cavitating jet performance E_{cav} of the cavitating jet to be estimated is.

(1) In the case of the process in one step:

E_{cav}/E_{ref}=(30/10)^{3.383}=41.1 fold in the case of using nₚ=3.383 at σ_{ref}=0.03.

(2) In the case of the process in one step:

E_{cav}/E_{ref}=(30/10)^{2.221}=11.5 fold in the case of using nₚ=2.221 at σ_{ref}=0.01.

(3) In the case of the process in four steps:

p_{1ref}=10 MPa, σ_{ref}=0.03

→p₁=15 MPa, σ=0.02 (3.115 fold)

→p₁=20 MPa, σ=0.15 (2.060 fold)

(a total of 6.4 fold, i.e. 3.1115×2.06 fold from p_{1ref}=10 MPa, σ_{ref}=0.03)

→p₁=25 MPa, σ=0.12 (1.685 fold)

(a total of 10.8 fold, i.e. 6.4×1.685 fold from p_{1ref}=10 MPa, σ_{ref}=0.03)

→p₁=30 MPa, σ=0.01 (1.499 fold)

(a total of 16.2 fold, i.e. 10.8×1.499 fold from p_{1ref}=10 MPa, σ_{ref}=0.03)

TABLE 7

| σ | p₂ | p₁ | nₚ | ΔE_{cav} | E_{cav} |
|---|---|---|---|---|---|
| 0.0300 | 0.3 | 10 | 3.383 | 1.000 | 1.0 |
| 0.0200 | 0.3 | 15 | 2.802 | 3.115 | 3.1 |
| 0.0150 | 0.3 | 20 | 2.512 | 2.060 | 6.4 |
| 0.0120 | 0.3 | 25 | 2.337 | 1.685 | 10.8 |
| 0.0100 | 0.3 | 30 | 2.221 | 1.499 | 16.2 |

(4) In the case of the process in ten steps:

18.0 fold from p_{1ref}=10 MPa, σ_{ref}=0.03

TABLE 8

| σ | p₂ | p₁ | n | ΔE_{cav} | E_{cav} |
|---|---|---|---|---|---|
| 0.0300 | 0.3 | 10 | 3.383 | 1.000 | 1.0 |
| 0.0250 | 0.3 | 12 | 3.093 | 1.757 | 1.8 |
| 0.0214 | 0.3 | 14 | 2.885 | 1.560 | 2.7 |
| 0.0188 | 0.3 | 16 | 2.729 | 1.440 | 3.9 |
| 0.0167 | 0.3 | 18 | 2.608 | 1.360 | 5.4 |
| 0.0150 | 0.3 | 20 | 2.512 | 1.303 | 7.0 |
| 0.0136 | 0.3 | 22 | 2.432 | 1.261 | 8.8 |
| 0.0125 | 0.3 | 24 | 2.366 | 1.229 | 10.8 |
| 0.0115 | 0.3 | 26 | 2.310 | 1.203 | 13.0 |
| 0.0107 | 0.3 | 28 | 2.263 | 1.183 | 15.4 |
| 0.0100 | 0.3 | 30 | 2.221 | 1.166 | 18.0 |

(5) In the case of the process in twenty steps:

18.6 fold from p_{1ref}=10 MPa, σ_{ref}=0.03

TABLE 9

| σ | p₂ | p₁ | n | ΔE_{cav} | E_{cav} |
|---|---|---|---|---|---|
| 0.0300 | 0.3 | 10 | 3.383 | 1.000 | 1.0 |
| 0.0273 | 0.3 | 11 | 3.225 | 1.360 | 1.4 |
| 0.0250 | 0.3 | 12 | 3.093 | 1.309 | 1.8 |
| 0.0231 | 0.3 | 13 | 2.981 | 1.269 | 2.3 |
| 0.0214 | 0.3 | 14 | 2.885 | 1.238 | 2.8 |
| 0.0200 | 0.3 | 15 | 2.802 | 1.213 | 3.4 |
| 0.0188 | 0.3 | 16 | 2.729 | 1.193 | 4.0 |
| 0.0176 | 0.3 | 17 | 2.665 | 1.175 | 4.8 |
| 0.0167 | 0.3 | 18 | 2.608 | 1.161 | 5.5 |
| 0.0158 | 0.3 | 19 | 2.557 | 1.148 | 6.3 |
| 0.0150 | 0.3 | 20 | 2.512 | 1.137 | 7.2 |
| 0.0143 | 0.3 | 21 | 2.470 | 1.128 | 8.1 |
| 0.0136 | 0.3 | 22 | 2.432 | 1.120 | 9.1 |
| 0.0130 | 0.3 | 23 | 2.398 | 1.112 | 10.1 |
| 0.0125 | 0.3 | 24 | 2.366 | 1.106 | 11.2 |
| 0.0120 | 0.3 | 25 | 2.337 | 1.100 | 12.3 |
| 0.0115 | 0.3 | 26 | 2.310 | 1.095 | 13.5 |
| 0.0111 | 0.3 | 27 | 2.286 | 1.090 | 14.7 |
| 0.0107 | 0.3 | 28 | 2.263 | 1.086 | 16.0 |
| 0.0103 | 0.3 | 29 | 2.241 | 1.082 | 17.3 |
| 0.0100 | 0.3 | 30 | 2.221 | 1.078 | 18.6 |

From the results of (1) to (5), the estimated cavitating jet performance E_{cav} was 11.5 fold of E_{ref} in one step, whereas it was 16.2 fold in four steps, 18.0 folds in ten steps and 18.6 fold in twenty steps. It is understood that a different value of the estimated cavitating jet performance E_{cav} can be obtained by changing a calculation process even if the first parameters are the same.

It should be noted that the estimation process of introducing the parameters in multiple steps in the present modification may be used in combination with a process of calculation with an introducing order (order of operations) of the respective parameters changed. Specifically, the introducing order of the cavitation number σ, the injection pressure p₁ and the nozzle diameter d may be exchanged and it is possible to introduce the respective parameters in multiple steps and conduct estimation by exchanging the introducing order of the respective parameters in multiple steps.

<Fourth Modification>

In the first to third embodiments, performance of the cavitating jet can be evaluated in consideration of the width w (see FIG. 3) of the cavitating jet after the estimated cavitating jet performance is obtained.

The width w of the cavitating jet is expressed by the following Equation (8).

[Equation 45]

w=0.6546dσ^{-0.744} (8)

Here, when a relative collision energy density on a collision surface is considered, energy on the collision surface is inversely proportional to the square of a diameter of a collision portion if the collision portion is assumed to be a circle having a diameter w. Thus, the relative impact energy density on the collision surface can be expressed as E_{cav}/w².

In the present modification, the aforementioned cavitating jet performance estimation device further includes a means for calculating the relative impact energy density.

If a relationship of the cavitation number σ and the cavitation number σₘₐₓ exhibiting maximum cavitating jet performance is σ<<σₘₐₓ, E_{cav}/w² drastically decreases since the estimated cavitating jet performance E_{cav} decreases and the width w increases. Thus, a decreases with an increase in p₁ under the condition that p₂ is constant, wherefore processing performance does not increase, but rather decreases even if p₁ is increased. Contrary to that, at σ≈0.014, E_{cav} increases and w decreases, wherefore the cavitating jet can be produced in a concentrated manner.

### EXAMPLES

Hereinafter, the present invention is described in more detail by way of examples. The present invention is not limited to the following examples without departing from the gist thereof.

### Example 1

In the present Example, a cavitation peening test was conducted with several hydrodynamic parameters, the optimum standoff distance sₒₚₜ was first calculated and the erosion rate as the cavitating jet performance was measured at this optimumstandoff distance sₒₚₜ. From data of the test at this time, the functions nₚ and n_{d} for the power indices and the influence function f(σ) of the Equation (3) were specified. Then, the estimated cavitating jet performance E_{cav} was calculated using the Equation (3). Further, the obtained estimated cavitating jet performance and the erosion test result were compared.

(Cavitating Jet Test)

By conducting the cavitating jet test at each condition using the cavitating jet testing device 101 configured as shown in FIG. 1, the maximum cumulative erosion rate E_{Rmax} of the test piece 110 was obtained as an index of the cavitating jet performance.

In the cavitating jet test, by causing a cavitating jet to act on the test piece 110 (hereinafter, also referred to as an erosion test piece), the amount of mass loss caused in the erosion test piece was measured and the maximum cumulative erosion rate E_{Rmax} was calculated from this value.

The plunger pump 104 pressurized at conditions of a maximum discharge pressure of 30 MPa and a maximum discharge flow rate of 3×10⁻² m³/min.

The nozzle 106 was a cylindrical nozzle and the nozzle tip part 107 was shaped as shown in FIG. 4(a).

The cylinder diameter D and the cylinder length L of the nozzle tip part 107 was set at d:D:L=1:8:8 with respect to the nozzle diameter d. The test was conducted with the nozzle diameter d set at 1 to 2.5 mm and the injection pressure (nozzle upstream pressure) p₁ set in a range of 10 to 30 MPa.

It should be noted that a length I of the nozzle throat portion was set to be constant at I/d=3.

Pure aluminum (JIS A1050P) was used as an erosion test piece in both the erosion test for obtaining the optimum standoff distance and the erosion test for obtaining the maximum cumulative erosion rate E_{Rmax}.

An erosion time t at each cavitation number σ and each injection pressure p₁ in obtaining the optimum standoff distance sₒₚₜ was as shown in TABLE 10.

TABLE 10
Erosion time t to obtain optimum standoff distance

| Cavitation | Injection pressure p₁ MPa | | | | |
|---|---|---|---|---|---|
| number σ | 10 MPa | 25 MPa | 20 MPa | 25 MPa | 30 MPa |
| 0.01 | 10 min | 5 min | 3 min | 2 min | 1 min |
| 0.014 | 10 min | 5 min | 3 min | 3 min | 2 min |
| 0.02 | 10 min | 5 min | 5 min | — | — |

The cavitating jet test was conducted at the conditions of the injection pressure p₁, the nozzle diameter d and the cavitation number σ shown in TABLE 11.

TABLE 11
Maximum cumulative erosion rate at various cavitating conditions

| Injection pressure | Nozzle diameter | Cavitation | Erosion rate |
|---|---|---|---|
| p₁ MPa | d mm | number σ | E_{Rmax} mg/min |
| 10 | 1 | 0.01 | 19.9 |
| 10 | 1.5 | 0.01 | 37 |
| 10 | 2 | 0.01 | 56.4 |
| 10 | 2.5 | 0.01 | 86.7 |
| 10 | 1 | 0.014 | 22.4 |
| 10 | 1.5 | 0.014 | 49.1 |
| 10 | 2 | 0.014 | 86.1 |
| 10 | 2.5 | 0.014 | 142.8 |
| 10 | 1 | 0.02 | 13.6 |
| 10 | 1.5 | 0.02 | 36.9 |
| 10 | 2 | 0.02 | 79.1 |
| 10 | 2.5 | 0.02 | 131.6 |
| 15 | 1 | 0.01 | 46.5 |
| 20 | 1 | 0.01 | 105.9 |
| 25 | 1 | 0.01 | 161.2 |
| 30 | 1 | 0.01 | 216.1 |
| 15 | 1 | 0.014 | 61.9 |
| 20 | 1 | 0.014 | 122.3 |
| 25 | 1 | 0.014 | 197.5 |
| 30 | 1 | 0.014 | 341.6 |
| 15 | 1 | 0.02 | 43.3 |
| 20 | 1 | 0.02 | 95.4 |
| 20 | 0.4 | 0.01 | *63.5 |
| 20 | 0.4 | 0.012 | *91.2 |
| 20 | 0.4 | 0.014 | *98.2 |
| 20 | 0.4 | 0.02 | *81.1 |
| 20 | 0.4 | 0.025 | *69.2 |

(Calculation of optimum standoff distance Sₒₚₜ)

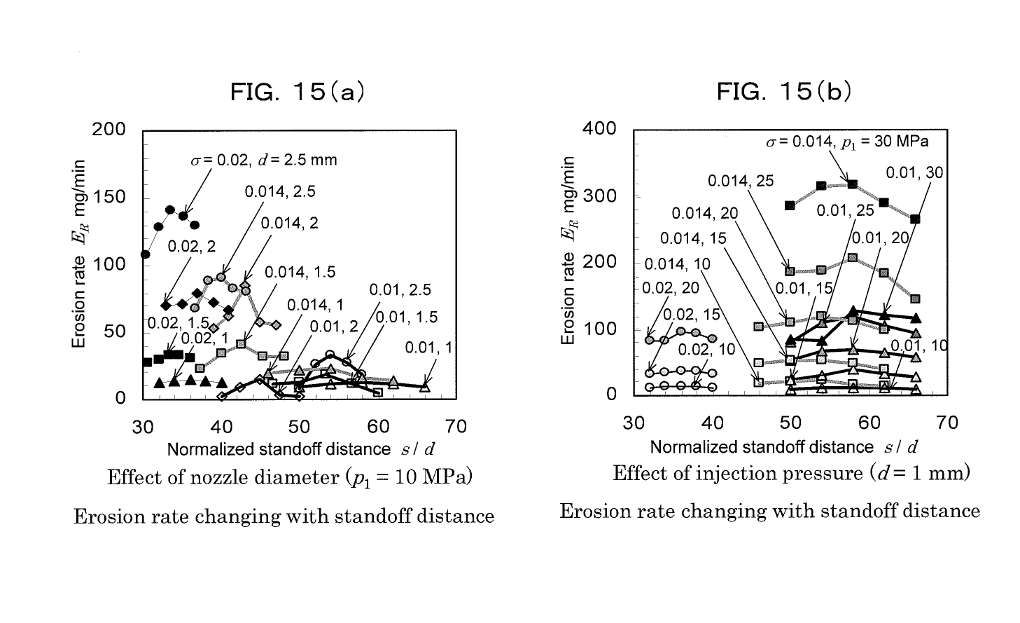

FIGS. 15(a), 15(b) show an erosion rate E_{R} obtained by dividing a mass loss Δm caused when the cavitating jet was injected to the erosion test piece while changing the standoff distance by the erosion time t to clarify the optimum standoff distance at each condition. In FIGS. 15(a), 15(b), the erosion rate E_{R} is shown using a dimensionlessstandoff distance s/d obtained by dividing thestandoff distance s by d to clarify the effect of a nozzle throat diameter (nozzle diameter).

In FIG. 15(a), the nozzle diameter d, the cavitation number σ and the standoff distance s are changed with the injection pressure p₁ kept constant and a relationship of thestandoff distance s and the erosion rate E_{R} at each cavitation number σ and each nozzle diameter d is shown.

In FIG. 15(b), the injection pressure p₁, the cavitation number σ and thestandoff distance s are changed with the nozzle diameter d kept constant and a relationship of thestandoff distance s and the erosion rate ER at each cavitation number σ and each injection pressure p₁ is shown.

The presence of the standoff distance s, at which the erosion rate ER is maximum with respect to the standoff distance, at each condition is seen from FIGS. 15(a), 15(b). From the perspective of effectively utilizing a cavitation impact force, impact energy is thought to be maximum at the standoff distance s at which the erosion rate ER is maximum. Thus, in the present Example, this standoff distance s is called the optimum standoff distance sₒₚₜ.

In FIGS. 15(a), 15(b), thestandoff distance s at the dimensionless standoff distance s/d at which the erosion rate ER was maximum was specified as the optimum standoff distance sₒₚₜ for each cavitation number σ and each nozzle diameter d. In the erosion test for obtaining the maximum cumulative erosion rate E_{R} shown in TABLE 11, a measurement was made using the optimum standoff distance sₒₚₜ obtained in this way as the standoff distance.

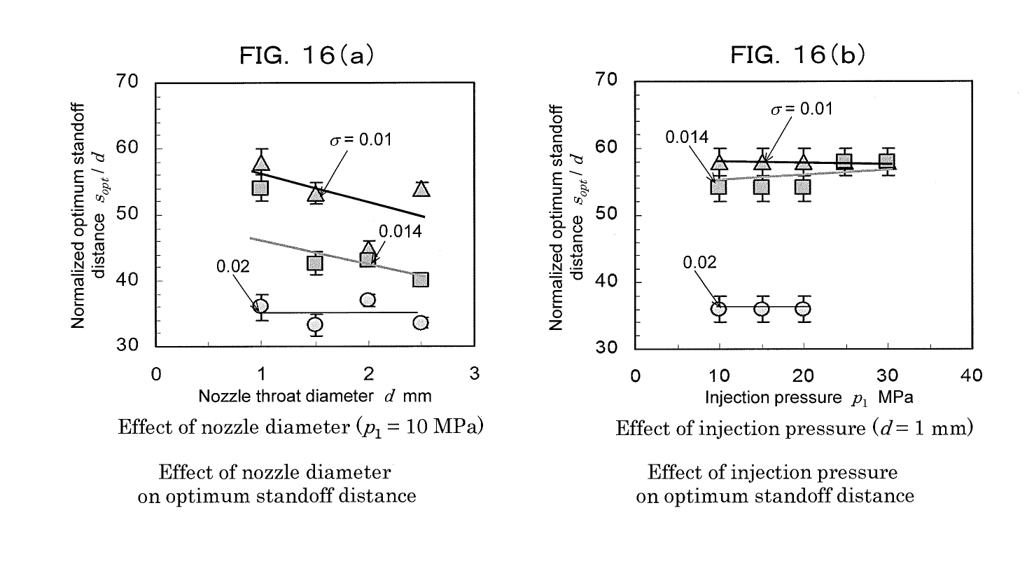

FIG. 16(a) shows a relationship of the nozzle diameter d and a dimensionless optimum standoff distance sₒₚₜ/d obtained by dividing the optimum standoff distance sₒₚₜ by d for each cavitation number σ when the nozzle throat diameter (nozzle diameter) d was changed with the nozzle upstream pressure (injection pressure) p₁ kept constant.

FIG. 16(b) shows a relationship of the injection pressure p₁ and the dimensionless optimum standoff distance sₒₚₜ/d obtained by dividing the optimum standoff distance sₒₚₜ by d for each cavitation number σ when the nozzle upstream pressure (injection pressure) p₁ was changed with the nozzle throat diameter (nozzle diameter) d kept constant.

It is understood from FIGS. 16(a), 16(b) that the optimum standoff distance sₒₚₜ becomes shorter with an increase in the cavitation number σ and, roughly, the optimum standoff distance sₒₚₜ can be expressed by the dimensionless standoff distance if the cavitation number σ is equal. It should be noted that the optimum standoff distance made dimensionless tends to become shorter probably because the jet becomes more turbulent as the nozzle throat diameter (nozzle diameter) d increases.

(Calculation of Maximum Cumulative Erosion Rate ER.)

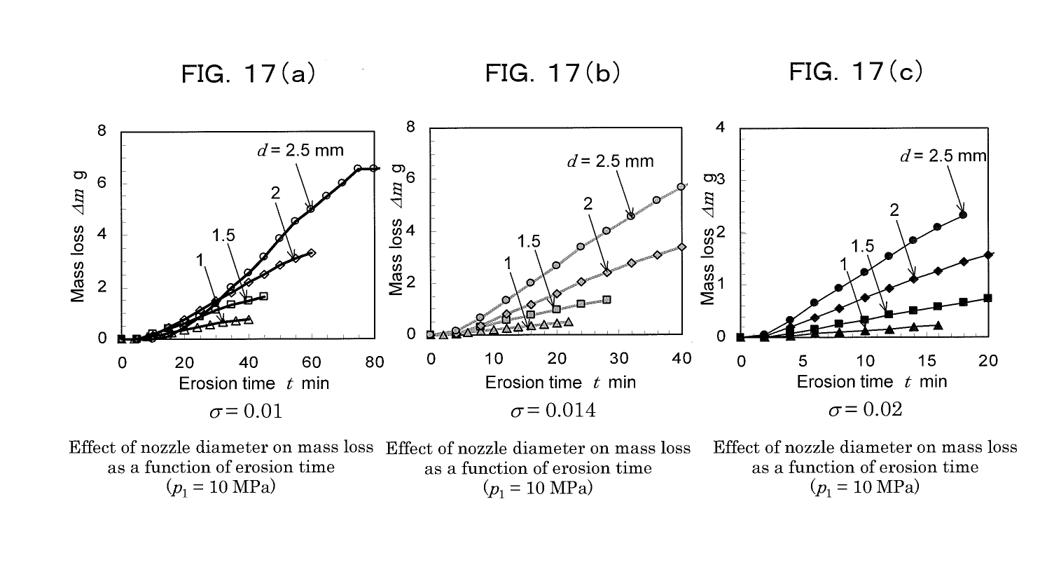

FIGS. 17(a) to 17(c) show a change of the mass loss Δm with time when the erosion test was conducted at each condition to obtain the maximum cumulative erosion rate E_{Rmax} for each nozzle throat diameter (nozzle diameter) d at each cavitation number σ.

It is understood that a latency period during which the erosion rate is low, an acceleration period during which the erosion rate increases with an increase in the erosion time, a steady period during which an instantaneous erosion rate increases substantially in proportion to the erosion time and a decay period during which the erosion rate decreases with the erosion time are present with the passage of the erosion time t at any condition. Further, it is seen at any condition of the cavitation number σ that the erosion rate tends to increase with an increase in the nozzle throat diameter (nozzle diameter). The maximum cumulative erosion rate E_{Rmax} at each nozzle diameter d was obtained from the gradients of the steady periods of FIGS. 17(a) to 17(c).

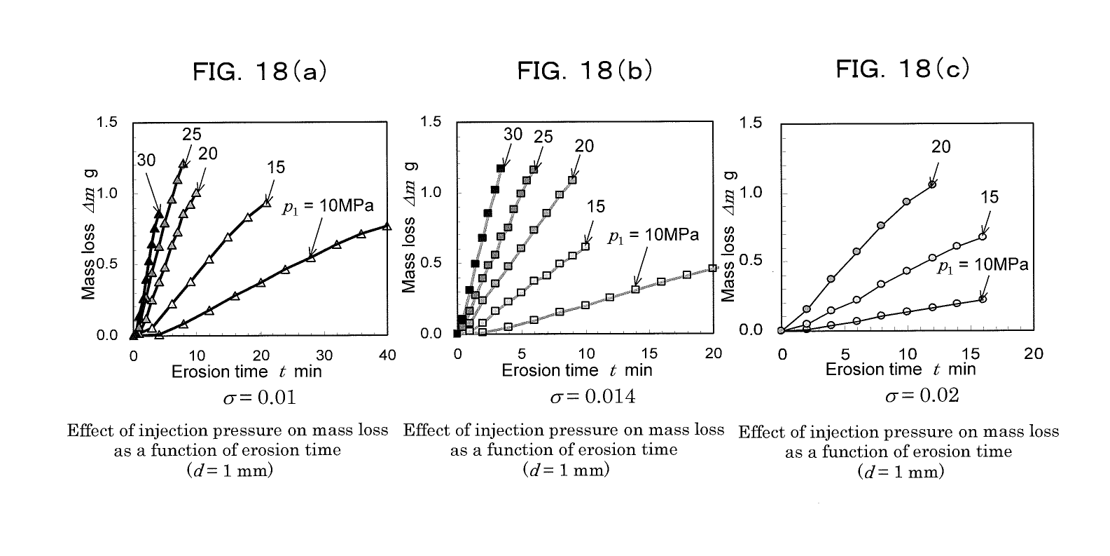

FIGS. 18(a) to 18(c) show a change of the mass loss Δm with time when the erosion test was conducted at each injection pressure p₁ to obtain the maximum cumulative erosion rate E_{Rmax} for each nozzle upstream pressure (injection pressure) p₁ at each cavitation number σ.

It is understood also in FIGS. 18(a) to 18(c) as in FIGS. 17(a) to 17(c) that a latency period, an acceleration period, a steady period and a decay period elapse with the passage of the erosion time t at any condition. Further, it is seen that the erosion rate tends to increase with an increase in the nozzle upstream pressure (injection pressure) p₁. The maximum cumulative erosion rate E_{Rmax} at each injection pressure p₁ was obtained from the gradients of the steady periods of FIGS. 18(a) to 18(c).

TABLE 11 shows the maximum cumulative erosion rate E_{Rmax} at each condition of the injection pressure p₁, the nozzle diameter d and the cavitation number obtained in this way. It should be noted that values shown with * in TABLE 11 are erosion rates obtained for an erosion time of 630 seconds.

(Calculation of Power Index nₚ for Injection Pressure p₁ and Power Index n_{d} for Nozzle Diameter d)

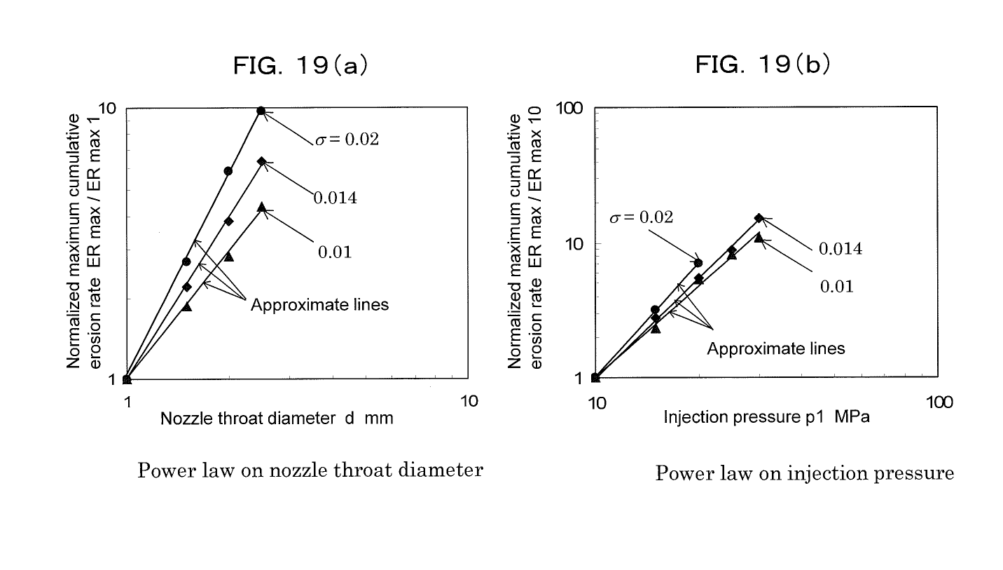

FIG. 19(a) shows a relationship of the nozzle diameter d and the maximum cumulative erosion rate E_{Rmax} made dimensionless by a value E_{Rmax 1} of the maximum cumulative erosion rate at d=1 mm at each σ=0.01, 0.014 and 0.02 for the maximum cumulative erosion rate E_{Rmax} at each nozzle diameter d obtained in FIGS. 17(a) to 17(c) on a double-logarithmic graph to clarify the power law of the nozzle throat diameter (nozzle diameter) d.

It is understood from FIG. 19(a) that the power law as expressed by the following Equation (9) holds between the nozzle throat diameter (nozzle diameter) d and the maximum cumulative erosion rate E_{Rmax} at each cavitation number since measurement values are apparently linearly aligned at each cavitation number σ on the double-logarithmic graph.

[Equation 46]

E_{R max}∝dⁿ^{_{d}} (9)

In the Equation (9), n_{d} denotes a power index of the nozzle throat diameter (nozzle diameter) d. It should be noted that an approximation line by n_{d} obtained by a least squares method at each σ is shown together with a data plot in FIG. 19(a). The power index n_{d} of the nozzle diameter d was calculated to be 1.584 at σ=0.01, 2.007 at σ=0.014 and 2.469 at σ=0.02 from the gradients of the approximation lines of FIG. 19(a). n_{d} is found to increase with an increase in the cavitation number σ.

FIG. 19(b) shows a relationship of the injection pressure p₁ and the maximum cumulative erosion rate E_{Rmax} made dimensionless by a value E_{Rmax 10} of the maximum cumulative erosion rate at p₁=10 MPa at each σ=0.01, 0.014 and 0.02 for the maximum cumulative erosion rate E_{Rmax} at each injection pressure p₁ obtained in FIGS. 18(a) to 18(c) on a double-logarithmic graph to clarify a flow velocity at the exit of the nozzle throat portion, i.e. the power law in the injection pressure (nozzle upstream pressure) p₁ in a manner similar to that for obtaining the power law of the nozzle throat diameter (nozzle diameter) d. A power law of the following Equation (10) similar to the Equation (9) can be assumed for the injection pressure p₁ similarly to the power law of the nozzle throat diameter (nozzle diameter) d.

[Equation 47]

E_{R max}∝p₁ⁿ^{ₚ} (10)

In the Equation (10), nₚ is a power index of the nozzle upstream pressure (injection pressure) p₁. It should be noted that an approximation line by nₚ obtained by a least squares method at each σ is shown together with a data plot in FIG. 19(b). The power index nₚ of the injection pressure p₁ was calculated to be 2.236 at σ=0.01, 2.438 at σ=0.014 and 2.813 at σ=0.02 from the gradients of the approximation lines of FIG. 19(b). nₚ is found to change according to the cavitation number σ and increase with an increase in the cavitation number σ similarly to n_{d}.

Since the power index nₚ of the injection pressure p₁ is relatively close to 3 in FIG. 19(b), cavitation intensity of the cavitating jet can be said to be in proportion to the sixth power of the aforementioned flow velocity. However, when a case where the nozzle upstream pressure is 10 MPa and a case where the nozzle upstream pressure is 30 MPa are, for example, compared for the cavitation intensity, the cavitation intensity is overestimated by 2.3 or more times when nₚ=3 than when nₚ=2.236 at σ=0.01 is used. Further, the cavitation intensity is overestimated by about 1.9 times when nₚ=2.813 than when nₚ=2.236. Thus, it may be said that the cavitating jet performance needs to be evaluated using the power indices taking into account the cavitation number σ.

The respective power indices nₚ, n_{d} at each cavitation number σ calculated in the aforementioned procedure are shown in TABLE 12.

TABLE 12
Power index at power law

| σ | nₚ | n_{d} |
|---|---|---|
| 0.01 | 2.236 | 1.584 |
| 0.014 | 2.438 | 2.007 |
| 0.02 | 2.813 | 2.496 |

(Specification of Functions nₚ and n_{d} for Power Indices)

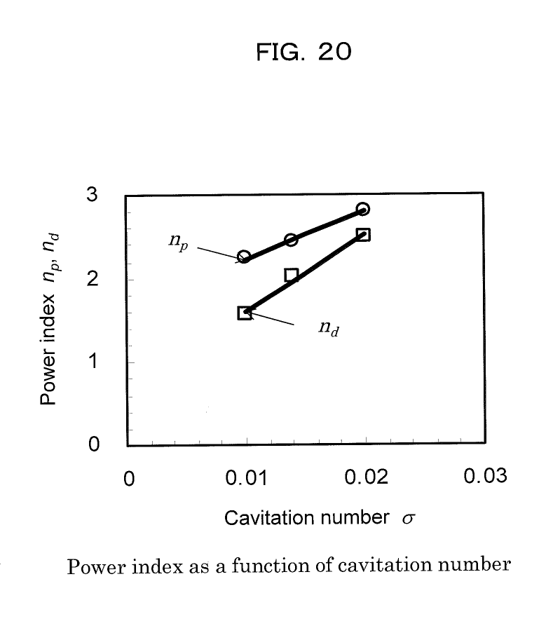

FIG. 20 shows relationships of the cavitation number σ and the power indices nₚ, n_{d} from the result of TABLE 12.

Since a linear relationship is confirmed between the cavitation number σ and the power index nₚ and between the cavitation number σ and the power index n_{d}, the following equations (11), (12) expressing the functions nₚ, n_{d} for the power indices were obtained by obtaining approximation expressions, assuming a linear expression for each relationship.

[Equation 48]

n=58.1σ+1.64 (11)

[Equation 49]

n_{d}=90.4σ+0.70 (12)

(Specification of Influence Function f(σ))

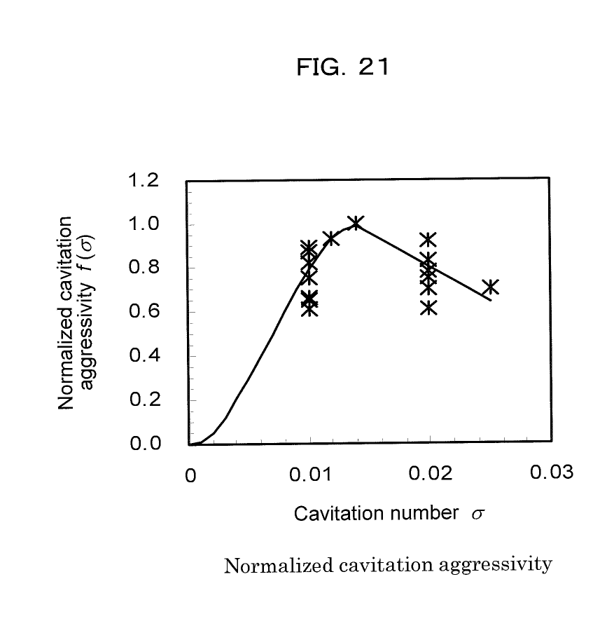

To obtain the influence function f(σ), a relationship of the cavitation number σ and f(σ) was plotted with × in FIG. 21, assuming the maximum cumulative erosion rate ER_{Rmax} of TABLE 11 as f(σ) by making it dimensionless by the value at σ=0.014 at which E_{Rmax} is maximum at each injection pressure p₁ and each nozzle diameter d.

Since a maximum is exhibited at σ=0.014 at each injection pressure p₁ and each nozzle diameter d, it is thought that f(0.014)=1, f′(0.014)=0. Further, f(0)=0 can be assumed since it is thought that no erosion occurs at σ≈0. Considering the above, the influence function f(σ) at σ≦0.014 was obtained as the following Equation (13) by assuming a cubic expression of σ as f(σ) at σ≦0.014 and obtaining each coefficient by applying Newton's method to experimental values at σ≦0.014.

[Equation 50]

f(σ)=−7.25×10⁵σ³+1.52×10⁴σ²−0.27σ (13)

On the other hand, at σ≧0.014, a cavitation occurrence area is reduced and f(σ) decreases as σ increases. If σ is larger than an incipient cavitation number σᵢ (or desinent cavitation number σ_{d}), the cavitation does not occur, wherefore f(σᵢ)=0. Specifically, since f(σ) is thought to monotonously decrease at σ≧0.014, the influence function f(σ) at σ≧0.014 was obtained as the following Equation (14) by assuming a linear expression.

[Equation 51]

f(σ)=−31.86σ+1.44 (14)

(Calculation of Cavitating Jet Performance E_{cav})

TABLE 13 shows an estimation result of the cavitating jet performance E_{cav} by assuming the maximum cumulative erosion rate E_{Rmax} of TABLE 11 as the cavitating jet performance E_{ref} of the cavitating jet to be referred to, introducing the Equations (11) to (14) into nₚ, n_{d} and f(σ) of the Equation (3), selecting reference conditions A to E from TABLE 11 and setting conditions of the cavitating jet to be estimated such that p₁=30 MPa, d=2 mm and σ=0.014 or p₁=30 MPa, d=2 mm and σ=0.003. Further, the actually measured erosion test result E_{Rmax Exp} and the estimation error Δ (%)=(1−E_{cav}/E_{Rmax Exp})×100 are also shown in TABLE 13.

TABLE 13
Estimation of cavitation aggressivity

| | | A | B | C | D | E |
|---|---|---|---|---|---|---|
| p_{1ref} | MPa | 30 | 10 | 10 | 10 | 10 |
| d_{ref} | mm | 1 | 1 | 2 | 1 | 2 |
| σ_{ref} | | 0.014 | 0.014 | 0.014 | 0.01 | 0.01 |
| E_{Rmax ref} | mg/min | 341.6 | 22.4 | 86.1 | 19.9 | 56.4 |
| f(σ_{ref}) | | 1.00 | 1.00 | 1.00 | 0.79 | 0.79 |
| p₁ | MPa | 30 | 30 | 30 | 30 | 30 |
| d | mm | 2 | 2 | 2 | 2 | 2 |
| σ | | 0.014 | 0.014 | 0.014 | 0.014 | 0.003 |
| nₚ | | 2.453 | 2.453 | 2.453 | 2.337 | 2.026 |
| n_{d} | | 1.966 | 1.966 | 1.966 | 1.785 | 1.301 |
| f(σ) | | 1.00 | 1.00 | 1.00 | 1.00 | 0.14 |
| E_{cav} | mg/min | 1.334 | 1.295 | 1.275 | 1.128 | 92.0 |
| E_{Rmax exp} | mg/min | 1.428 | 1.428 | 1.428 | 1.428 | 150.0 |
| Δ | % | −7 | −9 | −11 | −21 | −89 |
| W | mm | 31.4 | 31.4 | 31.4 | 31.4 | 91.9 |
| E_{cav}/w² | mg/min mm² | 1.36 | 1.32 | 1.30 | 1.15 | 0.01 |

It is understood from TABLE 13 that, by the present estimation method, the estimation error Δ can be estimated to be small when the injection pressure p₁, the nozzle diameter d and the cavitation number σ as the conditions of the cavitating jet to be estimated and the cavitating jet to be referred to are respectively similar, and to be about 20% even when all the conditions differ. Further, it is understood that E_{cav} can be estimated with Δ of about 40% even outside the ranges of the conditions of TABLE 11. It should be noted that an error due to f(σ) is seen to affect the estimation error most as shown in TABLE 13 in the estimation by the present empirical formula.

Next, processing performance by cavitation peening taking into account the width w of the cavitating jet is looked at. Since the width w is obtained from the Equation (8), a relative impact energy density on a collision surface is shown in the last row of TABLE 13 approximately as E_{cav}/w².

At σ≦0.014, E_{cav}/w² becomes drastically small since E_{cav} becomes small and w becomes large. Thus, under the condition that p₂ is constant, σ decreases with an increase in p₁, wherefore processing performance does not increase, but rather decreases even if p₁ is increased. Contrary to that, at σ≈0.014, E_{cav} becomes large and w becomes small, wherefore cavitation peening can be performed in a concentrated manner.

(Miscellaneous)

(1) Concerning Approximation Expressions of Relational Expressions of Power Index nₚ and n_{d}

Although the approximation expressions are obtained for the relational expressions of the power index nₚ of the term relating to the injection pressure p₁ and the power index n_{d} of the term relating to the nozzle diameter d, assuming linear expressions as the Equations (11), (12) in the above examples, there is no limitation to this and approximation expressions other than linear expressions can be obtained in relation to σ.

For example, in the case of obtaining approximation expressions assuming quadratic expressions, the relational expression (11) for the power index nₚ and the relational expression (12) for the power index n_{d} can be respectively obtained as the following Equations (15), (16).

[Equation 52]

nₚ=1200σ²+21.7σ+1.899 (15)

[Equation 53]

n_{d}=−2425σ²+163.95σ+0187 (16)

Further, in the case of obtaining approximation expressions by power approximation, the relational expression (11) for the power index nₚ and the relational expression (12) for the power index n_{d} relating to the nozzle diameter d can be respectively obtained as the following Equations (17), (18).

[Equation 54]

nₚ=10.222σ^{0.3139} (17)

[Equation 55]

n_{d}=32.609σ^{0.65556} (18)

Alternatively, if it is known from the database that σ₁=nₚ1, σ₂=nₚ₂, σ₁=n_{d1}, and σ₂=n_{d2}, nₚ₃ and n_{d3} of σ₃ can be obtained by interpolation or extrapolation. In this case, a relational expression for the power index nₚ₃ and a relational expression for the power index n_{d3} relating to the nozzle diameter d can be respectively obtained as the following Equations (19), (20).

$$[ Equation 56 ]$$

$$\begin{matrix}{n}_{p 3} = \frac{{σ}_{3} - {σ}_{1}}{{σ}_{2} - {σ}_{1}} ( {n}_{p 2} - {n}_{p 1} ) + {n}_{p 1} \\ [ Equation 57 ] & ( 19 ) \\ {n}_{d 3} = \frac{{σ}_{3} - {σ}_{1}}{{σ}_{2} - {σ}_{1}} ( {n}_{d 2} - {n}_{d 1} ) + {n}_{d 1} & ( 20 )\end{matrix}$$

(2) Concerning Approximation Conditions of Influence Function f(σ)

Although the influence function f(σ) of the cavitation number σ in the estimation cavitating jet performance E_{Rmax} is obtained as the Equation (13), assuming a cubic expression of σ at σ≦0.014 and as the Equation (14), assuming a linear expression of σ at σ≦0.014 in the above examples, there is no limitation to this. The influence function may be obtained as another approximation expressed in each range and approximation conditions may be set in more detail according to σ.

Alternatively, the influence function f(σ) may be a function having another hydrodynamic parameter such as the nozzle diameter d as a variable.

(3) Concerning Cavitating Conditions

Although the estimation cavitating jet performance is estimated, taking cavitation in water (in-water cavitation) as an example in the above embodiments and examples, the present invention can be also applied to an aerial cavitating jet produced by injecting a slow-speed water jet into an atmosphere from a nozzle and injecting a high-speed water jet into a center of the former water jet by a double nozzle.

### LIST OF REFERENCE SIGNS

10, 31 . . . cavitating jet performance estimation system
11, 211, 231 . . . cavitating jet performance estimation device (cavitating jet estimation error calculation device, cavitating jet performance evaluation device, cavitating jet performance calculation formula specification device)
51, 71 . . . cavitating jet performance estimation device (cavitating jet estimation error calculation device, cavitating jet performance evaluation device)
21, 61, 221 . . . cavitating jet testing device
23, 32, 63, 81, 223 . . . database
33, 233 . . . power index specification means
36, 236 . . . influence function specification means
37, 77, 237 . . . jet performance specification means
41, 91, 241 . . . estimation error calculation means
42, 92, 242 . . . estimation accuracy evaluation means
301 . . . cavitating jet estimation error calculation system
302 . . . cavitating jet performance evaluation system
311, 321 . . . cavitating jet estimation error calculation device

1. A cavitating jet performance estimation method, comprising:
in obtaining estimated cavitating jet performance E of a cavitating jet,
setting the following Equation (1) for calculating the estimated cavitating jet performance E,
[Equation 1]
E=FX^{n(σ)}Y^{m(σ)} (1)
(In Equation (1),
F denotes a term relating to the effect of a cavitation number σ of the cavitating jet,
X^{n(σ)} denotes a term relating to a power law of an injection pressure p₁ of the cavitating jet and a power index n(σ) thereof denotes a function of the cavitation number σ, and
Y^{m(σ)} denotes a term relating to a power law of a nozzle diameter d for producing the cavitating jet and a power index m(σ) thereof denotes a function of the cavitation number σ);
specifying the functions n(σ), m(σ) for the power indices in the Equation (1) from data on the injection pressure p₁, the nozzle diameter d and the cavitation number σ and data on cavitating jet performance E_{Rmax} corresponding to these pieces of data; and
obtaining the estimated cavitating jet performance E using the data on the injection pressure p₁, the nozzle diameter d and the cavitation number σ, the Equation (1) and the specified functions n(σ), m(σ) for the power indices.

2. The cavitating jet performance estimation method according to claim 1, wherein:
the Equation (1) for calculating the estimated cavitating jet performance E of the cavitating jet is the following Equation (2),
$$[ Equation 2 ]$$
$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$
(In the Equation (2),
E_{ref} denotes cavitating jet performance of a cavitating jet to be referred to,
p_{1ref} denotes an injection pressure to be referred to,
d_{ref} denotes a nozzle diameter to be referred to,
Kₙ denotes a shape function dependent on a nozzle shape or the shape of a testing unit,
f(σ) denotes an influence function at the cavitation number σ, and
f(σ_{ref}) denotes the influence function at a cavitation number σ_{ref} to be referred to), and
the estimated cavitating jet performance E_{cav} is obtained using the Equation (2).

3. The cavitating jet performance estimation method according to claim 2, wherein Kₙ=1 in the Equation (2).

4. The cavitating jet performance estimation method according to claim 2, wherein the influence function is defined as a function different before and after the cavitation number σ exhibiting a maximum.

5. The cavitating jet performance estimation method according to claim 2, wherein:
in specifying the functions n(σ), m(σ) for the power indices in the Equation (1) or (2),
the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d are first respectively obtained, and
the functions n(σ), m(σ) for the power indices are specified from the both relationships.

6. The cavitating jet performance estimation method according to claim 2, wherein:
in obtaining the estimated cavitating jet performance E_{cav},
a predetermined order of operations is set for the data on the injection pressure p₁, the nozzle diameter d and the cavitation number σ, and
the estimated cavitating jet performance E_{cav} is successively obtained in accordance with the order of operations.

7. (canceled)

8. A cavitating jet performance estimation device, comprising:
a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,
[Equation 4]
E=FX^{n(σ)}Y^{m(σ)} (1)
(In Equation (1),
F denotes a term relating to the effect of the cavitation number σ of the cavitating jet,
X^{n(σ)} denotes a term relating to a power law of the injection pressure p₁ of the cavitating jet and the power index n(σ) thereof denotes a function of the cavitation number σ, and
Y^{m(σ)} denotes a term relating to a power law of the nozzle diameter d for producing the cavitating jet and a power index m(σ) thereof denotes a function of the cavitation number σ);
an estimation means for obtaining the estimated cavitating jet performance E using the data on the injection pressure p₁, the nozzle diameter d and the cavitation number σ, the Equation (1) and the specified functions n(σ), m(σ) for the power indices.

9. (canceled)

10. The cavitating jet performance estimation device according to claim 8, wherein:
the Equation (1) for calculating the estimated cavitating jet performance E of the cavitating jet is the following Equation (2),
$$[ Equation 6 ]$$
$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$
(In the Equation (2),
E_{ref} denotes cavitating jet performance of a cavitating jet to be referred to,
p_{1ref} denotes an injection pressure to be referred to,
d_{ref} denotes a nozzle diameter to be referred to,
Kₙ denotes a shape function dependent on a nozzle shape or the shape of a testing unit,
f(σ) denotes an influence function at the cavitation number σ, and
f(σ_{ref}) denotes the influence function at a cavitation number σ_{ref} to be referred to), and
estimated cavitating jet performance E_{cav} is obtained using the Equation (2).

11. The cavitating jet performance estimation device according to claim 10, wherein Kₙ=1 in the Equation (2).

12. The cavitating jet performance estimation device according to claim 10, wherein the influence function is defined as a function different before and after the cavitation number σ exhibiting a maximum.

13. The cavitating jet performance estimation device according to claim 10, comprising, to specify the power indices:
a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d, and
a means for specifying the functions n(σ), m(σ) for the power indices from the both relationships.

14. The cavitating jet performance estimation device according to claim 10, wherein the estimation means includes:
a means for setting a predetermined order of operations for the data on the injection pressure p₁, the nozzle diameter d and the cavitation number σ, and
a means for successively obtaining the estimated cavitating jet performance E_{cav} in accordance with the order of operations.

15-19. (canceled)

20. A cavitating jet estimation error calculation method, comprising:
obtaining the estimated cavitating jet performance E_{cav} by the cavitating jet performance estimation method according to claim 2; and
obtaining a cavitating jet performance estimation error by comparing the estimated cavitating jet performance E_{cav} and actually measured cavitating jet performance E_{Rmax exp} of the cavitating jet corresponding to the estimated cavitating jet performance E_{cav}.

21. A cavitating jet performance evaluation method, comprising:
obtaining the cavitating jet performance estimation error by the cavitating jet estimation error calculation method according to claim 20, and
evaluating cavitating jet performance estimation accuracy based on the cavitating jet performance estimation error.

22. A cavitating jet estimation error calculation device, comprising:
the cavitating jet performance estimation device according to claim 10; and
a means for obtaining a cavitating jet performance estimation error by comparing estimated cavitating jet performance E_{cav} obtained by the cavitating jet performance estimation device and actually measured cavitating jet performance E_{Rmax exp} of the cavitating jet corresponding to the estimated cavitating jet performance E_{cav}.

23. A cavitating jet performance evaluation device, comprising:
the cavitating jet estimation error calculation device according to claim 22; and
a means for evaluating cavitating jet performance estimation accuracy based on the cavitating jet performance estimation error obtained by the cavitating jet estimation error calculation device.

24-30. (canceled)

31. A cavitating jet performance calculation formula specification device, comprising:
a power index specification means for specifying functions n(σ), m(σ) for power indices in the following Equation (1) for calculating estimated cavitating jet performance E from data accumulated in a database for accumulating data on an injection pressure p₁ of a cavitating jet, a nozzle diameter d for producing the cavitating jet and a cavitation number σ and data on cavitating jet performance E_{Rmax} corresponding to these pieces of data,
[Equation 15]
E=FX^{n(σ)}Y^{m(σ)} (1)
(In Equation (1),
F denotes a term relating to the effect of the cavitation number σ of the cavitating jet,
X^{n(σ)} denotes a term relating to a power law of the injection pressure p₁ of the cavitating jet and a power index n(σ) thereof denotes a function of the cavitation number σ, and
Y^{m(σ)} denotes a term relating to a power law of the nozzle diameter d for producing the cavitating jet and a power index m(σ) thereof denotes a function of the cavitation number σ).

32. The cavitating jet performance calculation formula specification device according to claim 31, wherein:
the Equation (1) for calculating the estimated cavitating jet performance E of the cavitating jet is the following Equation (2),
$$[ Equation 16 ]$$
$${E}_{cav} = {E}_{ref} {K}_{n} \frac{f ( σ )}{f ( {σ}_{ref} )} {( \frac{{p}_{1}}{{p}_{1 ref}} )}^{n ( σ )} {( \frac{d}{{d}_{ref}} )}^{m ( σ )} \qquad ( 2 )$$
(In the Equation (2),
E_{ref} denotes cavitating jet performance of a cavitating jet to be referred to,
p_{1ref} denotes an injection pressure to be referred to,
d_{ref} denotes a nozzle diameter to be referred to,
Kₙ denotes a shape function dependent on a nozzle shape or the shape of a testing unit,
f(σ) denotes an influence function at the cavitation number σ, and
f(σ_{ref}) denotes the influence function at a cavitation number σ_{ref} to be referred to).

33. The cavitating jet performance calculation formula specification device according to claim 32, wherein Kₙ=1 in the Equation (2).

34. The cavitating jet performance calculation formula specification device according to claim 32, wherein the influence function is defined as a function different before and after the cavitation number σ exhibiting a maximum.

35. The cavitating jet performance calculation formula specification device according to claim 32, wherein the power index specification means includes:
a means for respectively obtaining the injection pressure p₁ with the cavitation number σ as a parameter and a relationship of the cavitating jet performance E_{Rmax} with the injection pressure p₁ and the nozzle diameter d with the cavitation number σ as a parameter and a relationship of the cavitating jet performance E_{Rmax} with the nozzle diameter d; and
a means for specifying the functions n(σ), m(σ) for the power indices from the both relationships.

36-39. (canceled)
